(19) United States
(12) Patent Application Publication
(10) Pub. No.: US 2024/0393933 A1
(43) Pub. Date: Nov. 28, 2024

(54) Devices, Methods, and Graphical User Interfaces for Configuring Configurable Input Region

(71) Applicant: Apple Inc., Cupertino, CA (US)

(72) Inventors: Nathan de Vries, Alameda, CA (US); Camille Moussette, San Francisco, CA (US); Chanaka G. Karunamuni, San Jose, CA (US); Marcos Alonso Ruiz, Oakland, CA (US); Cameron Burgess, San Francisco, CA (US); Samuel L. Iglesias, Palo Alto, CA (US); Michael S. Soetaert, San Jose, CA (US)

(21) Appl. No.: 18/653,787

(22) Filed: May 2, 2024

Related U.S. Application Data
(60) Provisional application No. 63/465,213, filed on May 9, 2023.

(51) Int. Cl. G06F 3/04847; F21V 23/04; G04F 10/00; G06F 3/0482; G06F 3/0487; G06F 3/16; G06Q 10/083; H04N 23/63

(52) U.S. Cl. CPC G06F 3/04847; F21V 23/0485; G04F 10/00; G06F 3/0482; G06F 3/0487; G06Q 10/083; G06F 3/16; H04N 23/631

(57) ABSTRACT

An electronic device detects a first input on a first input region separate from a display of the electronic device, including detecting a first portion of the first input followed by a second portion of the first input. In response to detecting the first input on the first input region: in accordance with a determination that the first portion of the first input satisfies a first set of one or more criteria, the electronic device displays, a first preview that corresponds to the first operation of the first application. In accordance with a determination that the second portion of the first input meets a second set of criteria, the electronic device performs the first operation of the first application. In accordance with a determination that the second portion of the first input meets the second set of criteria, the electronic device performs the second operation of the second application.

### RELATED APPLICATIONS

This application claims priority to U.S. Provisional Patent Application No. 63/465,213, filed May 9, 2023, which is hereby incorporated by reference in its entirety.

### TECHNICAL FIELD

This relates generally to computer systems with display generation components, including but not limited to electronic devices that include a display area having a session region.

### BACKGROUND

Graphical user interfaces are useful for providing status information and status updates for functions and processes of computers and other electronic computing devices, such as when status information is provided and updated in a dedicated session region. But conventional methods for providing status information are cumbersome and inefficient. In some cases, the status information displayed is not sufficiently relevant to a user or device's current context. In some cases, displaying the status information takes too much focus away from and/or interrupts interaction with other displayed user interfaces. In some cases, the session region is not sufficiently user-configurable or is not configured to display certain types of status information. In addition, these methods take longer than necessary, thereby wasting energy. This latter consideration is particularly important in battery-operated devices.

### SUMMARY

Accordingly, there is a need for electronic devices with faster, more efficient methods and interfaces for providing and updating status information. Such methods and interfaces optionally complement or replace conventional methods for providing and updating status information. Such methods and interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has a touchpad. In some embodiments, the device has a touch-sensitive display (also known as a “touch screen” or “touch-screen display”). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method is performed at an electronic device with a display, and a first input region that is separate from the display. The method includes, detecting a first input on the first input region, including detecting a first portion of the first input followed by a second portion of the first input. The method includes, in response to detecting the first input on the first input region: during the first portion of the first input: in accordance with a determination that the first portion of the first input satisfies a first set of one or more criteria and that the first input region is associated with a first operation of a first application, displaying, via the display, a first preview that corresponds to the first operation of the first application. The method includes, during the second portion of the first input following the first portion of the first input: in accordance with a determination that the second portion of the first input meets a second set of one or more criteria that are different from the first set of one or more criteria after the first portion of the first input has met the first set of one or more criteria and that the first input region is associated with the first operation of the first application, performing the first operation of the first application; and in accordance with a determination that the second portion of the first input meets the second set of one or more criteria after the first portion of the first input has met the first set of one or more criteria and that the first input region is associated with the second operation of the second application, performing the second operation of the second application.

In accordance with some embodiments, a method is performed at an electronic device with a display, displaying a first user interface for configuring the first input region, including concurrently displaying a first representation of the first input region and first content indicating a first configuration option associated with the first input region, wherein the first representation of the first input region includes a first graphical representation having a first set of one or more visual features that are based on a physical appearance of the first input region, detecting a first input that corresponds to a request to switch to a second configuration option associated with the first input region. The method includes, in response to detecting the first input, concurrently displaying, in the first user interface, a second representation of the first input region and second content indicating a second configuration option associated with the first input region, wherein the second representation of the first input region has the first set of one or more visual features that are based on the physical appearance of the first input region and the second representation of the first input region is different from the first representation of the first input region in at least a second set of one or more visual features that indicate a change in configuration option from the first configuration option to the second configuration option.

In accordance with some embodiments, an electronic device includes a display (or more generally, a display generation component), a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

Thus, electronic devices with displays, touch-sensitive surfaces, optionally one or more sensors to detect intensities of contacts with the touch-sensitive surface, optionally one or more tactile output generators, optionally one or more device orientation sensors, and optionally an audio system, are provided with improved methods and interfaces for providing and updating status information, thereby increasing the effectiveness, efficiency, and user satisfaction with such devices. Such methods and interfaces may complement or replace conventional methods for providing and updating status information.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 1C is a block diagram illustrating a tactile output module in accordance with some embodiments.

FIG. 2 illustrates a portable multifunction device having a touch screen in accordance with some embodiments.

FIG. 3 is a block diagram of an example multifunction device with a display and a touch-sensitive surface in accordance with some embodiments.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5AD illustrate example user interfaces for configuring a first input region in accordance with some embodiments.

FIGS. 6A-6AL illustrate example user interfaces for interacting with a multifunction device via a configurable first input region configured using the example user interfaces illustrated in FIGS. 5A-5AD in accordance with some embodiments.

FIGS. 7A-7I are flow diagrams of a process for displaying user interfaces in response to inputs via a configurable first input region of a multifunction device in accordance with some embodiments.

FIGS. 8A-8F are flow diagrams of a process for configuring a first input region in accordance with some embodiments.

### DESCRIPTION OF EMBODIMENTS

Many electronic devices have graphical user interfaces that provide status information and status updates for functions and processes of a computer system. Conventional methods of providing and updating status information are often limited in functionality. In some cases, the status information displayed is not sufficiently relevant to a user or device's current context. In some cases, displaying the status information takes too much focus away from and/or interrupts interaction with other displayed user interfaces. In some cases, the session region is not sufficiently user-configurable or is not configured to display certain types of status information. The embodiments described herein provide intuitive ways for a user to view relevant, desired status information in a session region while being able to continue to interact with one or more other user interfaces displayed concurrently with and outside of the session region, and while enabling the session region to support displaying more types of status information.

The methods, devices, and GUIs described herein improve user interface interactions related to displayed status information in multiple ways. For example, they make it easier to view context-relevant status information and to view more types of status information in the session region, to view status information less intrusively to reduce interruption to interaction with other displayed user interfaces, and to enable a user to configure which status information is displayed in the session region, thereby eliminating the need for extra, separate steps to view a particular status update.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, improving privacy and/or security, reducing the amount of display area needed to display notifications and/or status information and thus increasing the amount of display area available for other applications to display information, and/or additional techniques. These techniques also reduce power usage and improve battery life of the device by enabling the user to use the device more quickly and efficiently. Saving on battery power, and thus weight, improves the ergonomics of the device.

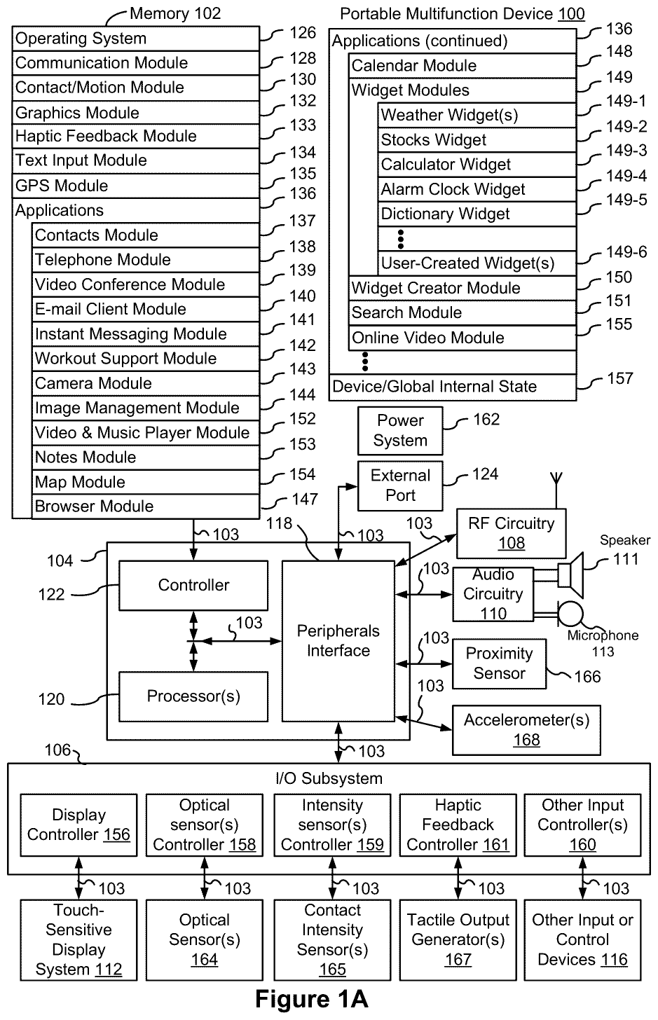

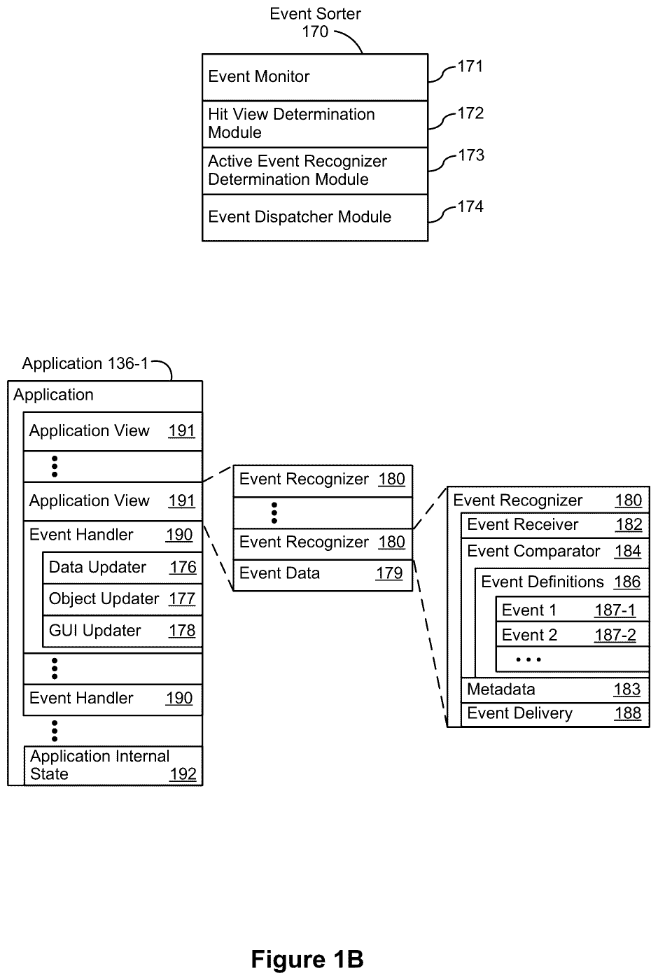

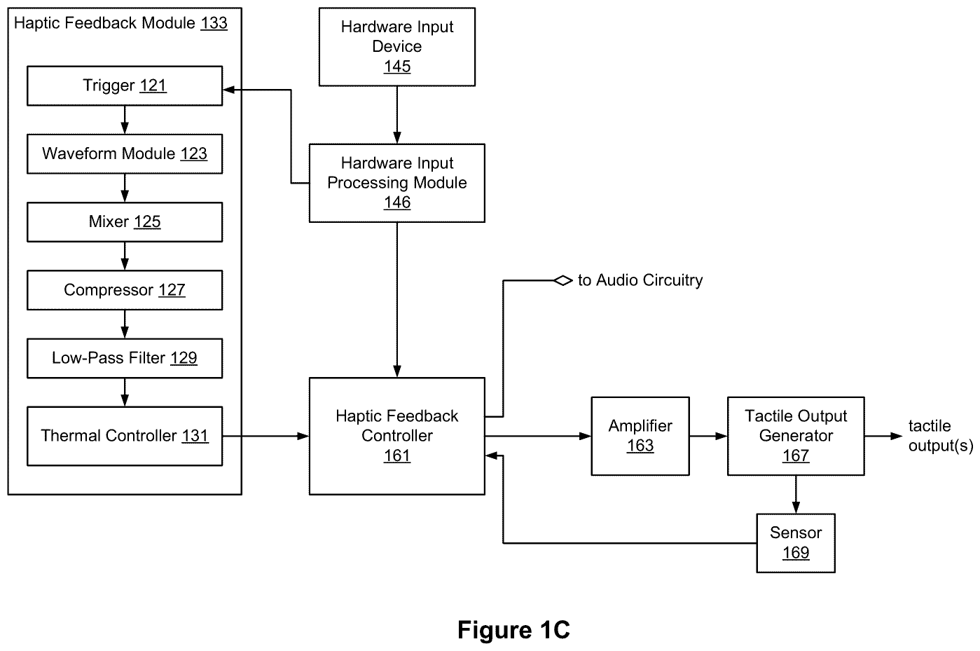

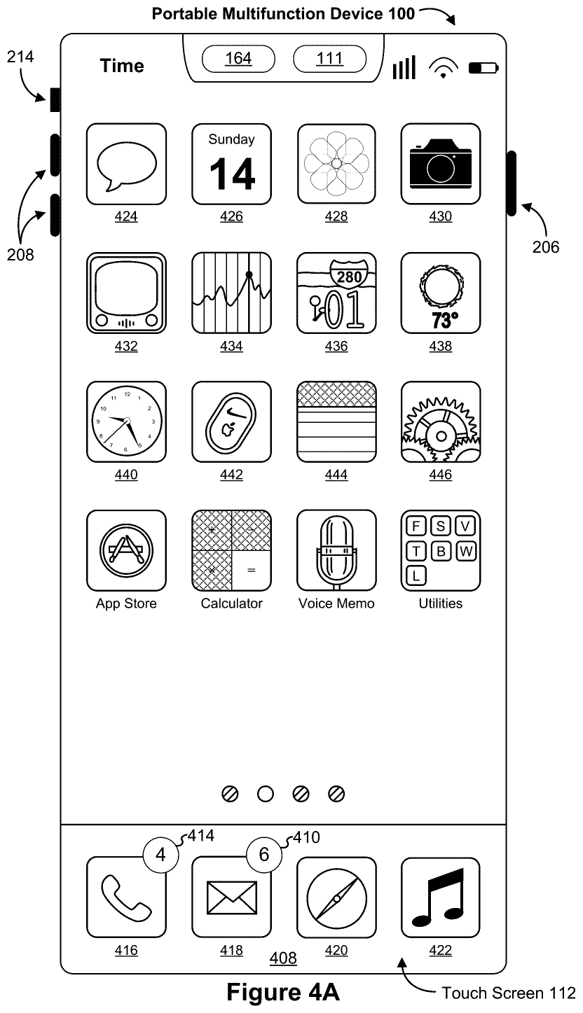

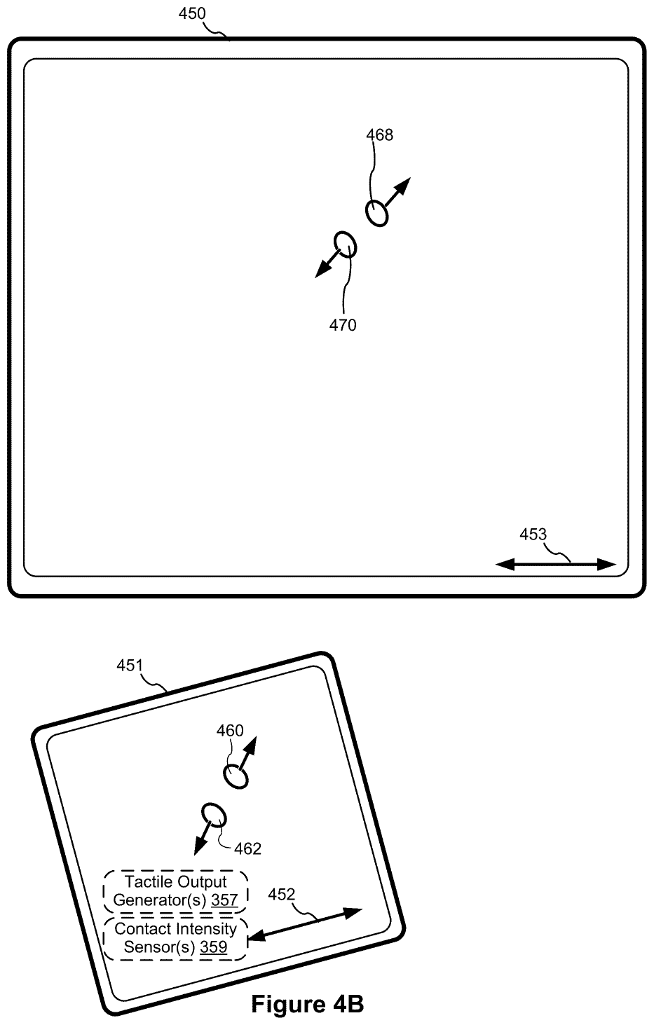

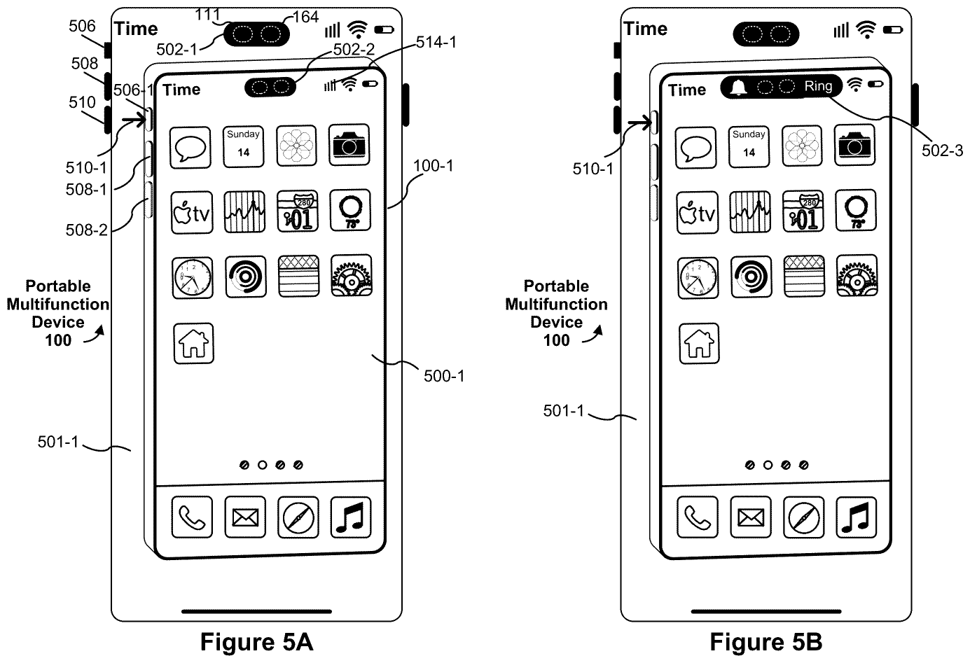

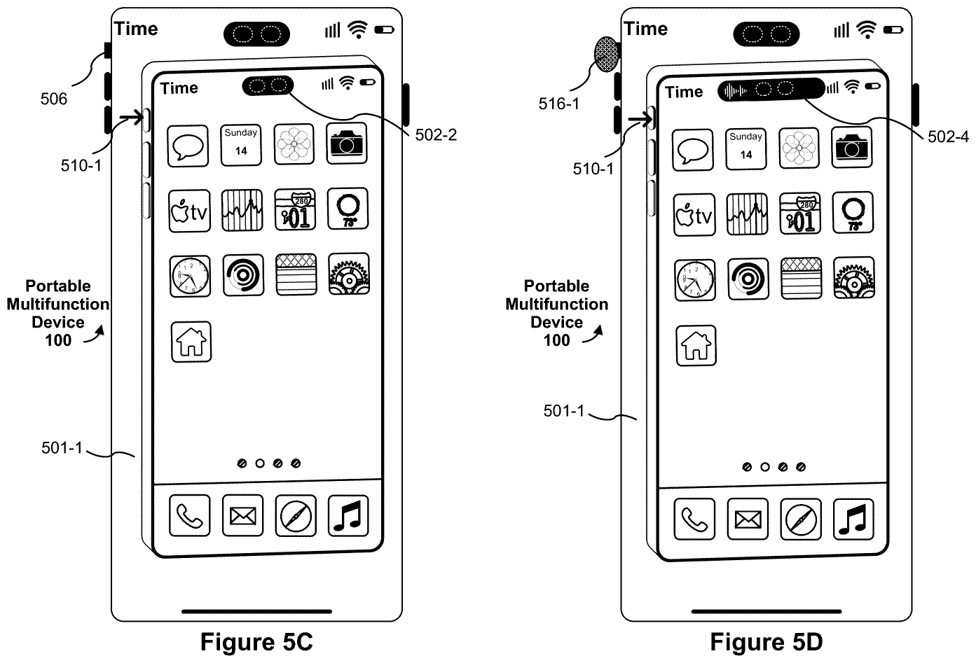

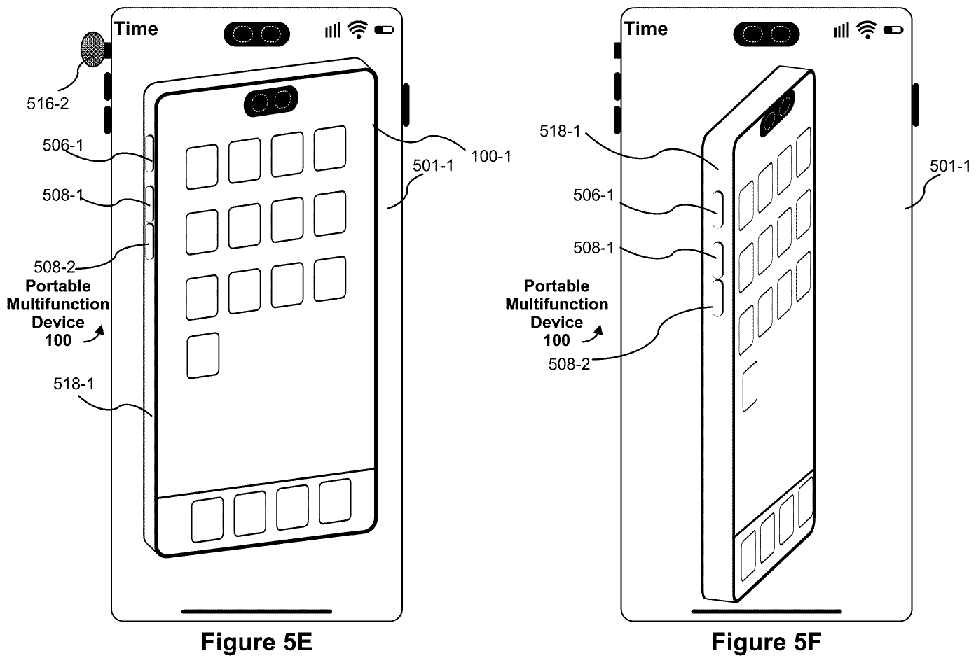

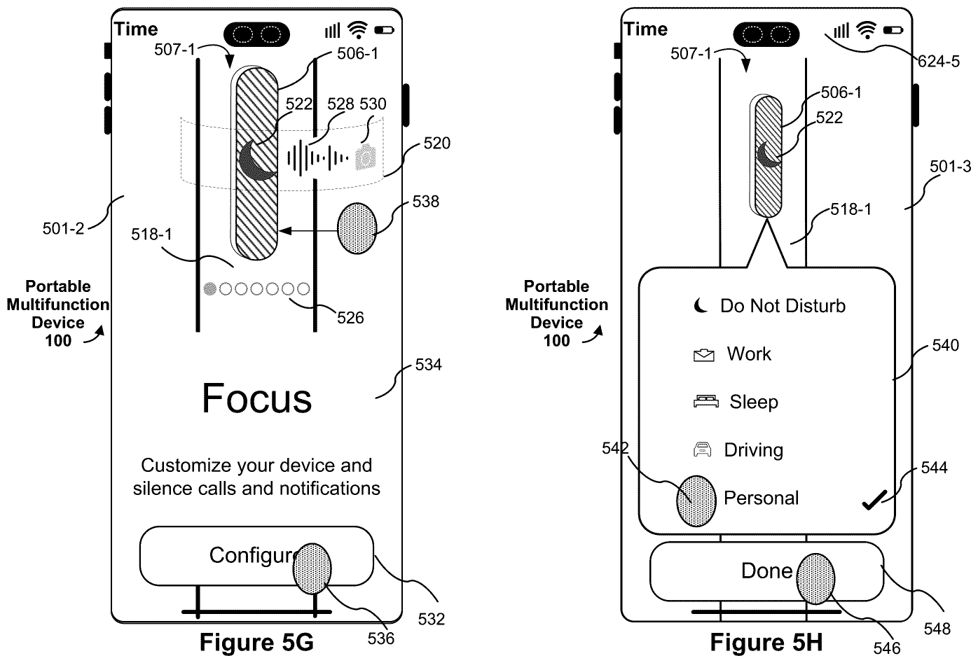

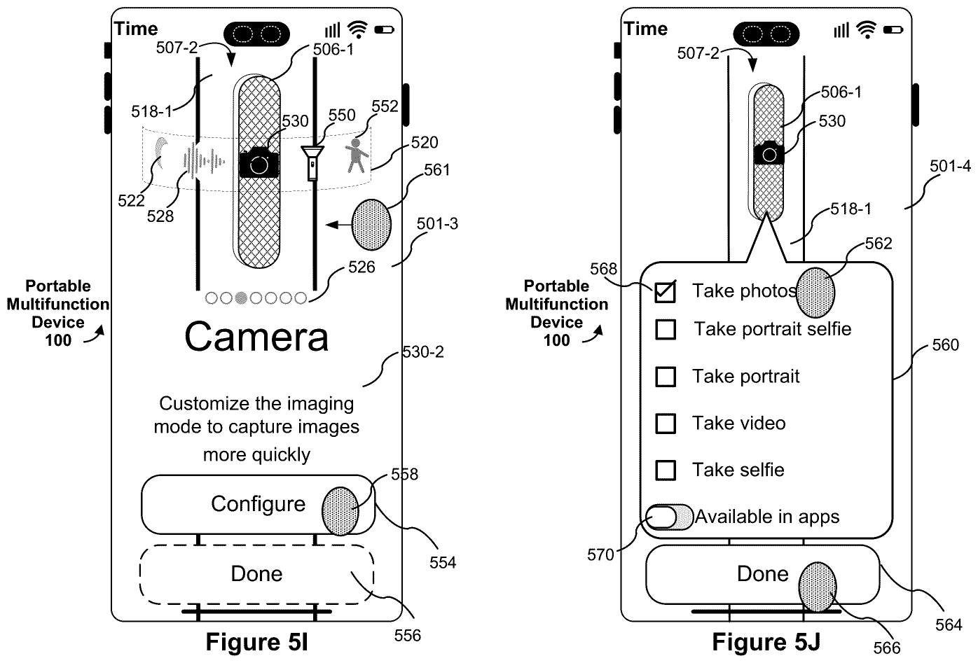

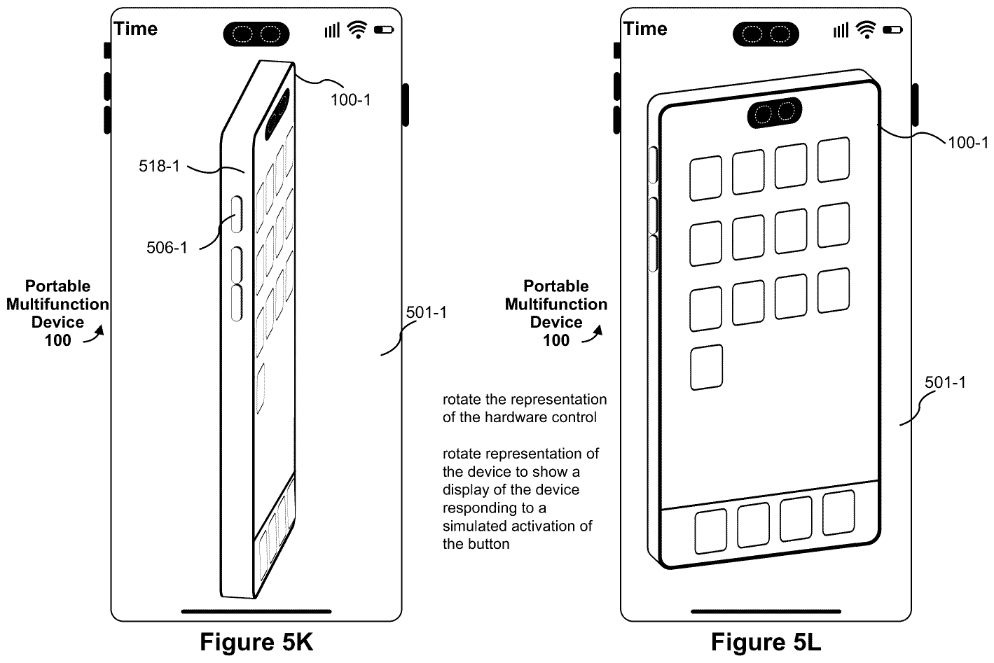

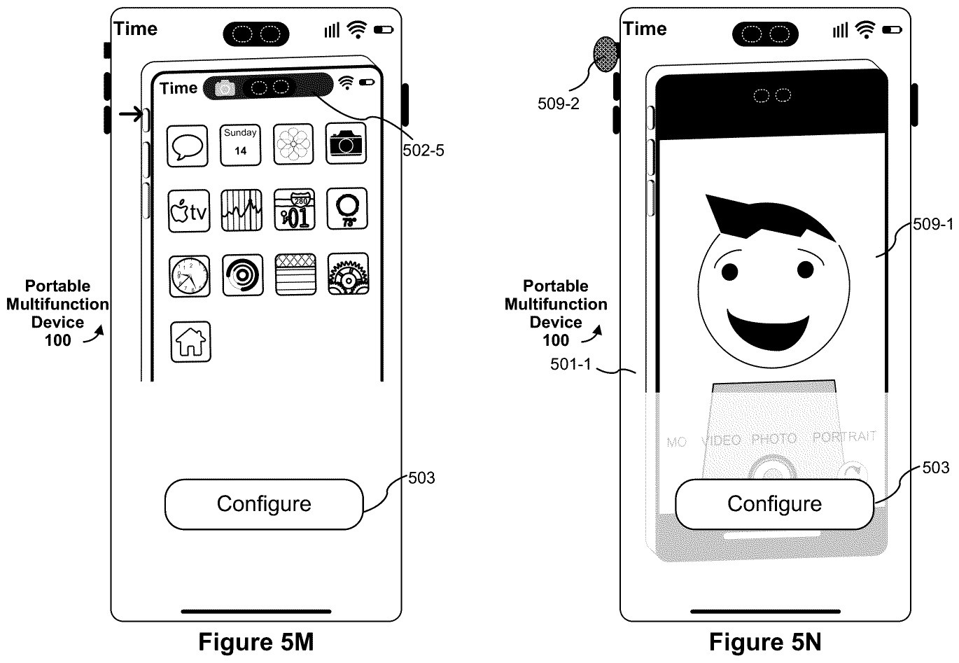

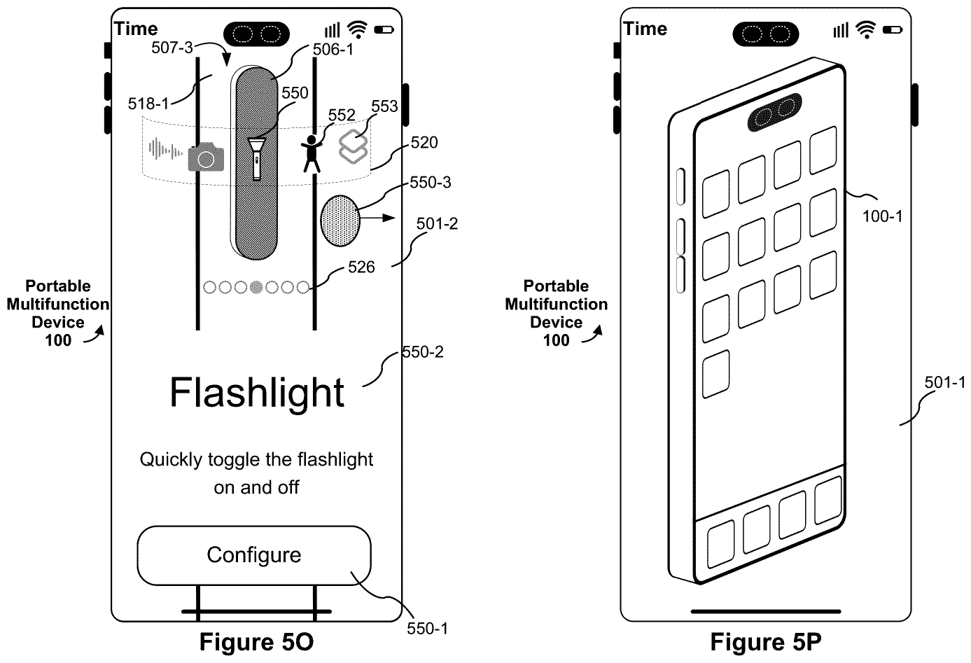

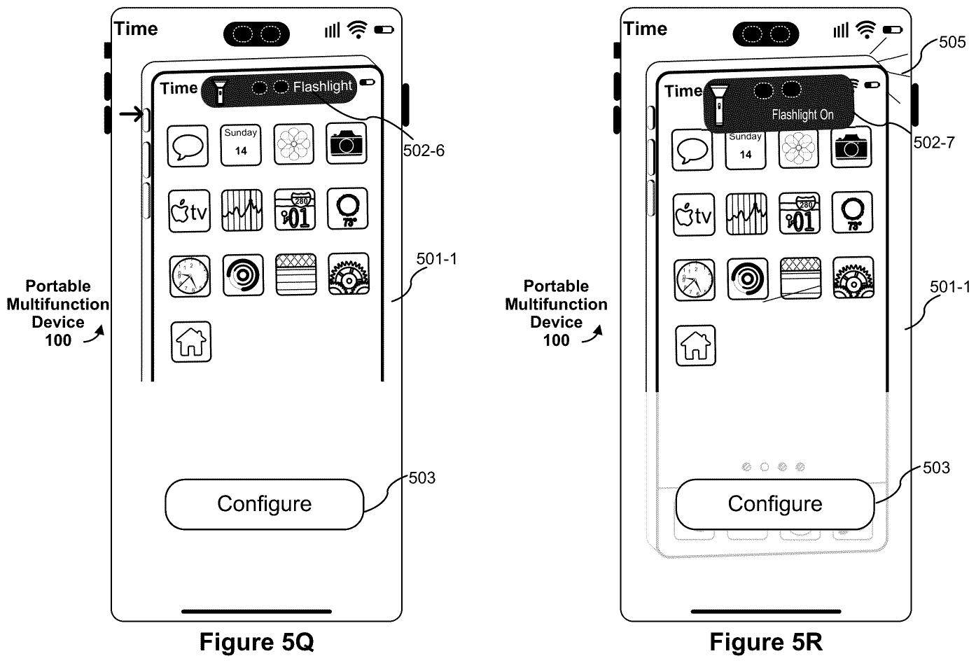

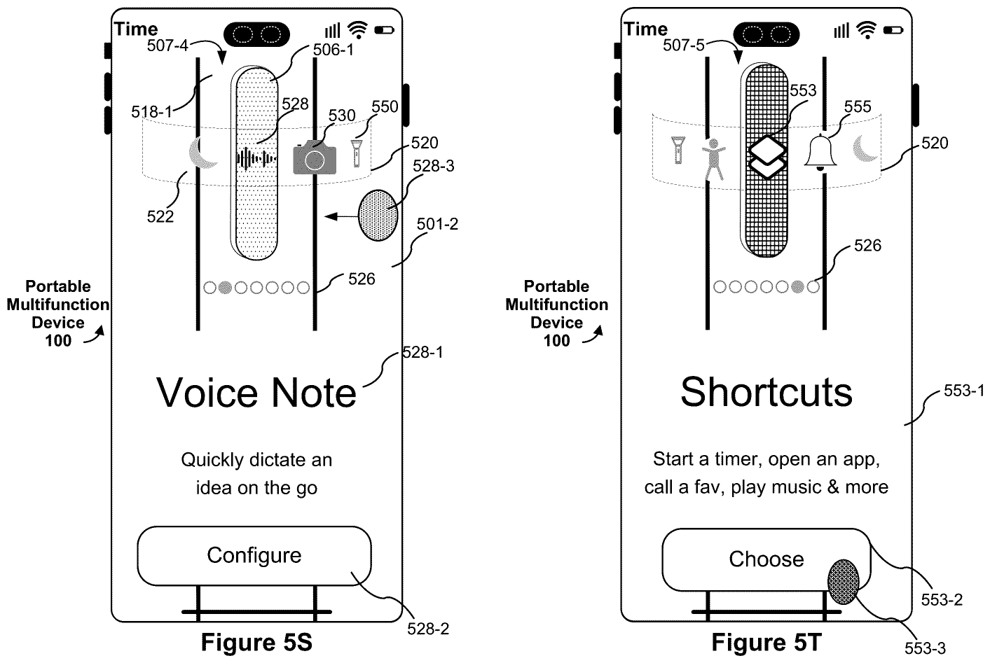

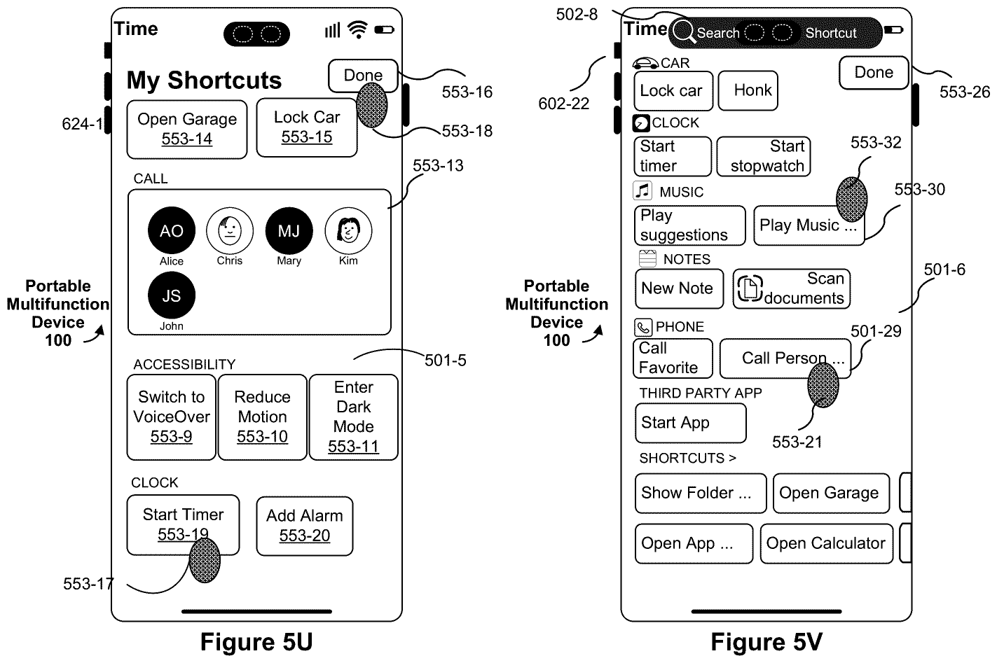

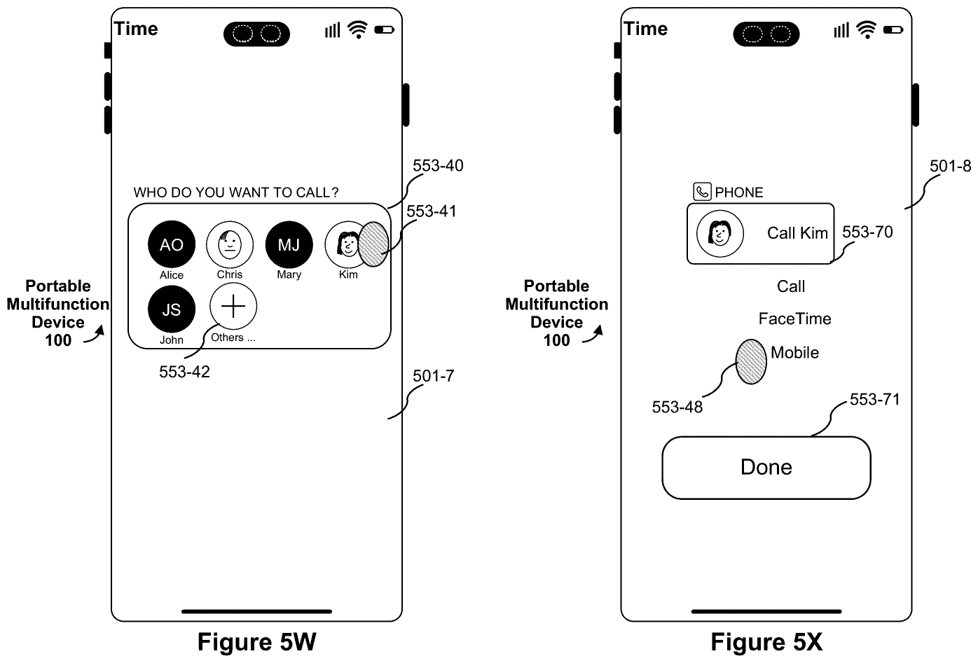

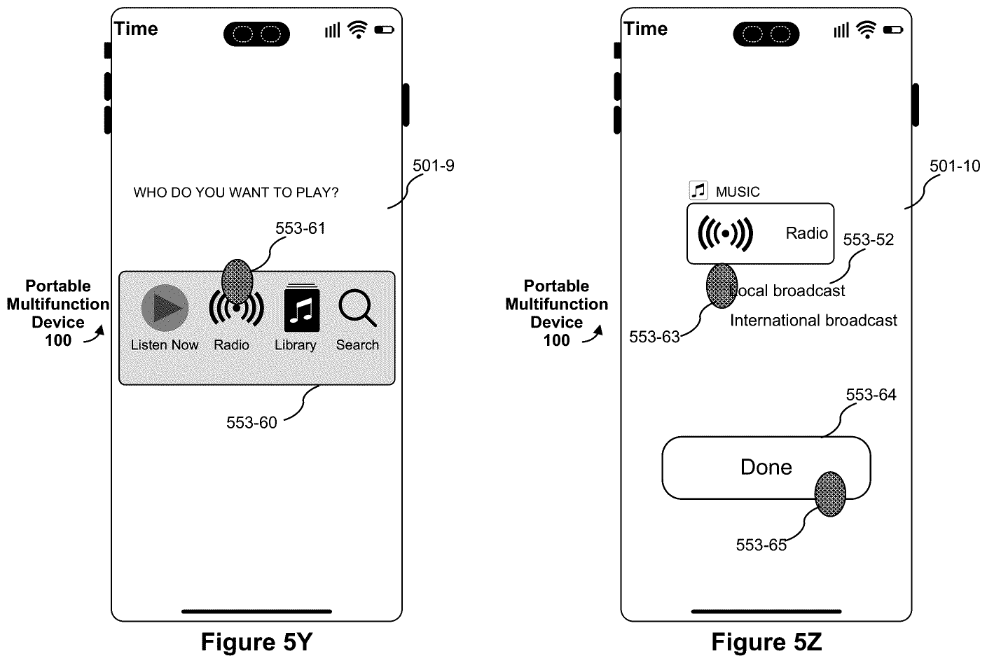

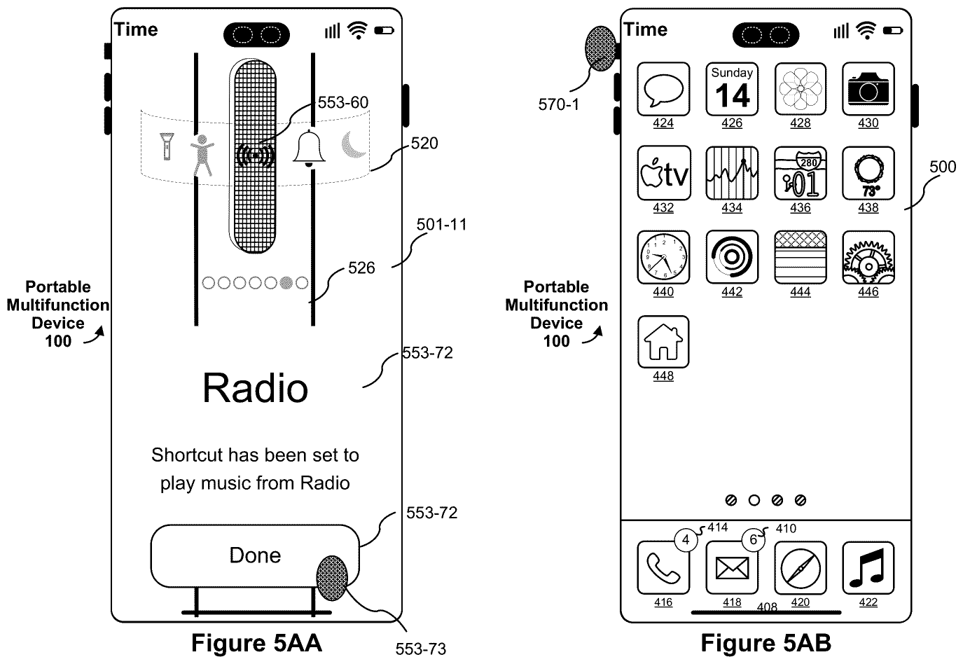

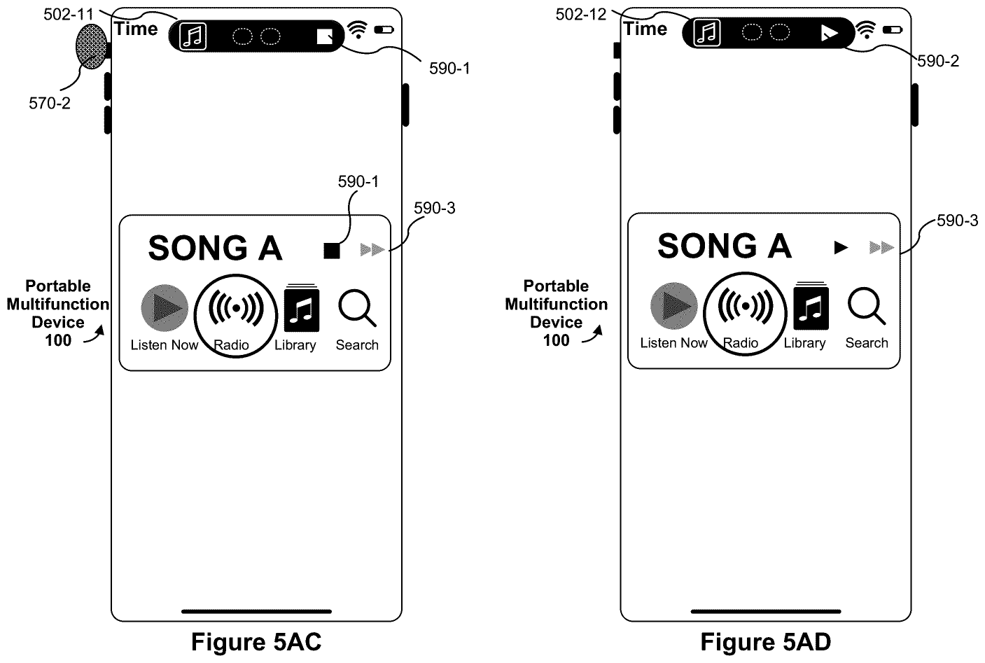

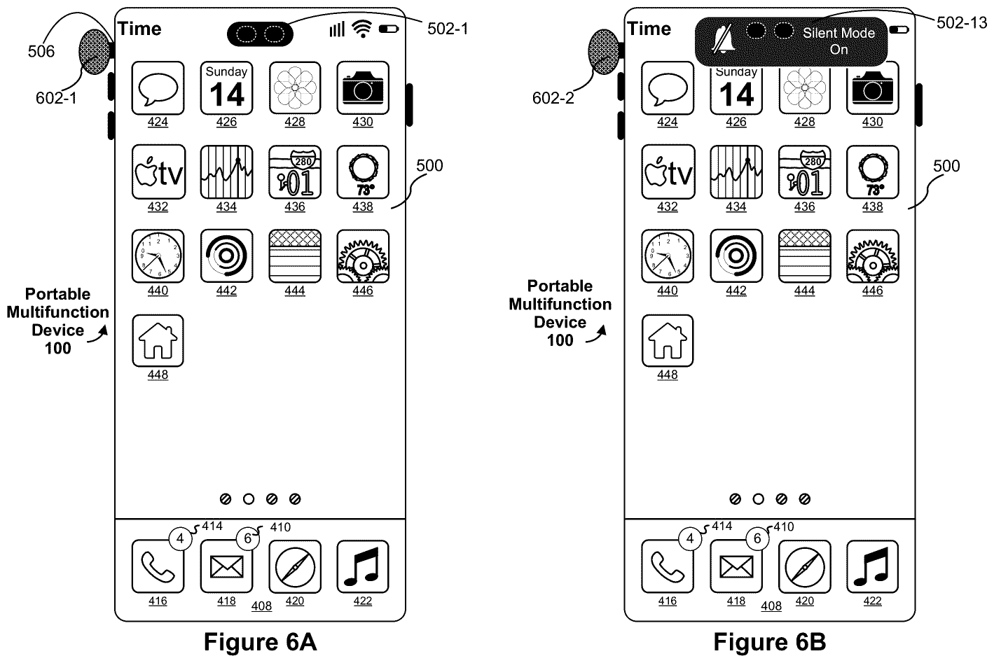

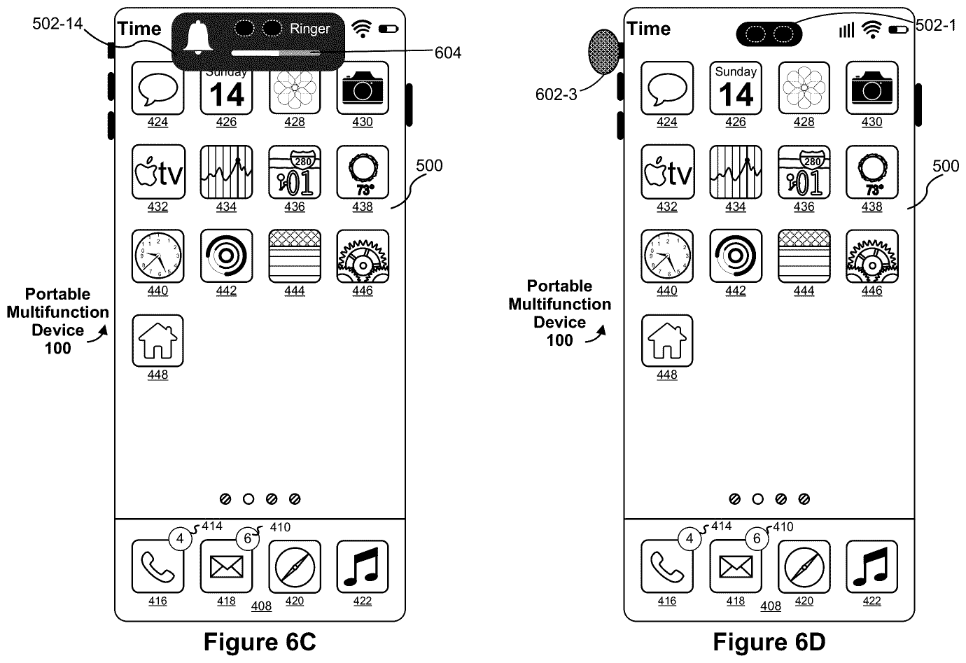

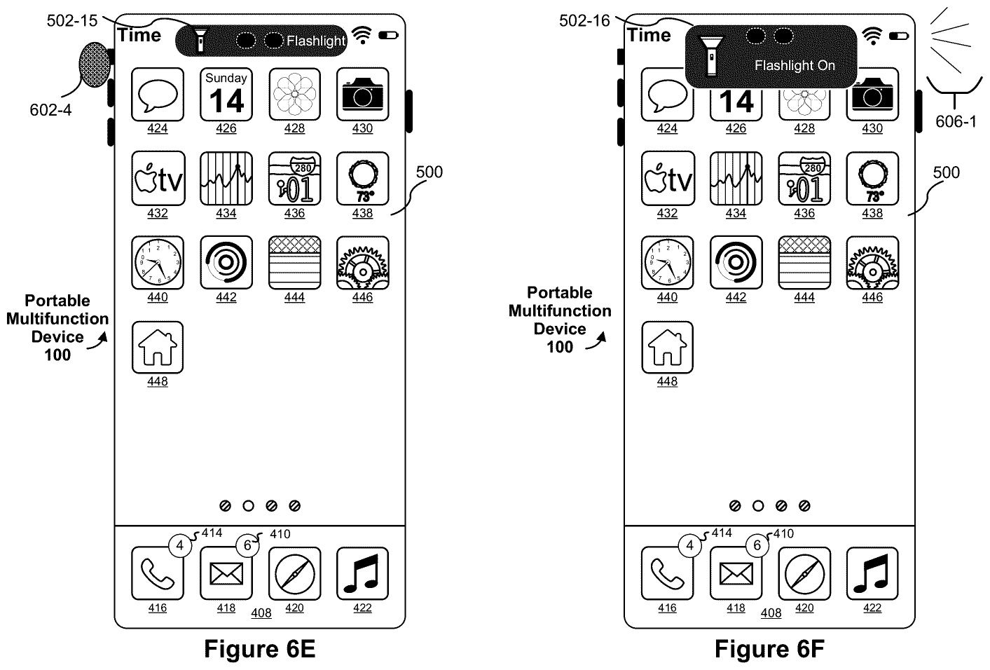

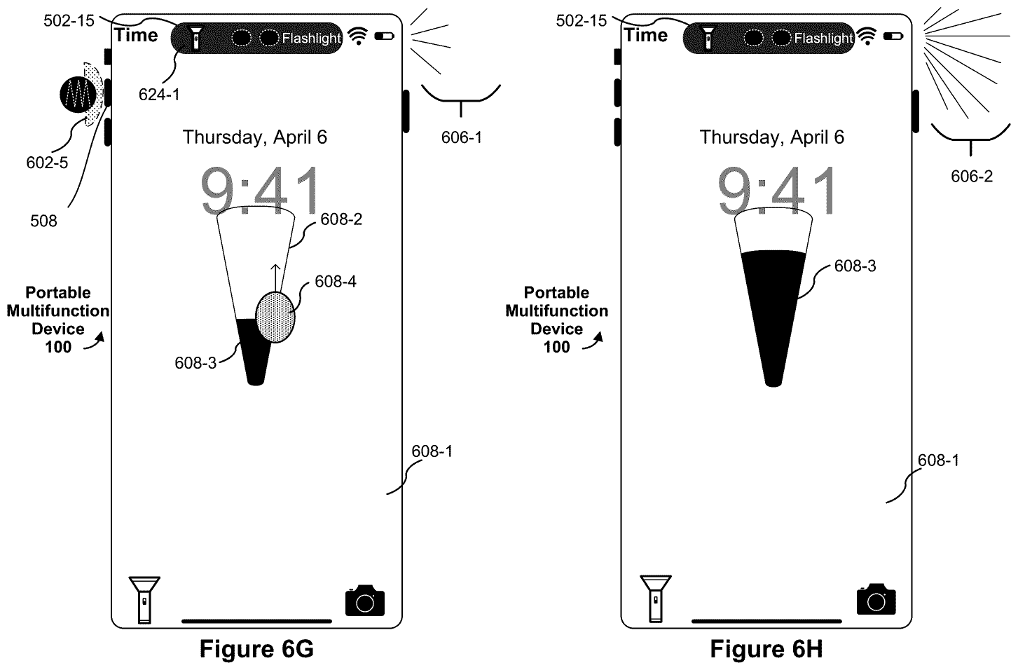

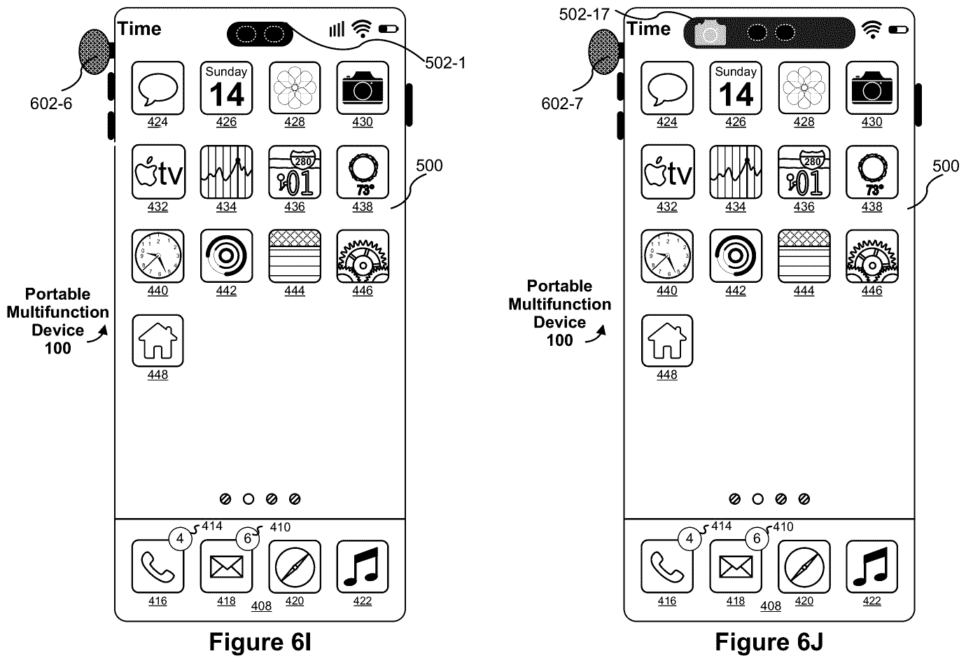

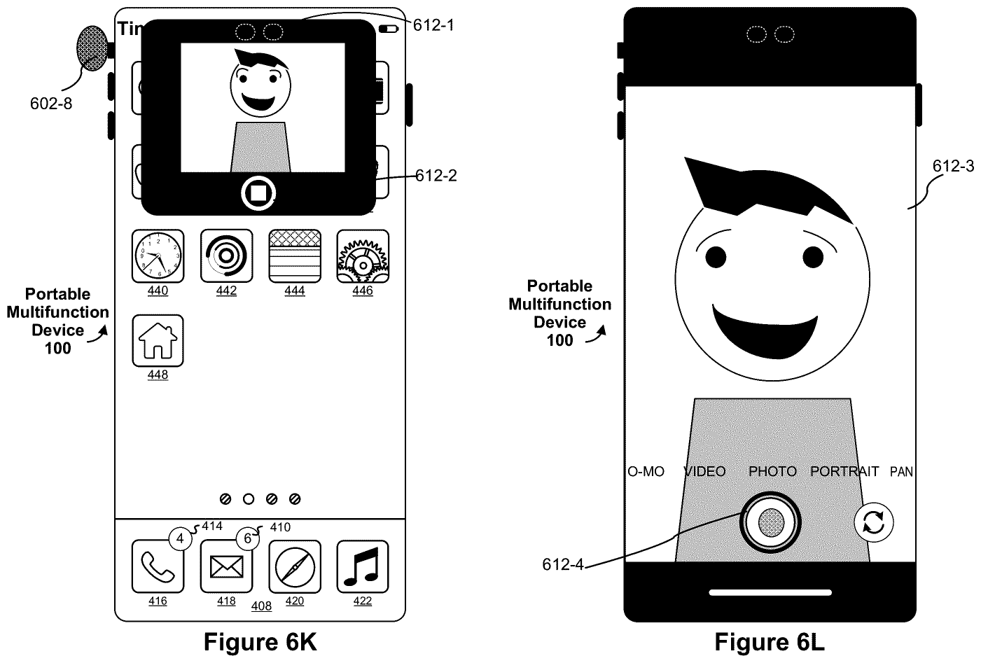

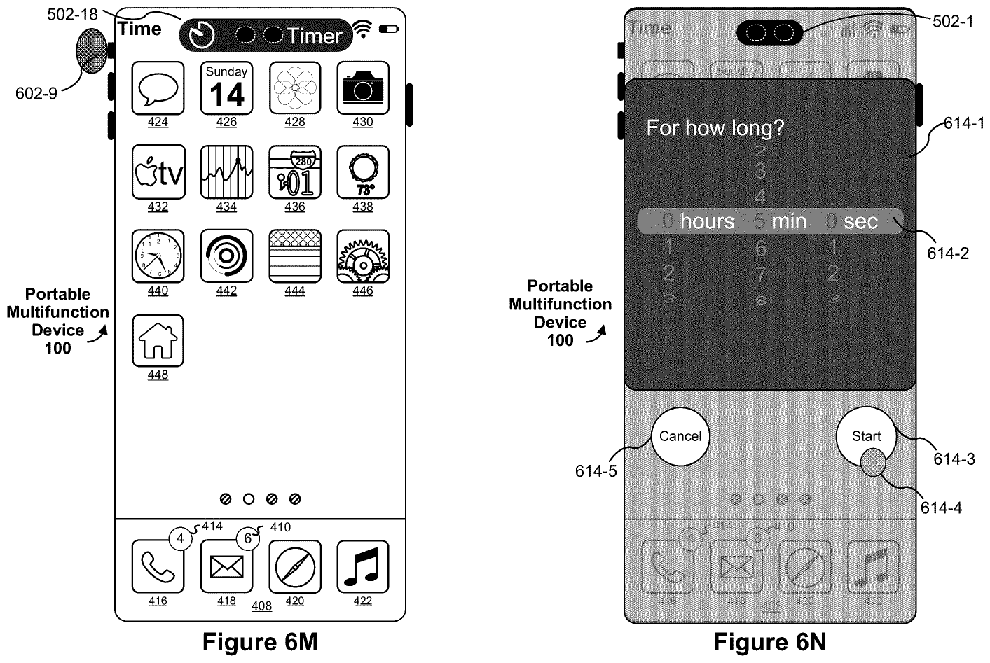

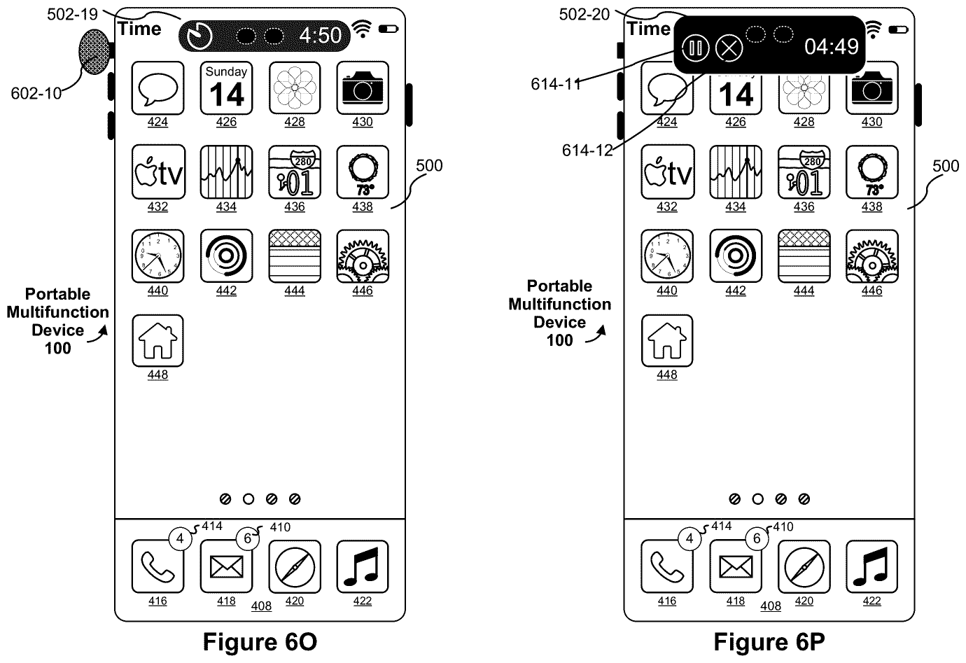

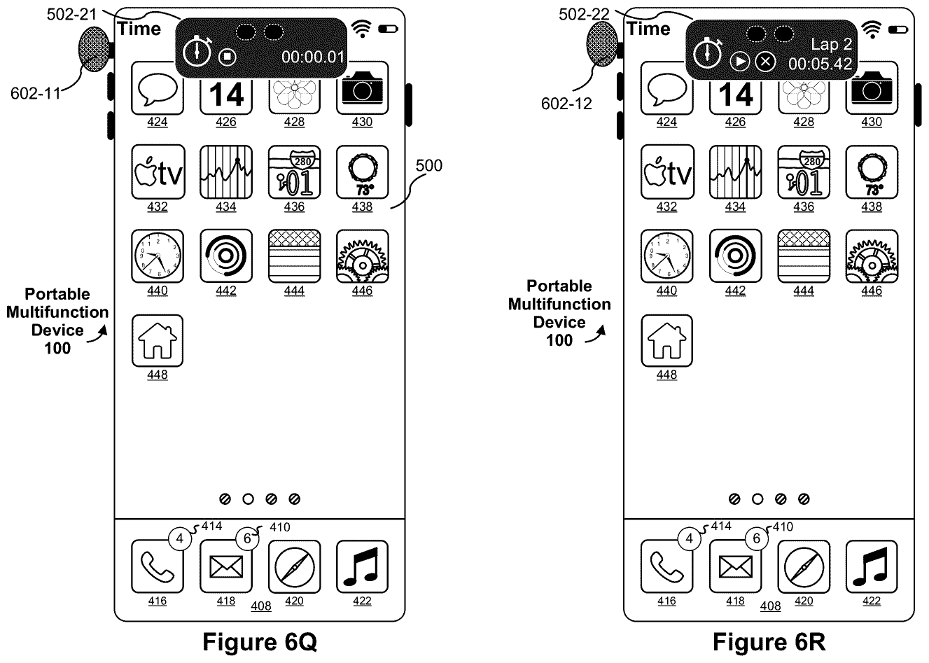

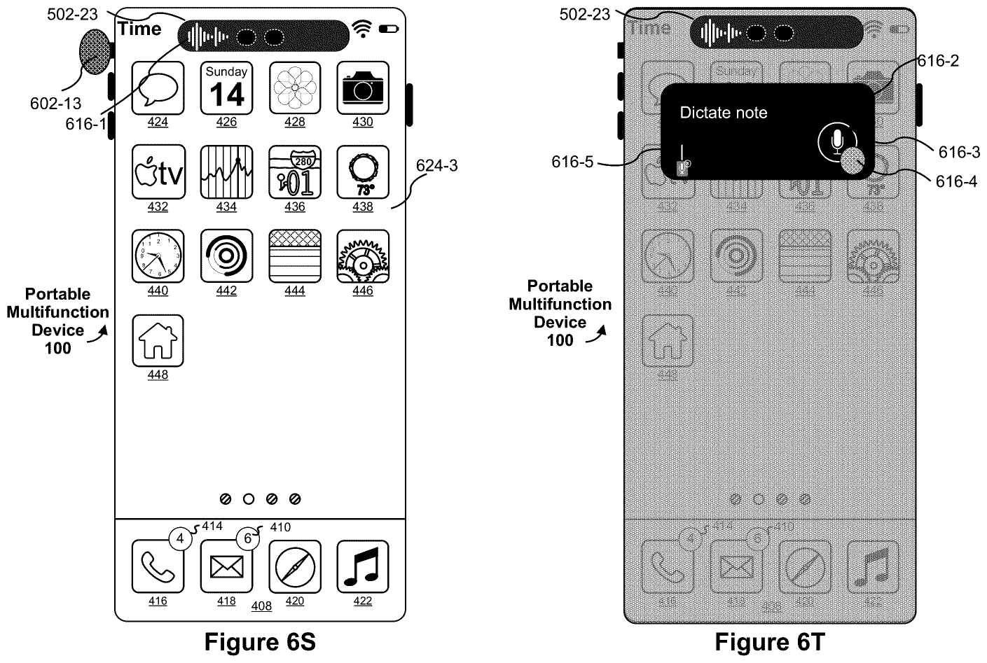

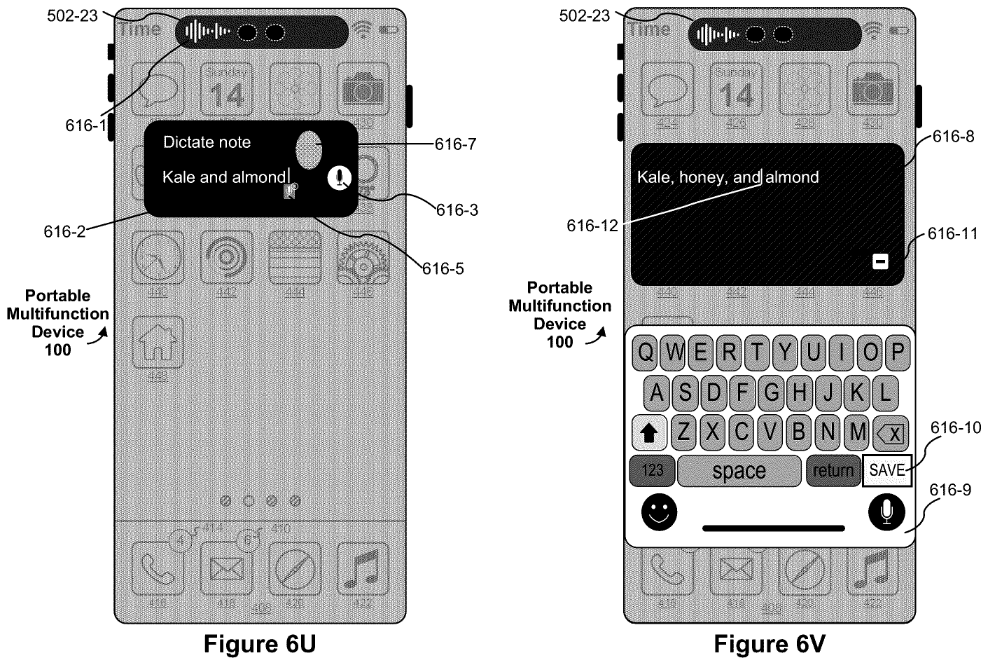

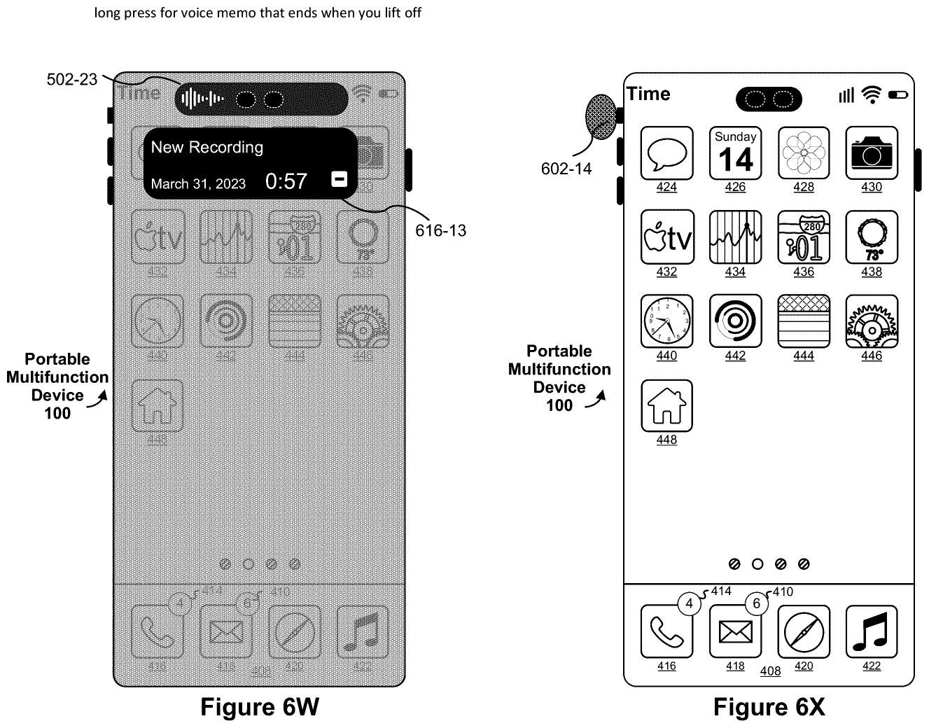

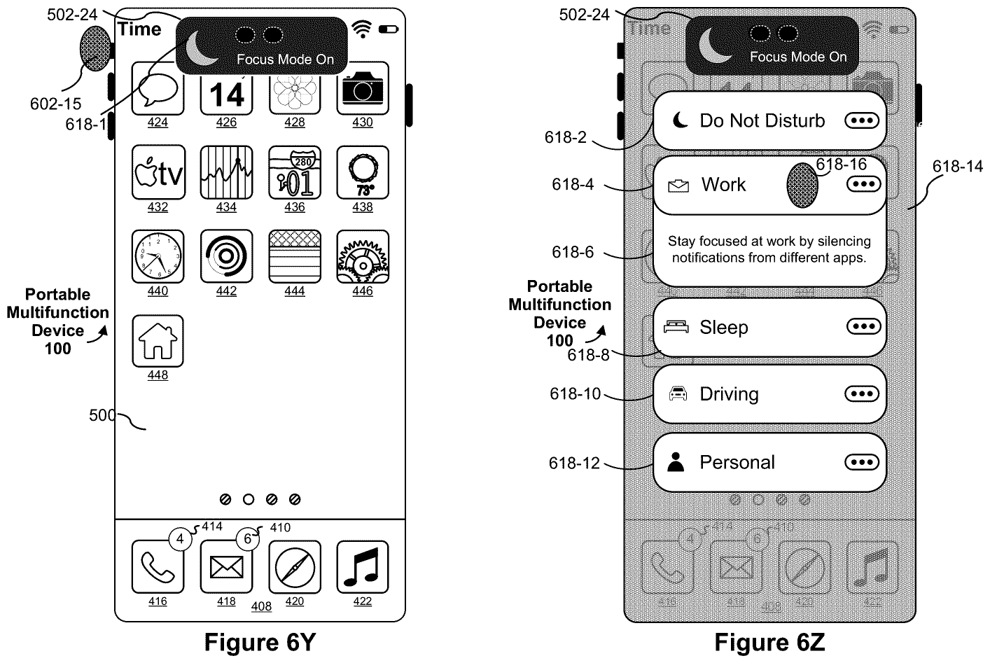

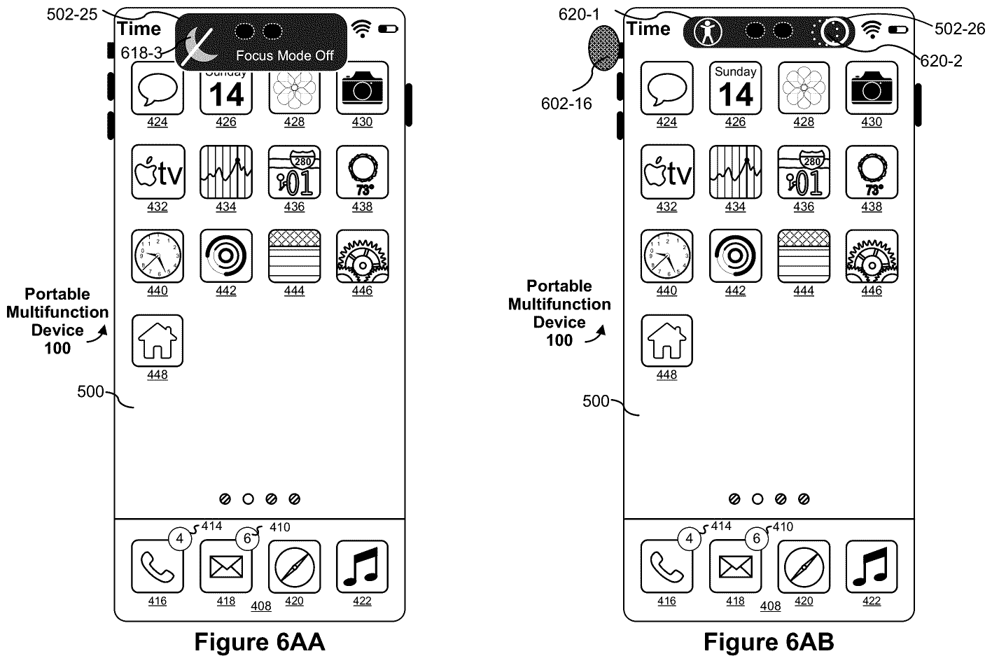

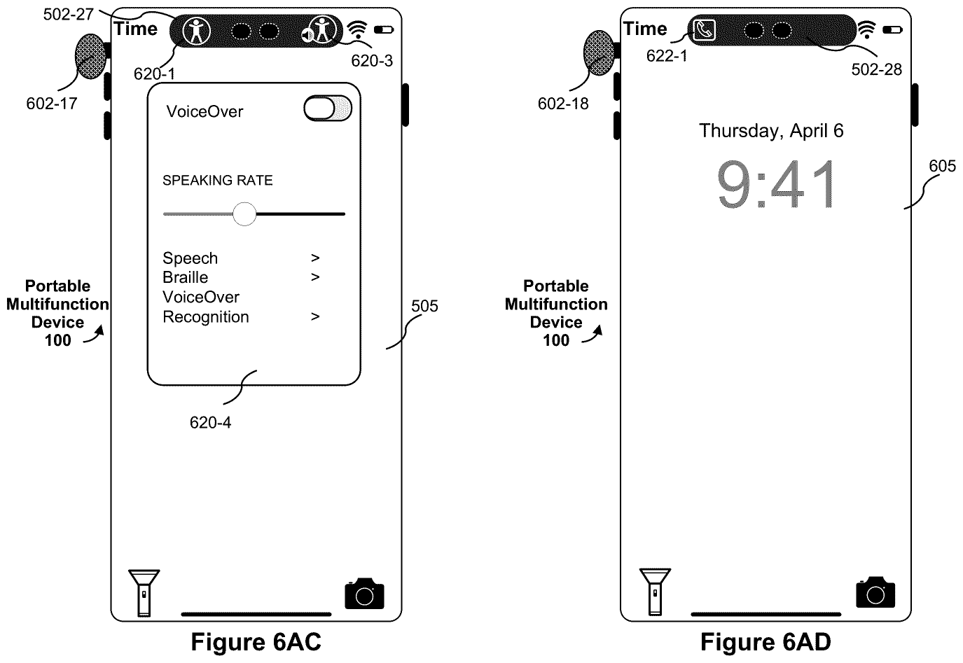

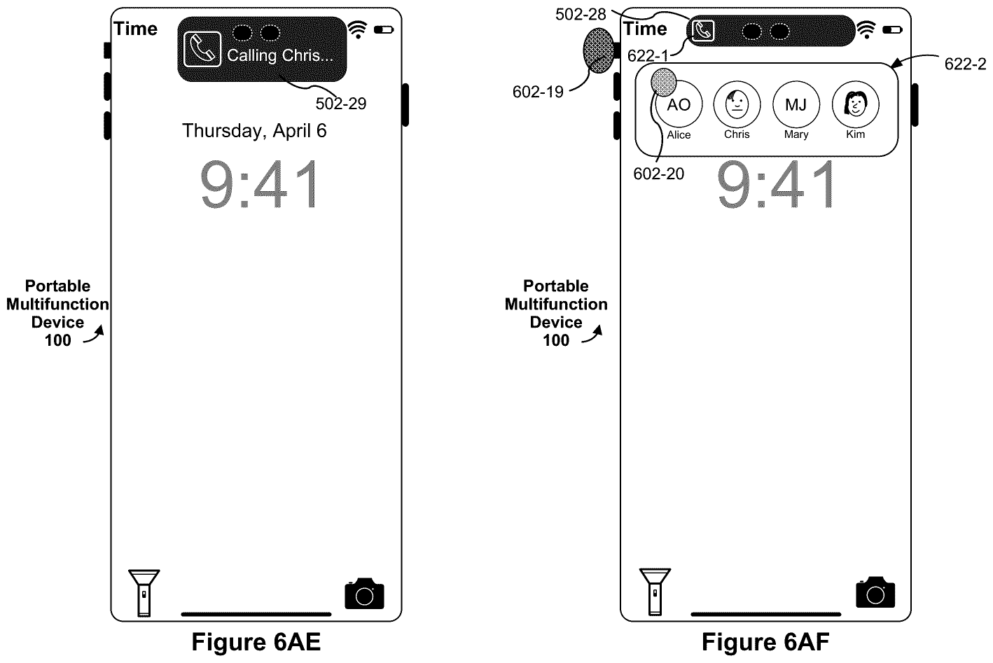

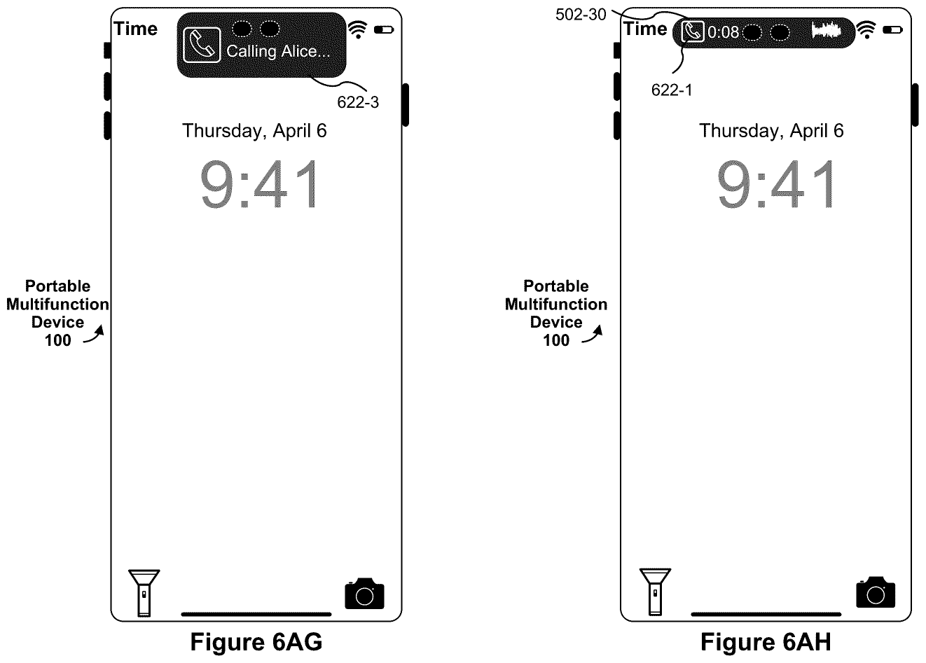

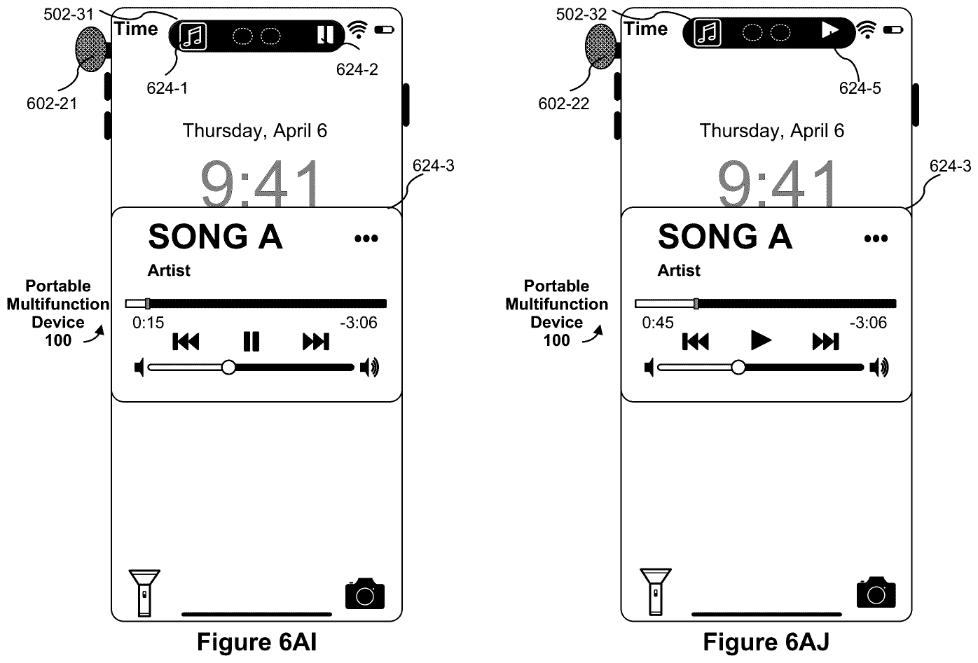

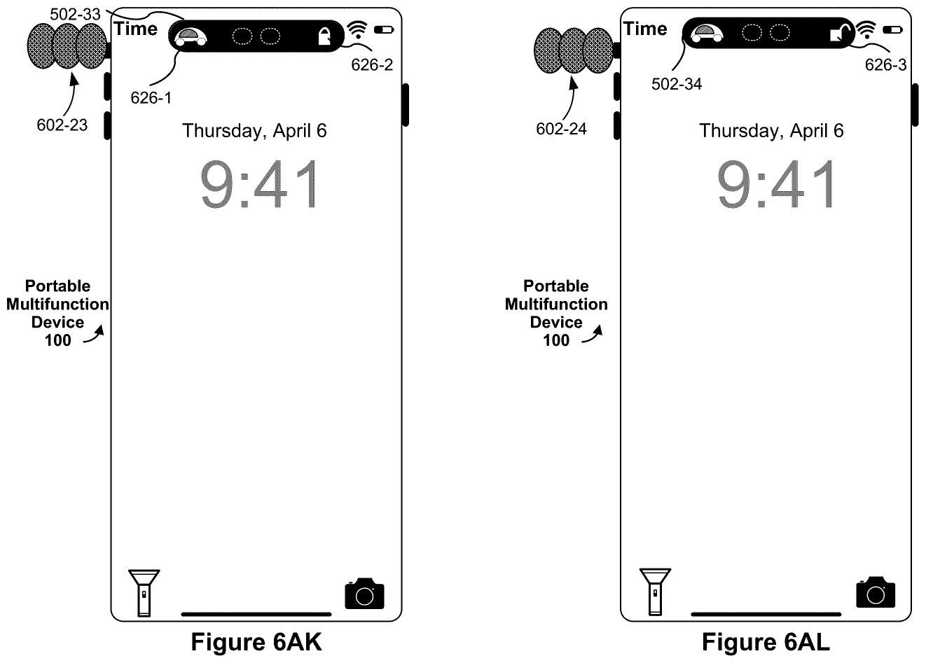

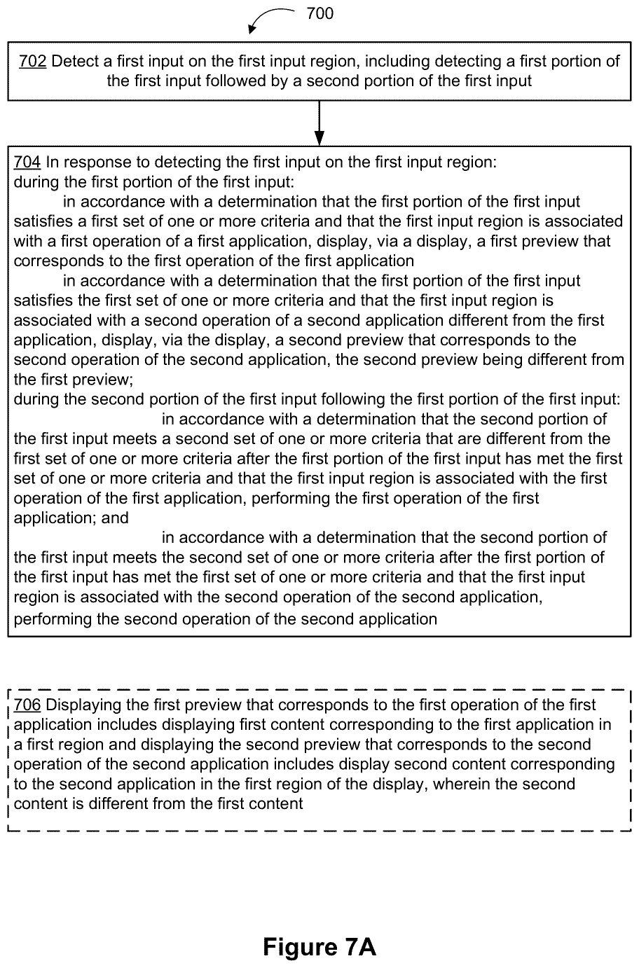

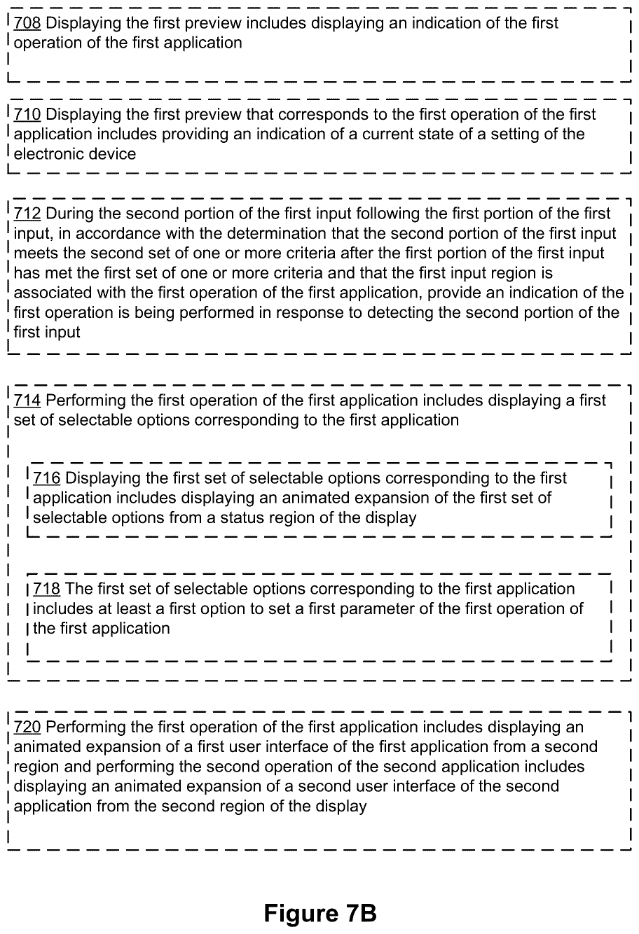

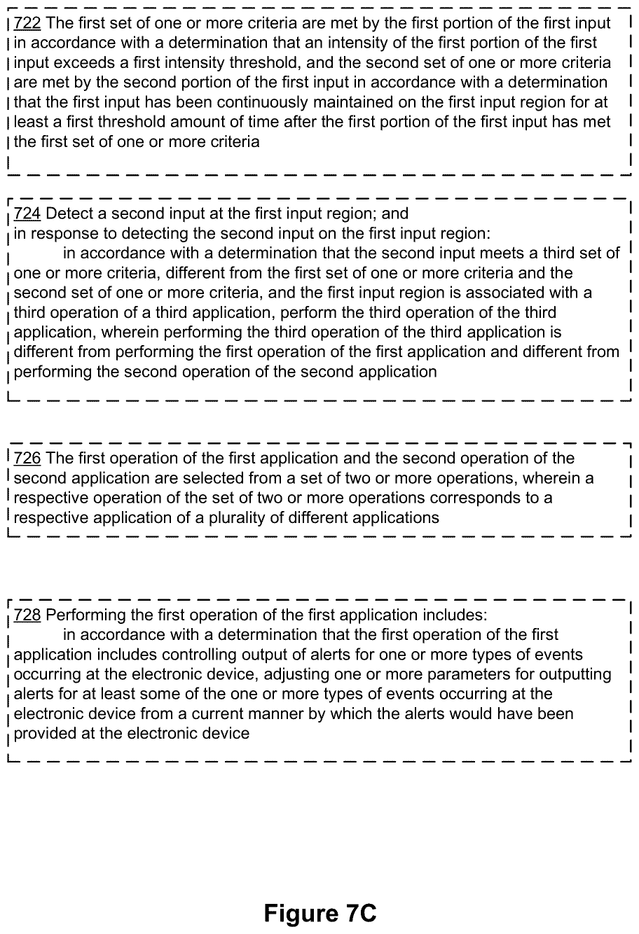

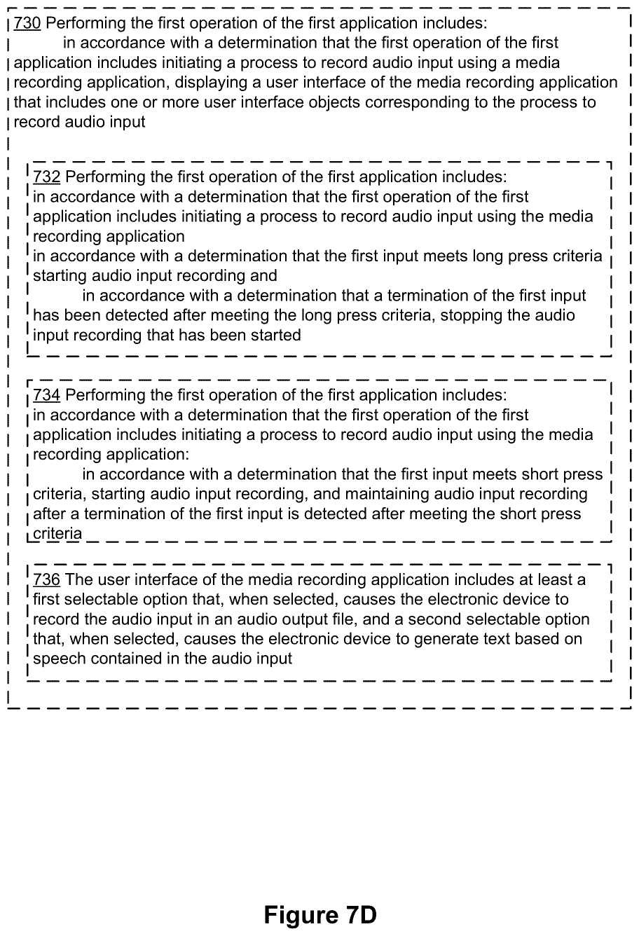

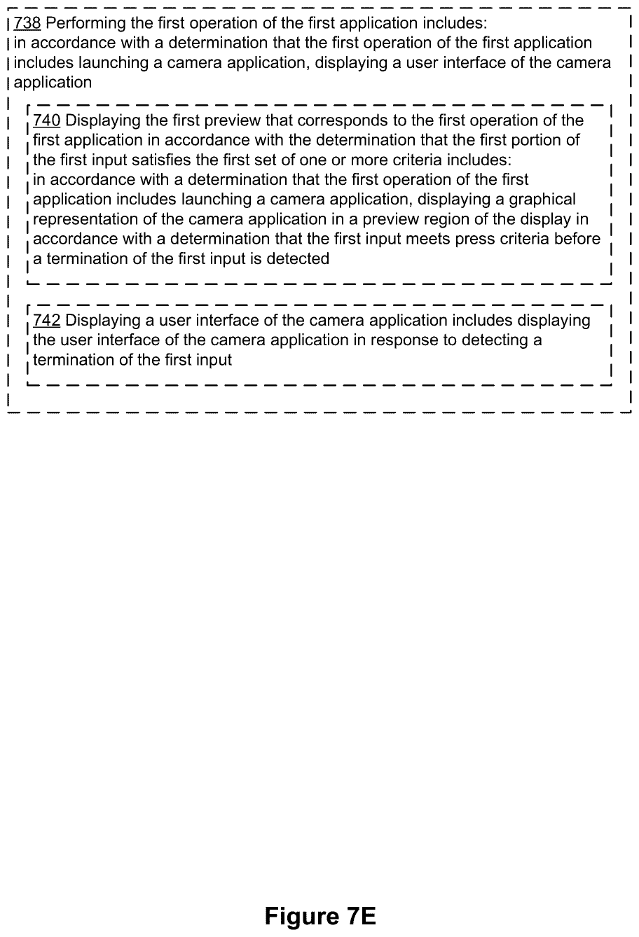

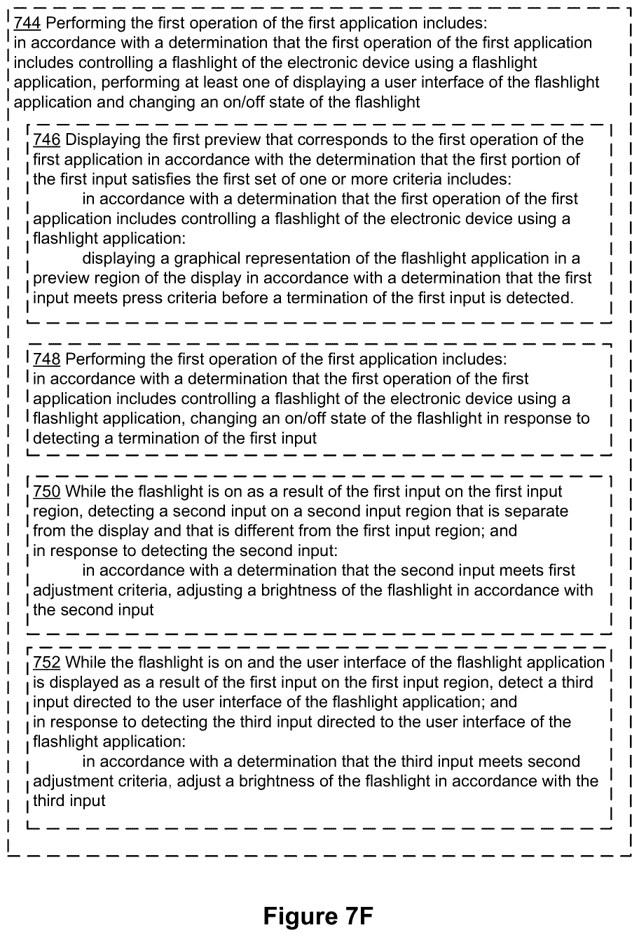

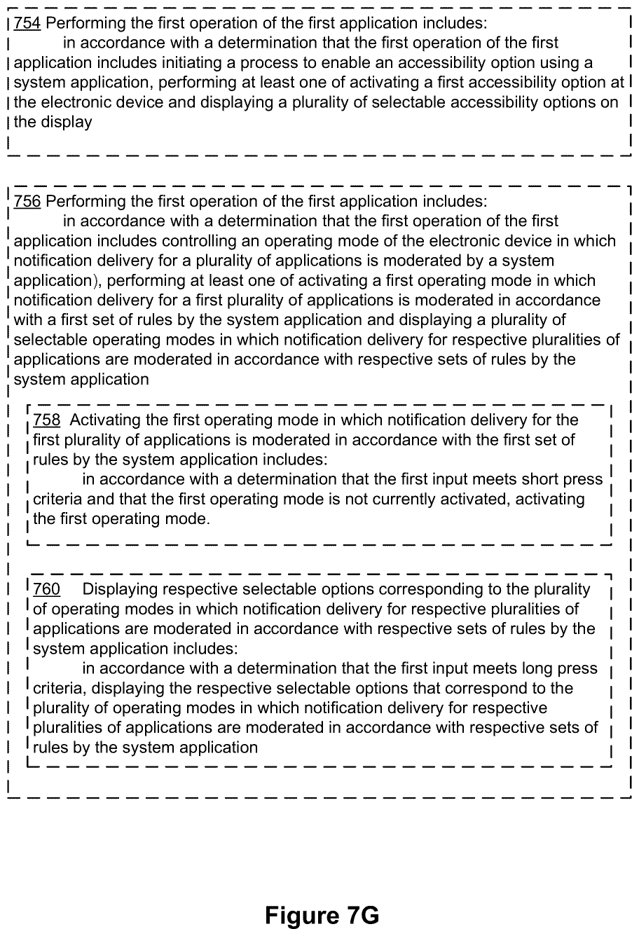

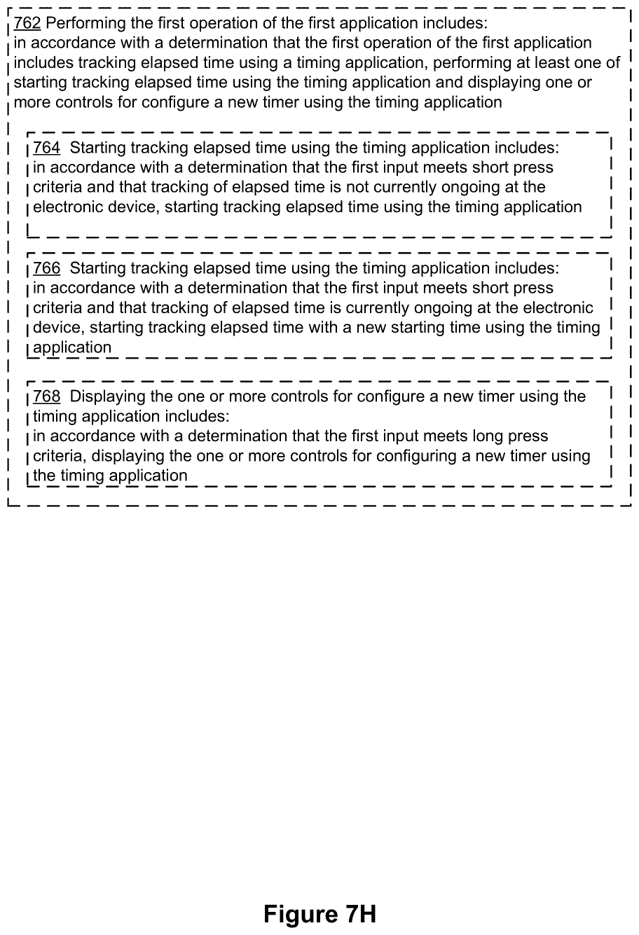

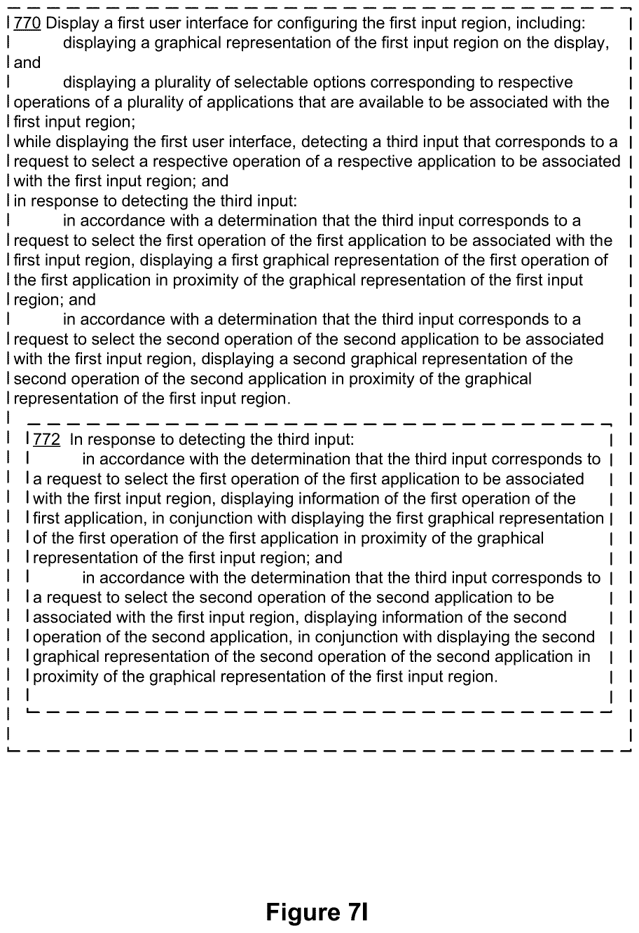

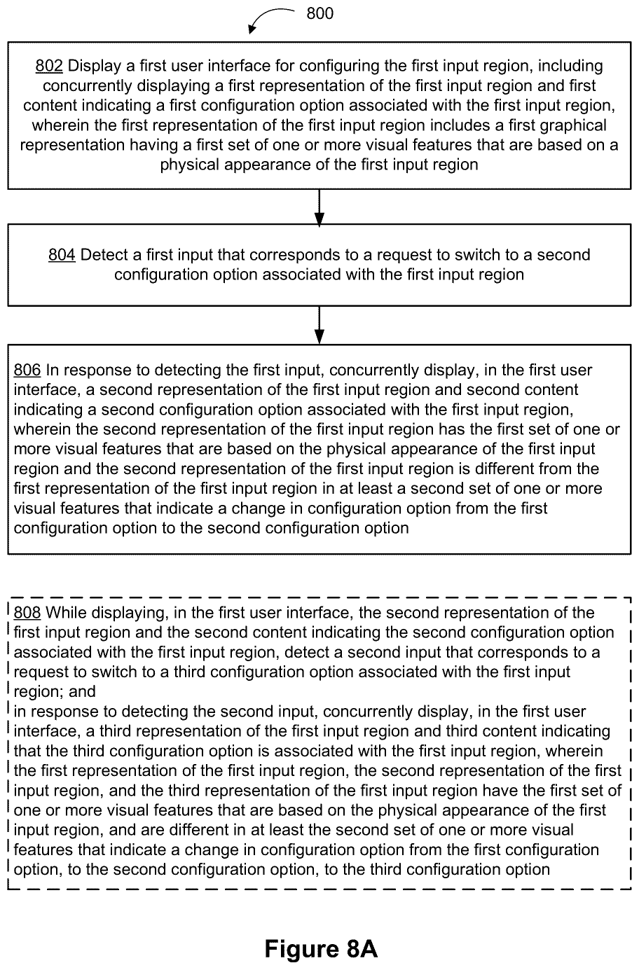

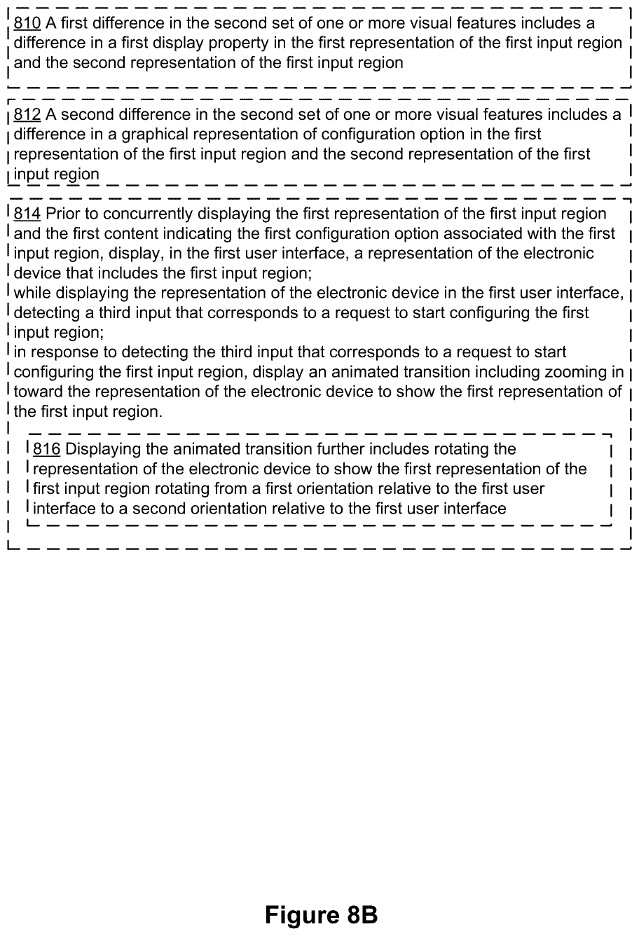

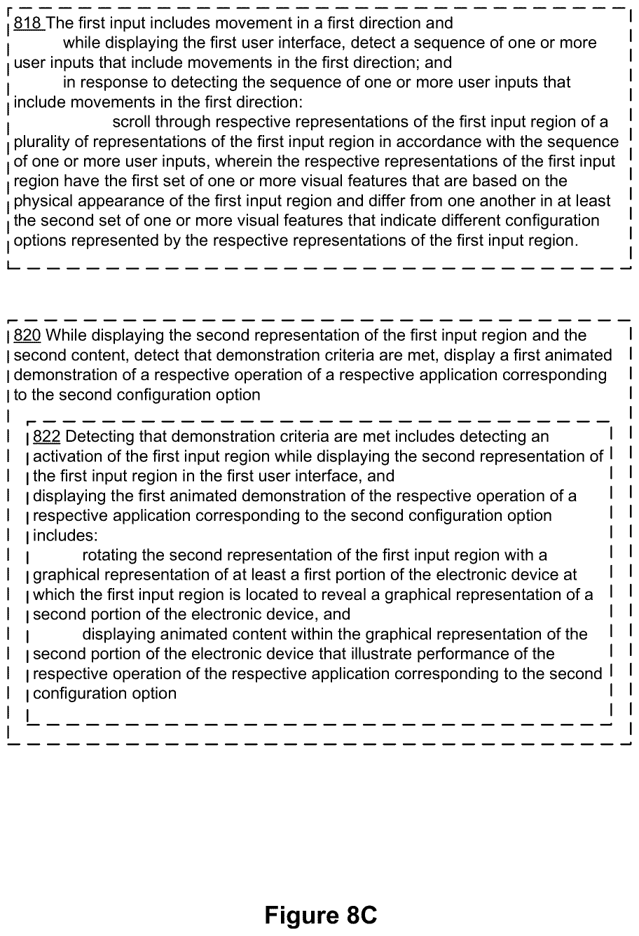

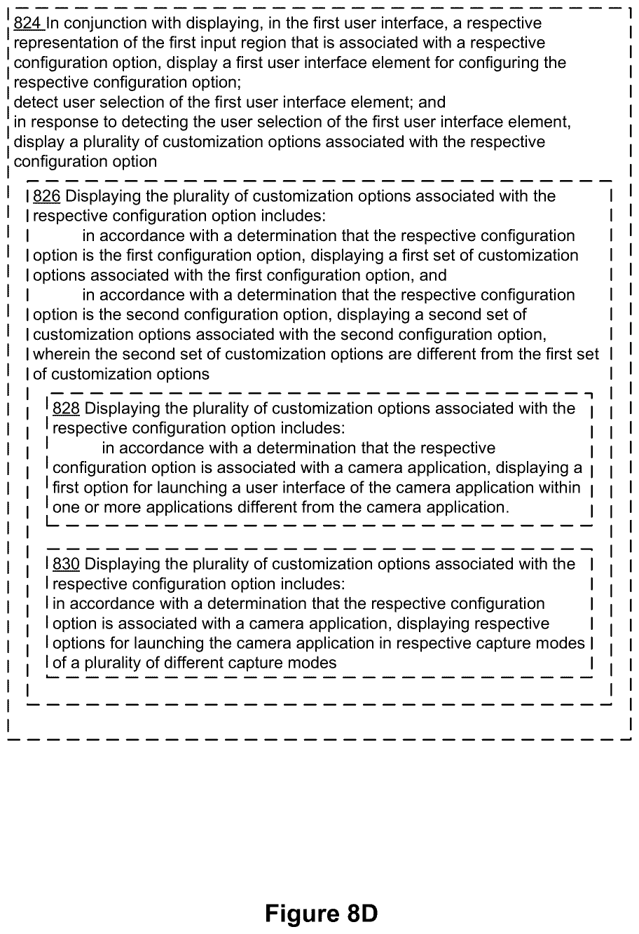

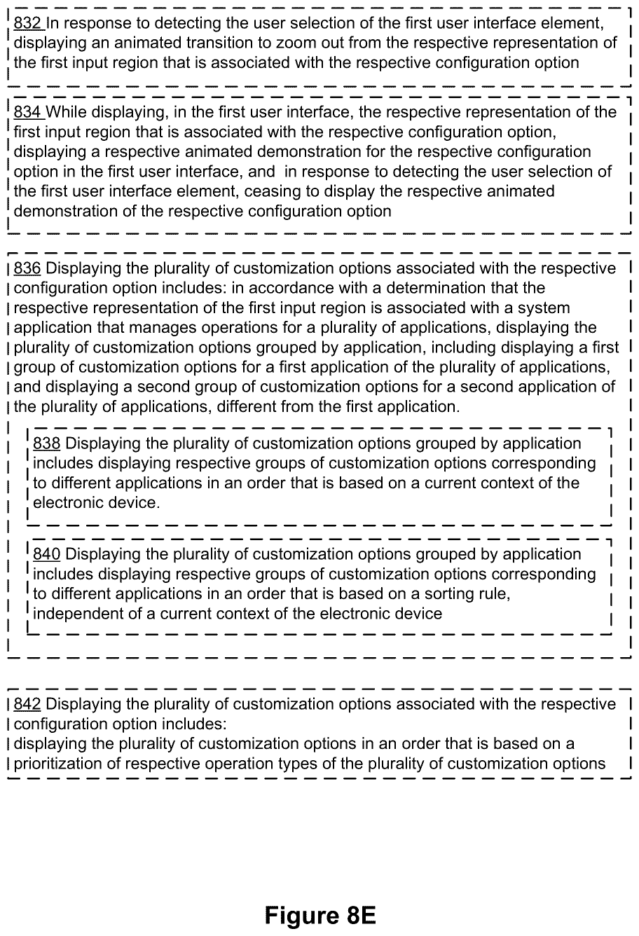

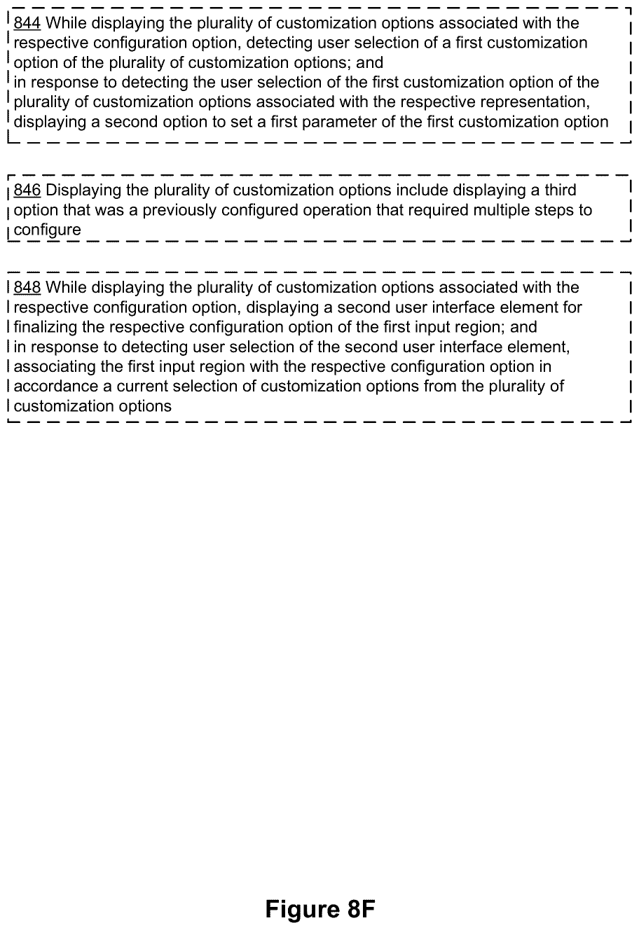

Below, FIGS. 1A-1B, 2, and 3 provide a description of example devices. FIGS. 4A-4B and 5A-5AD illustrate example user interfaces for configuring a first input region of device 100. FIGS. 8A-8F illustrate a flow diagram of configuring a first input region of an electronic device. FIGS. 6A-6AL illustrate example user interfaces for interacting with a first input region of device 100. FIGS. 7A-7I illustrate a flow diagram of a method of interacting with first input region. The user interfaces in FIGS. 5A-5AD and FIGS. 6A-6AL are used to illustrate the processes in FIGS. 7A-7I and 8A-8F.

### EXAMPLE DEVICES

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

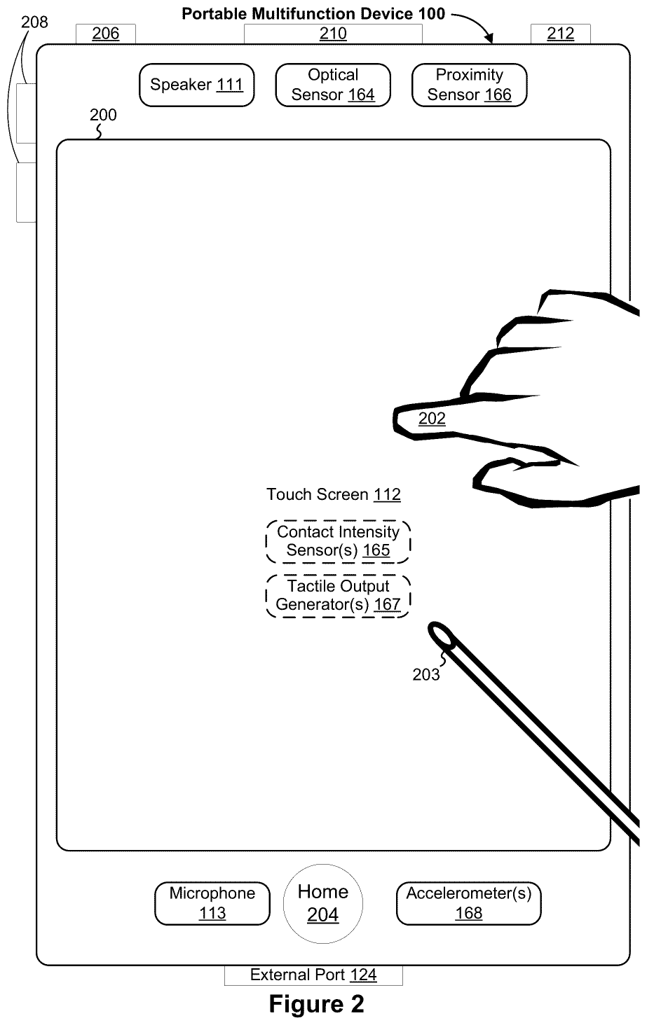

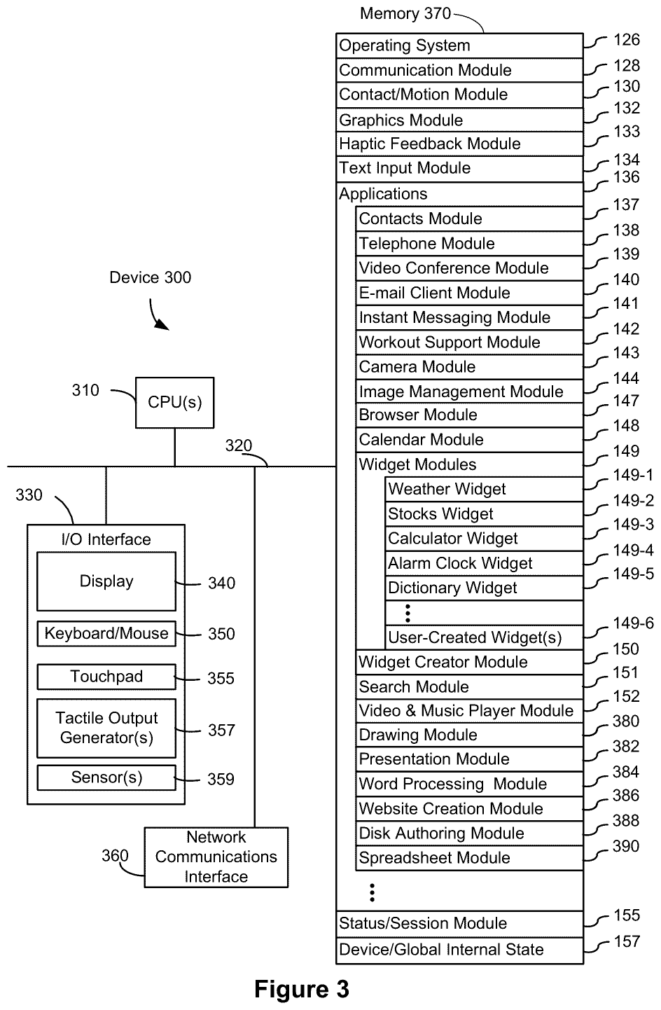

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include one or more physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2). The one or more buttons optionally include a switch or toggle button (e.g., 214, FIG. 2) for transitioning device 100 into or out of a respective associated state or mode.

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in some embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. In some embodiments, memory 102 includes status/session module 155, as shown in FIGS. 1A and 3. Status/session module 155 optionally displays information indicating current status of one or more functions of device 100, such as applications or system software, with currently active sessions. Furthermore, in some embodiments, memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture—which do not require that the intensity of the contact(s) meet a respective intensity threshold in order for the first gesture recognition criteria to be met—are in competition with second gesture recognition criteria for a second gesture—which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153; and/or
map module 154.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, optionally in conjunction with an online video module, include executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3) includes event sorter 170 (e.g., in operating system 126) and a respective application 136-1 (e.g., any of the aforementioned applications 136, 137-154, and 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In some embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In some embodiments, active event recognizer determination module 173 determines that all views that include the physical location of a sub-event are actively involved views, and therefore determines that all actively involved views should receive a particular sequence of sub-events. In some embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In some embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In some embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In some embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 1C is a block diagram illustrating a tactile output module in accordance with some embodiments. In some embodiments, I/O subsystem 106 (e.g., haptic feedback controller 161 (FIG. 1A) and/or other input controller(s) 160 (FIG. 1A)) includes at least some of the example components shown in FIG. 1C. In some embodiments, peripherals interface 118 includes at least some of the example components shown in FIG. 1C.

In some embodiments, the tactile output module includes haptic feedback module 133. In some embodiments, haptic feedback module 133 aggregates and combines tactile outputs for user interface feedback from software applications on the electronic device (e.g., feedback that is responsive to user inputs that correspond to displayed user interfaces and alerts and other notifications that indicate the performance of operations or occurrence of events in user interfaces of the electronic device). Haptic feedback module 133 includes one or more of: waveform module 123 (for providing waveforms used for generating tactile outputs), mixer 125 (for mixing waveforms, such as waveforms in different channels), compressor 127 (for reducing or compressing a dynamic range of the waveforms), low-pass filter 129 (for filtering out high frequency signal components in the waveforms), and thermal controller 131 (for adjusting the waveforms in accordance with thermal conditions). In some embodiments, haptic feedback module 133 is included in haptic feedback controller 161 (FIG. 1A). In some embodiments, a separate unit of haptic feedback module 133 (or a separate implementation of haptic feedback module 133) is also included in an audio controller (e.g., audio circuitry 110, FIG. 1A) and used for generating audio signals. In some embodiments, a single haptic feedback module 133 is used for generating audio signals and generating waveforms for tactile outputs.

In some embodiments, haptic feedback module 133 also includes trigger module 121 (e.g., a software application, operating system, or other software module that determines a tactile output is to be generated and initiates the process for generating the corresponding tactile output). In some embodiments, trigger module 121 generates trigger signals for initiating generation of waveforms (e.g., by waveform module 123). For example, trigger module 121 generates trigger signals based on preset timing criteria. In some embodiments, trigger module 121 receives trigger signals from outside haptic feedback module 133 (e.g., in some embodiments, haptic feedback module 133 receives trigger signals from hardware input processing module 146 located outside haptic feedback module 133) and relays the trigger signals to other components within haptic feedback module 133 (e.g., waveform module 123) or software applications that trigger operations (e.g., with trigger module 121) based on activation of the hardware input device (e.g., a home button). In some embodiments, trigger module 121 also receives tactile feedback generation instructions (e.g., from haptic feedback module 133, FIGS. 1A and 3). In some embodiments, trigger module 121 generates trigger signals in response to haptic feedback module 133 (or trigger module 121 in haptic feedback module 133) receiving tactile feedback instructions (e.g., from haptic feedback module 133, FIGS. 1A and 3).

Waveform module 123 receives trigger signals (e.g., from trigger module 121) as an input, and in response to receiving trigger signals, provides waveforms for generation of one or more tactile outputs (e.g., waveforms selected from a predefined set of waveforms designated for use by waveform module 123, such as the waveforms described in greater detail below with reference to FIGS. 4F-4G).

Mixer 125 receives waveforms (e.g., from waveform module 123) as an input, and mixes together the waveforms. For example, when mixer 125 receives two or more waveforms (e.g., a first waveform in a first channel and a second waveform that at least partially overlaps with the first waveform in a second channel) mixer 125 outputs a combined waveform that corresponds to a sum of the two or more waveforms. In some embodiments, mixer 125 also modifies one or more waveforms of the two or more waveforms to emphasize particular waveform(s) over the rest of the two or more waveforms (e.g., by increasing a scale of the particular waveform(s) and/or decreasing a scale of the rest of the waveforms). In some circumstances, mixer 125 selects one or more waveforms to remove from the combined waveform (e.g., the waveform from the oldest source is dropped when there are waveforms from more than three sources that have been requested to be output concurrently by tactile output generator 167)

Compressor 127 receives waveforms (e.g., a combined waveform from mixer 125) as an input, and modifies the waveforms. In some embodiments, compressor 127 reduces the waveforms (e.g., in accordance with physical specifications of tactile output generators 167 (FIG. 1A) or 357 (FIG. 3)) so that tactile outputs corresponding to the waveforms are reduced. In some embodiments, compressor 127 limits the waveforms, such as by enforcing a predefined maximum amplitude for the waveforms. For example, compressor 127 reduces amplitudes of portions of waveforms that exceed a predefined amplitude threshold while maintaining amplitudes of portions of waveforms that do not exceed the predefined amplitude threshold. In some embodiments, compressor 127 reduces a dynamic range of the waveforms. In some embodiments, compressor 127 dynamically reduces the dynamic range of the waveforms so that the combined waveforms remain within performance specifications of the tactile output generator 167 (e.g., force and/or moveable mass displacement limits).

Low-pass filter 129 receives waveforms (e.g., compressed waveforms from compressor 127) as an input, and filters (e.g., smooths) the waveforms (e.g., removes or reduces high frequency signal components in the waveforms). For example, in some instances, compressor 127 includes, in compressed waveforms, extraneous signals (e.g., high frequency signal components) that interfere with the generation of tactile outputs and/or exceed performance specifications of tactile output generator 167 when the tactile outputs are generated in accordance with the compressed waveforms. Low-pass filter 129 reduces or removes such extraneous signals in the waveforms.

Thermal controller 131 receives waveforms (e.g., filtered waveforms from low-pass filter 129) as an input, and adjusts the waveforms in accordance with thermal conditions of device 100 (e.g., based on internal temperatures detected within device 100, such as the temperature of haptic feedback controller 161, and/or external temperatures detected by device 100). For example, in some cases, the output of haptic feedback controller 161 varies depending on the temperature (e.g. haptic feedback controller 161, in response to receiving same waveforms, generates a first tactile output when haptic feedback controller 161 is at a first temperature and generates a second tactile output when haptic feedback controller 161 is at a second temperature that is distinct from the first temperature). For example, the magnitude (or the amplitude) of the tactile outputs may vary depending on the temperature. To reduce the effect of the temperature variations, the waveforms are modified (e.g., an amplitude of the waveforms is increased or decreased based on the temperature).

In some embodiments, haptic feedback module 133 (e.g., trigger module 121) is coupled to hardware input processing module 146. In some embodiments, other input controller(s) 160 in FIG. 1A includes hardware input processing module 146. In some embodiments, hardware input processing module 146 receives inputs from hardware input device 145 (e.g., other input or control devices 116 in FIG. 1A, such as a home button). In some embodiments, hardware input device 145 is any input device described herein, such as touch-sensitive display system 112 (FIG. 1A), keyboard/mouse 350 (FIG. 3), touchpad 355 (FIG. 3), one of other input or control devices 116 (FIG. 1A), or an intensity-sensitive home button (e.g., as shown in FIG. 2B or a home button with a mechanical actuator as illustrated in FIG. 2C). In some embodiments, hardware input device 145 consists of an intensity-sensitive home button (e.g., as shown in FIG. 2B or a home button with a mechanical actuator as illustrated in FIG. 2C), and not touch-sensitive display system 112 (FIG. 1A), keyboard/mouse 350 (FIG. 3), or touchpad 355 (FIG. 3). In some embodiments, in response to inputs from hardware input device 145, hardware input processing module 146 provides one or more trigger signals to haptic feedback module 133 to indicate that a user input satisfying predefined input criteria, such as an input corresponding to a “click” of a home button (e.g., a “down click” or an “up click”), has been detected. In some embodiments, haptic feedback module 133 provides waveforms that correspond to the “click” of a home button in response to the input corresponding to the “click” of a home button, simulating a haptic feedback of pressing a physical home button.

In some embodiments, the tactile output module includes haptic feedback controller 161 (e.g., haptic feedback controller 161 in FIG. 1A), which controls the generation of tactile outputs. In some embodiments, haptic feedback controller 161 is coupled to a plurality of tactile output generators, and selects one or more tactile output generators of the plurality of tactile output generators and sends waveforms to the selected one or more tactile output generators for generating tactile outputs. In some embodiments, haptic feedback controller 161 coordinates tactile output requests that correspond to activation of hardware input device 145 and tactile output requests that correspond to software events (e.g., tactile output requests from haptic feedback module 133) and modifies one or more waveforms of the two or more waveforms to emphasize particular waveform(s) over the rest of the two or more waveforms (e.g., by increasing a scale of the particular waveform(s) and/or decreasing a scale of the rest of the waveforms, such as to prioritize tactile outputs that correspond to activations of hardware input device 145 over tactile outputs that correspond to software events).

In some embodiments, as shown in FIG. 1C, an output of haptic feedback controller 161 is coupled to audio circuitry of device 100 (e.g., audio circuitry 110, FIG. 1A), and provides audio signals to audio circuitry of device 100. In some embodiments, haptic feedback controller 161 provides both waveforms used for generating tactile outputs and audio signals used for providing audio outputs in conjunction with generation of the tactile outputs. In some embodiments, haptic feedback controller 161 modifies audio signals and/or waveforms (used for generating tactile outputs) so that the audio outputs and the tactile outputs are synchronized (e.g., by delaying the audio signals and/or waveforms). In some embodiments, haptic feedback controller 161 includes a digital-to-analog converter used for converting digital waveforms into analog signals, which are received by amplifier 163 and/or tactile output generator 167.

In some embodiments, the tactile output module includes amplifier 163. In some embodiments, amplifier 163 receives waveforms (e.g., from haptic feedback controller 161) and amplifies the waveforms prior to sending the amplified waveforms to tactile output generator 167 (e.g., any of tactile output generators 167 (FIG. 1A) or 357 (FIG. 3)). For example, amplifier 163 amplifies the received waveforms to signal levels that are in accordance with physical specifications of tactile output generator 167 (e.g., to a voltage and/or a current required by tactile output generator 167 for generating tactile outputs so that the signals sent to tactile output generator 167 produce tactile outputs that correspond to the waveforms received from haptic feedback controller 161) and sends the amplified waveforms to tactile output generator 167. In response, tactile output generator 167 generates tactile outputs (e.g., by shifting a moveable mass back and forth in one or more dimensions relative to a neutral position of the moveable mass).

In some embodiments, the tactile output module includes sensor 169, which is coupled to tactile output generator 167. Sensor 169 detects states or state changes (e.g., mechanical position, physical displacement, and/or movement) of tactile output generator 167 or one or more components of tactile output generator 167 (e.g., one or more moving parts, such as a membrane, used to generate tactile outputs). In some embodiments, sensor 169 is a magnetic field sensor (e.g., a Hall effect sensor) or other displacement and/or movement sensor. In some embodiments, sensor 169 provides information (e.g., a position, a displacement, and/or a movement of one or more parts in tactile output generator 167) to haptic feedback controller 161 and, in accordance with the information provided by sensor 169 about the state of tactile output generator 167, haptic feedback controller 161 adjusts the waveforms output from haptic feedback controller 161 (e.g., waveforms sent to tactile output generator 167, optionally via amplifier 163).

FIG. 1C is a block diagram illustrating a tactile output module in accordance with some embodiments. In some embodiments, I/O subsystem 106 (e.g., haptic feedback controller 161 (FIG. 1A) and/or other input controller(s) 160 (FIG. 1A)) includes at least some of the example components shown in FIG. 1C. In some embodiments, peripherals interface 118 includes at least some of the example components shown in FIG. 1C.

In some embodiments, the tactile output module includes haptic feedback module 133. In some embodiments, haptic feedback module 133 aggregates and combines tactile outputs for user interface feedback from software applications on the electronic device (e.g., feedback that is responsive to user inputs that correspond to displayed user interfaces and alerts and other notifications that indicate the performance of operations or occurrence of events in user interfaces of the electronic device). Haptic feedback module 133 includes one or more of: waveform module 123 (for providing waveforms used for generating tactile outputs), mixer 125 (for mixing waveforms, such as waveforms in different channels), compressor 127 (for reducing or compressing a dynamic range of the waveforms), low-pass filter 129 (for filtering out high frequency signal components in the waveforms), and thermal controller 131 (for adjusting the waveforms in accordance with thermal conditions). In some embodiments, haptic feedback module 133 is included in haptic feedback controller 161 (FIG. 1A). In some embodiments, a separate unit of haptic feedback module 133 (or a separate implementation of haptic feedback module 133) is also included in an audio controller (e.g., audio circuitry 110, FIG. 1A) and used for generating audio signals. In some embodiments, a single haptic feedback module 133 is used for generating audio signals and generating waveforms for tactile outputs.

In some embodiments, haptic feedback module 133 also includes trigger module 121 (e.g., a software application, operating system, or other software module that determines a tactile output is to be generated and initiates the process for generating the corresponding tactile output). In some embodiments, trigger module 121 generates trigger signals for initiating generation of waveforms (e.g., by waveform module 123). For example, trigger module 121 generates trigger signals based on preset timing criteria. In some embodiments, trigger module 121 receives trigger signals from outside haptic feedback module 133 (e.g., in some embodiments, haptic feedback module 133 receives trigger signals from hardware input processing module 146 located outside haptic feedback module 133) and relays the trigger signals to other components within haptic feedback module 133 (e.g., waveform module 123) or software applications that trigger operations (e.g., with trigger module 121) based on activation of the hardware input device (e.g., a home button). In some embodiments, trigger module 121 also receives tactile feedback generation instructions (e.g., from haptic feedback module 133, FIGS. 1A and 3). In some embodiments, trigger module 121 generates trigger signals in response to haptic feedback module 133 (or trigger module 121 in haptic feedback module 133) receiving tactile feedback instructions (e.g., from haptic feedback module 133, FIGS. 1A and 3).

Waveform module 123 receives trigger signals (e.g., from trigger module 121) as an input, and in response to receiving trigger signals, provides waveforms for generation of one or more tactile outputs (e.g., waveforms selected from a predefined set of waveforms designated for use by waveform module 123, such as the waveforms described in greater detail below with reference to FIGS. 4F-4G).

Mixer 125 receives waveforms (e.g., from waveform module 123) as an input, and mixes together the waveforms. For example, when mixer 125 receives two or more waveforms (e.g., a first waveform in a first channel and a second waveform that at least partially overlaps with the first waveform in a second channel) mixer 125 outputs a combined waveform that corresponds to a sum of the two or more waveforms. In some embodiments, mixer 125 also modifies one or more waveforms of the two or more waveforms to emphasize particular waveform(s) over the rest of the two or more waveforms (e.g., by increasing a scale of the particular waveform(s) and/or decreasing a scale of the rest of the waveforms). In some circumstances, mixer 125 selects one or more waveforms to remove from the combined waveform (e.g., the waveform from the oldest source is dropped when there are waveforms from more than three sources that have been requested to be output concurrently by tactile output generator 167)

Compressor 127 receives waveforms (e.g., a combined waveform from mixer 125) as an input, and modifies the waveforms. In some embodiments, compressor 127 reduces the waveforms (e.g., in accordance with physical specifications of tactile output generators 167 (FIG. 1A) or 357 (FIG. 3)) so that tactile outputs corresponding to the waveforms are reduced. In some embodiments, compressor 127 limits the waveforms, such as by enforcing a predefined maximum amplitude for the waveforms. For example, compressor 127 reduces amplitudes of portions of waveforms that exceed a predefined amplitude threshold while maintaining amplitudes of portions of waveforms that do not exceed the predefined amplitude threshold. In some embodiments, compressor 127 reduces a dynamic range of the waveforms. In some embodiments, compressor 127 dynamically reduces the dynamic range of the waveforms so that the combined waveforms remain within performance specifications of the tactile output generator 167 (e.g., force and/or moveable mass displacement limits).

Low-pass filter 129 receives waveforms (e.g., compressed waveforms from compressor 127) as an input, and filters (e.g., smooths) the waveforms (e.g., removes or reduces high frequency signal components in the waveforms). For example, in some instances, compressor 127 includes, in compressed waveforms, extraneous signals (e.g., high frequency signal components) that interfere with the generation of tactile outputs and/or exceed performance specifications of tactile output generator 167 when the tactile outputs are generated in accordance with the compressed waveforms. Low-pass filter 129 reduces or removes such extraneous signals in the waveforms.

Thermal controller 131 receives waveforms (e.g., filtered waveforms from low-pass filter 129) as an input, and adjusts the waveforms in accordance with thermal conditions of device 100 (e.g., based on internal temperatures detected within device 100, such as the temperature of haptic feedback controller 161, and/or external temperatures detected by device 100). For example, in some cases, the output of haptic feedback controller 161 varies depending on the temperature (e.g. haptic feedback controller 161, in response to receiving same waveforms, generates a first tactile output when haptic feedback controller 161 is at a first temperature and generates a second tactile output when haptic feedback controller 161 is at a second temperature that is distinct from the first temperature). For example, the magnitude (or the amplitude) of the tactile outputs may vary depending on the temperature. To reduce the effect of the temperature variations, the waveforms are modified (e.g., an amplitude of the waveforms is increased or decreased based on the temperature).

In some embodiments, haptic feedback module 133 (e.g., trigger module 121) is coupled to hardware input processing module 146. In some embodiments, other input controller(s) 160 in FIG. 1A includes hardware input processing module 146. In some embodiments, hardware input processing module 146 receives inputs from hardware input device 145 (e.g., other input or control devices 116 in FIG. 1A, such as a home button). In some embodiments, hardware input device 145 is any input device described herein, such as touch-sensitive display system 112 (FIG. 1A), keyboard/mouse 350 (FIG. 3), touchpad 355 (FIG. 3), one of other input or control devices 116 (FIG. 1A), or an intensity-sensitive home button (e.g., as shown in FIG. 2B or a home button with a mechanical actuator as illustrated in FIG. 2C). In some embodiments, hardware input device 145 consists of an intensity-sensitive home button (e.g., as shown in FIG. 2B or a home button with a mechanical actuator as illustrated in FIG. 2C), and not touch-sensitive display system 112 (FIG. 1A), keyboard/mouse 350 (FIG. 3), or touchpad 355 (FIG. 3). In some embodiments, in response to inputs from hardware input device 145, hardware input processing module 146 provides one or more trigger signals to haptic feedback module 133 to indicate that a user input satisfying predefined input criteria, such as an input corresponding to a “click” of a home button (e.g., a “down click” or an “up click”), has been detected. In some embodiments, haptic feedback module 133 provides waveforms that correspond to the “click” of a home button in response to the input corresponding to the “click” of a home button, simulating a haptic feedback of pressing a physical home button.

In some embodiments, the tactile output module includes haptic feedback controller 161 (e.g., haptic feedback controller 161 in FIG. 1A), which controls the generation of tactile outputs. In some embodiments, haptic feedback controller 161 is coupled to a plurality of tactile output generators, and selects one or more tactile output generators of the plurality of tactile output generators and sends waveforms to the selected one or more tactile output generators for generating tactile outputs. In some embodiments, haptic feedback controller 161 coordinates tactile output requests that correspond to activation of hardware input device 145 and tactile output requests that correspond to software events (e.g., tactile output requests from haptic feedback module 133) and modifies one or more waveforms of the two or more waveforms to emphasize particular waveform(s) over the rest of the two or more waveforms (e.g., by increasing a scale of the particular waveform(s) and/or decreasing a scale of the rest of the waveforms, such as to prioritize tactile outputs that correspond to activations of hardware input device 145 over tactile outputs that correspond to software events).

In some embodiments, as shown in FIG. 1C, an output of haptic feedback controller 161 is coupled to audio circuitry of device 100 (e.g., audio circuitry 110, FIG. 1A), and provides audio signals to audio circuitry of device 100. In some embodiments, haptic feedback controller 161 provides both waveforms used for generating tactile outputs and audio signals used for providing audio outputs in conjunction with generation of the tactile outputs. In some embodiments, haptic feedback controller 161 modifies audio signals and/or waveforms (used for generating tactile outputs) so that the audio outputs and the tactile outputs are synchronized (e.g., by delaying the audio signals and/or waveforms). In some embodiments, haptic feedback controller 161 includes a digital-to-analog converter used for converting digital waveforms into analog signals, which are received by amplifier 163 and/or tactile output generator 167.

In some embodiments, the tactile output module includes amplifier 163. In some embodiments, amplifier 163 receives waveforms (e.g., from haptic feedback controller 161) and amplifies the waveforms prior to sending the amplified waveforms to tactile output generator 167 (e.g., any of tactile output generators 167 (FIG. 1A) or 357 (FIG. 3)). For example, amplifier 163 amplifies the received waveforms to signal levels that are in accordance with physical specifications of tactile output generator 167 (e.g., to a voltage and/or a current required by tactile output generator 167 for generating tactile outputs so that the signals sent to tactile output generator 167 produce tactile outputs that correspond to the waveforms received from haptic feedback controller 161) and sends the amplified waveforms to tactile output generator 167. In response, tactile output generator 167 generates tactile outputs (e.g., by shifting a moveable mass back and forth in one or more dimensions relative to a neutral position of the moveable mass).

In some embodiments, the tactile output module includes sensor 169, which is coupled to tactile output generator 167. Sensor 169 detects states or state changes (e.g., mechanical position, physical displacement, and/or movement) of tactile output generator 167 or one or more components of tactile output generator 167 (e.g., one or more moving parts, such as a membrane, used to generate tactile outputs). In some embodiments, sensor 169 is a magnetic field sensor (e.g., a Hall effect sensor) or other displacement and/or movement sensor. In some embodiments, sensor 169 provides information (e.g., a position, a displacement, and/or a movement of one or more parts in tactile output generator 167) to haptic feedback controller 161 and, in accordance with the information provided by sensor 169 about the state of tactile output generator 167, haptic feedback controller 161 adjusts the waveforms output from haptic feedback controller 161 (e.g., waveforms sent to tactile output generator 167, optionally via amplifier 163).

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), side button 206 for powering the device on/off and locking the device, volume adjustment button(s) 208, Subscriber Identity Module (SIM) card slot 210, head set jack 212, switch 214 for transitioning the device between an audio output mode and a silent or vibrate (or other reduced audio output) mode, and/or docking/charging external port 124. Side button 206 is, optionally, used to turn the power on/off on the device by depressing the button (or otherwise applying a sufficient input intensity, such as for a solid-state button) and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3 is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, optionally labeled “Phone,” which optionally includes an indicator 414 of the number of missed calls or voicemail messages;
   Icon 418 for e-mail client module 140, optionally labeled “Mail,” which optionally includes an indicator 410 of the number of unread e-mails;
   Icon 420 for browser module 147, optionally labeled “Browser”; and
   Icon 422 for video and music player module 152, optionally labeled “Music”; and
Icons for other applications, such as:
   Icon 424 for IM module 141, optionally labeled “Messages”;
   Icon 426 for calendar module 148, optionally labeled “Calendar”;
   Icon 428 for image management module 144, optionally labeled “Photos”;
   Icon 430 for camera module 143, optionally labeled “Camera”;
   Icon 432 for an online video module, optionally labeled “Online Video”;
   Icon 434 for stocks widget 149-2, optionally labeled “Stocks”;
   Icon 436 for map module 154, optionally labeled “Maps”;
   Icon 438 for weather widget 149-1, optionally labeled “Weather”;
   Icon 440 for alarm clock widget 149-4, optionally labeled “Clock”;
   Icon 442 for workout support module 142, optionally labeled “Workout Support”;
   Icon 444 for notes module 153, optionally labeled “Notes”; and
   Icon 446 for a settings application or module, which provides access to settings for device 100 and its various applications 136; and
   Icon 448 for a home automation application or module, optionally of applications 136, which provides access to and control over physical home features such as lights, locks, cameras, and the like.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3) with a touch-sensitive surface 451 (e.g., a tablet or touchpad 355, FIG. 3) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device). USER INTERFACES AND ASSOCIATED PROCESSES

Attention is now directed towards embodiments of user interfaces (“UI”) and associated processes that may be implemented on an electronic device, such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5AD illustrate example user interfaces for configuring a first input region in accordance with some embodiments. The user interfaces in these figures are used to illustrate the processes described below, including the processes in FIGS. 7A-7I. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector.

FIGS. 5A-5D illustrate example session regions on a representation of a portable multifunction device.

FIG. 5A illustrates an example user interface of a configuration interface 501-1 for configuring a first input region 506 of a portable multifunction device 100. In some embodiments, the first input region 508 is a physical button (e.g., a push button, a rocker button, or a solid-state button), dials, slider switches, joysticks or a click wheel. In some embodiments, portable multifunction device 100 is a computer system, a handheld mobile device, tablet, or other client device. Configuration interface 501-1 includes a representation of configurable multifunction device 100-1 which displays an example user interface of home screen (also called a home user interface) 500-1 of configurable multifunction device 100-1. In some embodiments, the home screen user interface includes icons for navigating to a plurality of applications that are executed, or executable, by the device 100-1. In some embodiments, a user is enabled to interact with the device 100 using one or more gestures, including touch inputs. For example, a tap input on a respective application icon causes the respective application to launch, or otherwise open a user interface for the respective application, on the display area of device 100-1. In some embodiments, a plurality of views (also called pages) for the home screen user interface is available. For example, a user is enabled to swipe or otherwise navigate between the plurality of views, wherein different views, and in some embodiments, a respective view, of the home screen user interface include different application icons for different applications. In some embodiments, the application icons are different sizes, as in the case of an application widget that displays information for one or more corresponding applications. For example, the application widget may be larger than the individual application icons, or the application widget may be smaller than the individual application icons.

In some embodiments, device 100 includes a session region 502-1 that includes one or more sensors (e.g., speaker 111 and/or one or more optical sensors 164). In some embodiments, the one or more sensors are positioned within one or more cutouts (also called sensor regions) in a display of the device 100. In some embodiments, as shown in FIG. 5A, the session region 502-1 encompasses the one or more sensor cutouts for the one or more sensors. In some embodiments, additional sensors are located within the session region 502-1, wherein the cutouts illustrated in FIG. 5A include one or more sensors in the cutout (e.g., one or more additional sensors are positioned in the same cutout as speaker 111, and/or one or more additional sensors are positioned in the same cutout as optical sensor(s) 164, such as a structured light emitter or projector). It will be understood that in some embodiments, alternative shapes and/or numbers of cutouts (e.g., more than two or fewer than two), as well as numbers of sensors in a respective cutout, are implemented. In some embodiments, the cutouts are not visible from the surface of device 100. In some embodiments, the device displays an outline of the session region 502-1. For example, the device displays the black session region 502-1 that encompasses the cutouts for speaker 111 and optional sensors 164. In some embodiments, the device displays the session region 502-1 with a color that matches, or otherwise blends with, a color of the sensors that are positioned within the cutouts.

In some embodiments, a region that is between two of the sensor cutouts is maintained with a same color as the color of the sensors. For example, the region that is between two of the sensor cutouts comprises a display that displays a color selected to match the color of the hardware of the sensors. In some embodiments, at least one of the sensor cutouts includes a camera as the sensor in the sensor cutout. In some embodiments, the region that is between two of the sensor cutouts displays content (e.g., a privacy indicator and/or a lock indicator).

In some embodiments, session region 502-1 that is displayed without active sessions (e.g., without status information), and/or session regions described herein that are displayed with at least one active session (e.g., with status information), are displayed at a predefined position of the display as the user navigates between different user interfaces. For example, the session region is displayed within a same area of the display while the device 100 displays application user interfaces, a home screen user interface, and optionally a wake screen user interface (e.g., at the top of touch screen 112, as shown throughout the figures). In FIG. 5A, the representation of the configurable multifunction device 100-1 also includes a black session region 502-2 which is displayed at a minimized size (e.g., a minimum size). For example, the session region 502-2 is not associated with any active sessions in FIG. 5A. In some circumstances, a minimized session region without any active sessions is called an empty session region.

In some embodiments, one or more sensors are absent from a session region. For example, in some embodiments, the one or more sensors are not positioned within cutouts of the display of device 100. In some embodiments, the session region that does not include one or more sensors is enabled to perform all of the functions described herein (e.g., any of the same functions described herein as for session region 502-1). Although most examples describe herein illustrate one or more sensors within the session region, in some embodiments, the session region is displayed regardless of whether the one or more sensors are encompassed by the session region. FIG. 5A shows indicator 510-1 directed at first input region 506-1. Indicator 510-1 shows a simulated activation of first input region 506-1, and/or different responses of configurable multifunction device 100-1 that can be associated with first input region 506-1. In other words, indicator 510-1 may not correspond to a manual activation of first input region 506-1.

FIGS. 5A-5D illustrate example user interfaces for automatically displaying content in a session region to guide a user in configuring the first input region 506 of device 100, in accordance with some embodiments. FIG. 5A also illustrates a simulated activation input represented by indicator 510-1 on first input region 506-1 of configurable multifunction device 100-1. In response to detecting the simulated activation input, configurable multifunction device 100-1 displays a different session region, as illustrated in FIG. 5B.

FIG. 5B illustrates home screen 500-1 as described with reference to FIG. 5A. In FIG. 5B, session region 502-3 is increased in size, relative to session region 502-2, to a condensed size and includes status information for whether configurable multifunction device 100-1 is in silent mode or ringer mode. For example, 502-3 shows that configurable multifunction device 100-1 is in ringer mode. Session region 502-3 occupies at least some of the area previously occupied by home screen 500-1 and/or the status bar above home screen 500-1 and to the left and right of session region 502-2 (e.g., one or more status indicators in the status bar cease to be displayed; for example, cellular network indicator 514-1 of FIG. 5A has ceased to be displayed in FIG. 5B).

In some embodiments, session region 502-3 is displayed as part of an animation that includes other functions that can be associated with first input region 506-1. For example, the animation includes automatically displayed content in a session region illustrated in FIGS. 5A-5D that show various applications or functions, one or more of which may be associated with first input region 506-1. Even though indicator 510-1 is depicted in FIG. 5B, the transition of the animation from FIG. 5B to FIG. 5C may not include any simulated input to first input region 506-1. Rather, indicator 510-1 may be used to provide visual guidance to a user that first input region 506-1 is a configurable region, and highlight a position of first input region 506-1 on configurable multifunction device 100-1. FIG. 5C shows session region 502-2 displayed at a minimized size without any active sessions. FIG. 5C also illustrates a simulated activation input represented by indicator 510-1 on the first input region 506-1 of configurable multifunction device 100-1. In response to detecting the simulated activation input, configurable multifunction device 100-1 displays a different session region, as illustrated in FIG. 5D.

In FIG. 5D, session region 502-4 is increased in size, relative to session region 502-2, to a condensed size and includes a preview of a media recording application (e.g., a graphical representation of the media recording application, such as a voice memo application, or an application icon of the voice memo application). Example of user interfaces of the media recording application are illustrated in FIGS. 6Q-6U corresponds to an example media recording application that has been associated with first input region 506. The animation illustrated in FIGS. 5A-5D shows that first input region 506-1 may be associated with one or more of multiple functions (e.g., ringer mode, and/or a media recording application). Thus, instead of associating first input region 506-1 with controlling a ringer mode or silent mode function of configurable multifunction device 100-1, first input region 506-1 can instead be configured to be associated with a media recording application. Like session region 502-3, session region 502-4 occupies at least some of the area previously occupied by home screen 500-1 and/or the status bar above home screen 500-1 and to the left and right of session region 502-2.

In FIG. 5D, in response to detecting user input 516-1 directed to first input region 506, configuration interface 501-1 for configuring first input region 506 of device 100 is updated to display a rotating representation of configurable multifunction device 100-1, as illustrated in FIG. 5E. In some embodiments, user input 516-1 initiates the configuration of first input region 506. FIGS. 5E-5H illustrate example user interfaces for initiating and configuring the first input region 506 of device 100 for a first operation of a first application. For example, the user input to initiate the configuration process is provided to first input region 506 while content in automatically displaying in a session region, in accordance with some embodiments.

For simplicity of illustrations, application icons in FIGS. 5E and 5F are depicted as blank shapes (e.g., quadrilaterals) in conjunction with the rotation of the representation of configurable multifunction device 100-1. In some embodiments, the animation showing the rotation of the representation of configurable multifunction device 100-1 includes the same application icons (e.g., no simplification of the application icons into schematic shapes, and/or the number of application icons remains the same) as those displayed in FIGS. 5A-5D.

FIG. 5E illustrates a rotated representation of configurable multifunction device 100-1, revealing a more visible representation of edge 518-1 on which first input region 506-1, second input region 508-1, and third input region 508-2 are arranged. The rotating animation of configurable multifunction device 100-1 provides a visual indication to a user regarding the physical location of first input region 506-1 on configurable multifunction device 100-1. FIG. 5E illustrates a continuing user input 516-2 on first input region 506 of device 100 while the representation of configurable multifunction device 100-1 is being rotated. In response to detecting continuing user input 516-2, configuration interface 501-1 for configuring first input region 506 of device 100 is updated to display a further rotated representation of configurable multifunction device 100-1, as illustrated in FIG. 5F. In some embodiments, in accordance with a determination that continuing user input 516-2 fails to meet first criteria for initiating a configuration process of first input region 506, including for example, failing to meet one or more of a time-based criterion that requires continuing user input 516-2 to be maintained for at least a threshold amount of time (optionally, with less than a threshold amount of movement), or having an intensity above a third intensity threshold, device 100 may stop displaying the rotating representation of configurable multifunction device 100-1 and resume displaying the animation illustrated in FIGS. 5A-5D.

FIG. 5F illustrates configuration interface 501-1, which shows a representation of configurable multifunction device 100-1 that is further rotated from the orientation shown in FIG. 5E, in response to detecting continuing user input 516-2 (FIG. 5E). FIG. 5F reveals a more visible representation of edge 518-1, in which a surface of the representation of edge 518-1 is becomes more parallel to the display of device 100, while the representation of a display of the representation of configurable multifunction device 100-1 is rotated almost by 90°, into the plane of the drawing. In both FIGS. 5A-5F, representations of first input region 506-1 in the representation of configurable multifunction device 100-1 is sized proportionately to the representation of configurable multifunction device 100-1. The animation of the rotating representation of configurable multifunction device 100-1 then transitions to configuration interface 501-2, as illustrated in FIG. 5G.

FIG. 5G illustrates configuration interface 501-2 displayed at the conclusion of the animation illustrated in FIGS. 5E and 5F. In FIG. 5G, representation 507-1 of first input region 506-1 is displayed as having zoomed in from the representation of first input region 506-1 shown in FIG. 5F. For example, while the representation of first input region 506-1 in FIG. 5F is displayed with a graphical representation of at least a portion of configurable multifunction device 100-1 at which the first input region is located (e.g., a representation of edge 518-1, or another edge portion of configurable multifunction device 100-1), no other input regions (e.g., second input region 508-1, and/or third input region 508-2) are displayed in configuration interface 501-2. Displaying an animated transition including zooming in toward representation 507-1 of first input region 506-1 guides the user to the location of first input region 506-1 on configurable multifunction device 100-1 without displaying additional controls.

FIG. 5G also illustrates a collection of graphical representations 522, 528, and 530 arranged in a scrollable carousel 520. The different graphical representations 522, 528, and 530 correspond to different applications and/or functions selectable by a user for associating with first input region 506-1. A pagination indicator 526 shows that representation 522 currently displayed overlaid on first input region 506-1 is the first in the collection of graphical representations (e.g., of several selectable options, for example, of seven selectable options, or of ten selectable options) in scrollable carousel 520. For example, the first element (e.g., a circle) in pagination indicator 526 has a different appearance compared to the other elements in the pagination indicator 526 (e.g., different shading or color). Information about the function or application associated with a respective representation displayed over a representation of first input region 506-1 is displayed in a middle or lower portion of configuration interface 501-2. For example, graphical representation 522 is associated with a system application for controlling selectable operating modes, for example, focus modes, in which notification delivery for respective pluralities of applications, and or other visual characteristics of the user interfaces are moderated in accordance with respective sets of rules by the system application. Region 534 shows a brief description of the system application associated with representation 522 for controlling and selecting different focus modes. For example, different focus modes may have different notification settings, which affect which notifications are delivered, suppressed, and/or deferred.

FIG. 5G also shows user interface element 532 (e.g., a selectable button, or other affordances) displayed on configuration interface 501-2 that enables a user to further configure the system application associated with representation 522, which is overlaid on a representation of first input region 506-1. In some embodiments, the combination of a respective representation (e.g., representation 522, representation 528, or representation 530) displayed on the scrollable carousel 502) and the representation of first input region 506-1 is jointly referred to as a respective representation of the first input region. In some embodiments, the first representation of the first input region may include a high-quality 3D model of the customizable first input region, or customization hardware control region. Optionally, the first representation of the first input region includes a graphical depiction of spatial features of the customizable hardware control region.

FIG. 5G also illustrates selection input 536 directed to user interface element 532. In response to detecting selection input 536, configuration interface 501-2 is updated to display, as illustrated in FIG. 5H, one or more customization options specific to representation 507-1 of first input region 506-1 that includes representation 522 of a system application that controls an operating mode of the electronic device by which notification delivery for a plurality of applications is moderated. Representation 507-1 of first input region 506-1 (hereinafter sometimes also referred to as a first representation of the first input region) includes the graphical representation overlaying the representation of first input region 506-1, such as representation 522 in FIG. 5G, or representation 530 in FIG. 5I.

FIG. 5H illustrates configuration interface 501-3 device 100 displays in response to detecting selection input 536 directed at user interface element 532 illustrated in FIG. 5G. In FIG. 5H, while edge 518-1 of configurable multifunction device 100-1 is still visible in configuration interface 501-3, the representation first input region 506-1 is displayed as having zoomed out from the representation of first input region 506-1 shown in FIG. 5G. Graphical representation 522 is overlaid on first input region 506-1 to provide visual reminder that the first input region 506-1 is to be associated with the controlling of focus mode selection. In some embodiments, device 100 displays an animated transition starting at the depiction of first input region 506-1 shown in FIG. 5G and ends with the depiction of first input region 506-1 shown in FIG. 5H. Displaying an animated transition to zoom out from the respective representation of the first input region deemphasizes the respective representation and allows the user to focus on the respective configuration option for the respective representation (e.g., for focus mode selection, or for camera capture mode selection). Zooming out of the representative representation of the first input region also provides visual feedback to the user that the current user interface is not interactable for changing a respective representation of the first input region scrollable carousel 520, together with the collection of graphical representations 522, 528, and 530, are no longer displayed in configuration interface 501-2 but is for further configuring the currently selected representation of the first input region.

FIG. 5H shows configuration user interface 501-3 in which a list of customization options 540, specific to graphical representation 522, is displayed. For example, the list of customization options 540 includes affordances for available focus modes such as a “Do not disturb” mode affordance, a “Work” mode affordance, a “Sleep” mode affordance, a “Driving” mode affordance, and a “Personal” mode affordance. While a “Work” mode is active, notifications associated with users who are not whitelisted as work contacts are suppressed (e.g., are not delivered when initially received, and are instead delivered when the “Work” mode is deactivated). As shown in FIG. 5H, in response to detecting a user input 542 on a focus mode affordance, visual feedback in the form of an indicator 544 (e.g., a check mark, or other indicators) is placed on the selected focus mode affordance, informing the user that a specific focus mode has been selected. In some embodiments, list of customization options 540 further includes focus modes that have already been configured (e.g., previously set up and configured by the user to some user specified delivery notification mode or display selection mode). In some embodiments, device 100 displays some focus modes even if those focus modes are not yet configured (e.g., and when selected, will prompt the user to either configure the focus mode, and/or provide suggested settings for configuring the focus mode). In some embodiments, focus modes may include more than changing notification rules, such as to additionally include changing a background graphic (e.g., a wallpaper), and/or arrangement of widgets and/or application icons on the home screen user interface or lock screen interface. Further, the information displayed in different applications may also be configured to change.

FIG. 5G also illustrates user input 546 directed to user interface element 548. In some embodiments, user interface 548 is a button or other affordance to indicate that configuration is completed (e.g., a “done” button). In response to detecting user input 546 directed at user interface element 548, configuration of first input region 506 is completed. For example, a subsequent user input directed at input region 506 toggles the “Personal” focus mode on and off. Examples of focus mode activation and user interfaces associated with focus mode are further described in reference to FIGS. 6V-6Y.

In FIG. 5G, user input 538 directed near scrollable carousel 520 (e.g., instead of, or prior to providing user input 538 on the user interface element 532) switches the graphic representation that is overlaid on the representation of first input region 506-1, allowing a user to select a different function and/or application to be associated to first input region 506-1. For example, in FIG. 5G, a leftward user input, such as a swipe input 538 (or another swipe input that includes movements in a left-right direction, and/or another swipe input that includes movements in an up-down direction) switches the graphical representation overlaying first input region 506-1 from representation 522 for focus mode to representation 530 for a camera application, as shown in FIG. 5I. In other words, in response to detecting leftward user input 538, device 100 updates configuration interface 501-2 to display representation 530 overlaying first input region 506-1 in representation 507-2, as illustrated in FIG. 5I. In some embodiments, in response to detecting a leftward user input 538 meets first criteria (e.g., a distance criteria), device 100 can causes multiple representations to be sequentially overlaid on first input region 506-1. For example, the user input to initiate the configuration process is provided to first input region 506 while content is automatically displaying in a session region, in accordance with some embodiments.

FIGS. 5I-5N illustrate example user interfaces for configuring first input region 506 of device 100 for a different operation of a different application from that illustrated in FIGS. 5E-5H, including an animated transition that is automatically displayed in accordance with a determination that animation display criteria are met, in accordance with some embodiments. FIG. 5I illustrates configuration interface 501-2 after the graphical representation overlaying first input region 506-1 has changed from focus mode to a camera application. In FIG. 5I, one or more visual characteristics of representation 507-2 of first input region 506-1, represented by cross-hatched shading (e.g., a color, hue, texture, fill pattern, reflectivity, or other display properties) when overlaid by representation 530 is different from that shown in representation 507-1 of first input region 506-1 of FIG. 5G (e.g., a diagonal shading or other pattern), when representation 522 is overlaid on the first input region 506-1. Additional graphical representations are visible in scrollable carousel 520 due to the movement of user input 538. For example, representations 550 and 552 correspond to additional applications and/or functions selectable by a user for associating with first input region 506-1, and are displayed on a right side of first input region 506-1. Representations 522 and 528 have been scrolled off first input region 506-1, and are now displayed on a left side of first input region 506-1. Pagination indicator 526 shows that representation 530 currently displayed overlaid on first input region 506-1 is the third representation in the collection of graphical representations (e.g., of several selectable options, for example, of seven selectable options) displayed on scrollable carousel 520. Information about the camera application associated with representation 530 displayed over first input region 506-1 is displayed in a middle or lower portion of configuration interface 501-2. For example, region 530-2 provides a brief description about the camera application associated with representation 530.

In FIG. 5Q, session region 502-6 is increased in size, relative to session region 502-2 (FIG. 5A), to a condensed size and includes a preview of the flashlight application (e.g., a graphical representation of the flashlight application, an application icon of the flashlight application) corresponding to representation 550 that is overlaid on first input region 506-1 in configuration user interface 501-2 (FIG. 5O) when no user input was detected within the first time threshold. In some embodiments, the animation shown in FIG. 5Q and FIG. 5R differ from the animation illustrated in FIGS. 5A-5D due to the display of user interface element 503. In response to a user input, such as a selection input or another user input, on user interface element 503, the device 100 resumes displaying configuration interface 501-2. User interface element 503 may be presented on a lower portion of the animation, and may be provided on a top layer of display content, with an intervening layer that blurs and/or partially obscures the lower portion of the animation. In the absence of user input, the animation proceeds to provide an animated demonstration of an activation of the first input region 506-1 when associated with the flashlight application. For example, FIG. 5R shows an expanded session region 502-7 that includes an enlarged graphic representation of the flashlight application, and a textual label (e.g., “Flashlight On”) that indicates a current status of the flashlight application. For example, light rays 505 are depicted in FIG. 5R to show a simulated activation of the flashlight application.

User interface element 554 (e.g., a selectable button) is also presented on the configuration interface 501-2. User interface element 554 enables a user to further configure the function or application associated with the representation (e.g., representation 530 in FIG. 5G) overlaid on first input region 506-1. FIG. 5I also illustrates selection input 558 directed to user interface element 554. In response to detecting selection input 558, device 100 updates configuration interface 501-2 to display one or more customization options specific to the camera application, as illustrated in FIG. 5J. In some embodiments, user interface element 556, which allows a user to finalize a configuration option associated with representation 530 is not selectable until camera application has been configured.

FIG. 5J illustrates configuration interface 501-4 displayed in response to detecting selection input 558 directed at user interface element 554 illustrated in FIG. 5I. As described with respect to FIG. 5H, the representation of first input region 506-1 in FIG. 5J is displayed as having zoomed out from the representation of first input region 506-1 shown in FIG. 5I. Graphical representation 530 overlaid on first input region 506-1 provides a visual reminder that the first input region 506-1 is associated with the camera application. Device 100 displays a list of customization options 560, specific to the camera application associated with graphical representation 530, in configuration interface 501-4. For example, the list of customization options 560 includes affordances for available camera capture modes such as a “Take photos” mode affordance, a “Take portrait selfie” mode affordance, a “Take portrait” mode affordance, a “Take video” mode affordance, and a “Take selfie” mode affordance. In conjunction with the above mode affordances, there is also a toggle slider for indicating whether the camera application is to be made available in applications, for example, whether a user can activate the camera application via an input to the first input region 506 while one or more other applications are in use. As shown in FIG. 5J, in response to detecting a user input 562 on the “Take photos” mode affordance, device 100 provides visual feedback in the form of an indicator 568 (e.g., a check mark, or other indication affordance) adjacent to the selected mode affordance. FIG. 5J also illustrates user input 566 directed to user interface element 564. In some embodiments, user interface element 564 is a button to indicate that configuration is complete (e.g., a “done” button, or other indication affordance). In response to detecting user input 566 directed at user interface element 564, device 100 updates configuration interface 501-4 is updated to display configuration interface 501-2 shown in FIG. 5I, but with the user interface element 556 becoming available for user selection. Upon a user input directed at user interface element 556, the configuration of first input region 506 to be associated with the camera application is complete. For example, a subsequent user input directed at input region 506 activates the camera application to launch in the “Take photos” mode. Examples of activating the camera application from first input region 506 and user interfaces associated with the application are further provided with respect to FIGS. 6I-6L.

Returning to FIG. 5I, in response to not detecting a user input within a first time threshold after representation 530 is scrolled to overlay first input region 506-1 (e.g., user input 558 is not detected within the first time threshold, or user input 561 is not detected within the first time threshold), device 100 updates configurable interface 501-2 to provide an animated demonstration of the camera application on configurable device 100-1, as shown in FIGS. 5K-5N. In some embodiments, the animated demonstration includes rotating a representation of configurable device 100-1 that reverses the rotation animation shown in FIGS. 5E and 5F. For example, representation of edge 518-1 is rotated in a clockwise manner to provide a frontal view of configurable device 100-1, such as a rotated view of the representation of configurable device 100-1 that is rotated by an angle between 0°-110° from a central vertical axis about configurable device 100-1. FIG. 5N shows a further rotation of a representation of configurable device 100-1.

In FIG. 5M, session region 502-5 is increased in size, relative to session region 502-2 (FIG. 5A), to a condensed size and includes a preview of the camera application (e.g., a graphical representation of the camera application, an application icon of the camera application) corresponding to representation 530 that is overlaid on first input region 506-1 in configuration user interface 501-2 (FIG. 5I) when no user input was detected within the first time threshold. In some embodiments, the animation shown in FIG. 5M and FIG. 5N differ from the animation illustrated in FIGS. 5A-5D due to the display of user interface element 503. In response to a user input, such as a selection input, or other types of user input, on user interface element 503, the device 100 resumes displaying configuration interface 501-2. User interface element 503 may be presented on a lower portion of the animation, and may be provided on a top layer of display content, with an intervening layer that blurs and/or partially obscures the lower portion of the animation. In the absence of user input, the animation proceeds to provide an animated demonstration of an activation of the first input region 506-1 when associated with the camera application. For example, FIG. 5N shows a viewfinder of user interface 509-1 of a camera application. The animated demonstration of a simulated activation of first input region 506-1 when associated with the camera application provides more information to the user than that provided in region 530-2 of configuration user interface 501-2 (FIG. 5I), regarding the function of camera application. For example, the lack of user input within the first time threshold may be indicative of a user's wish for more guidance or assistance in configuring the first input region. By automatically providing the animated demonstration of a simulated activation of the first input region, a user can be more quickly guided to the desired configuration option for the first input region. In some embodiments, if the user interface element is not selected, the animated demonstration proceeds to an animated demonstration of a different configuration option (e.g., a flashlight application subsequent to the camera application, or an accessibility function subsequent to the camera application).

In some embodiments, while displaying configuration user interface 501-4, the animated preview of respective customization options described in reference to FIGS. 5K-5N is not displayed. In other words, the animated preview is paused while user is configuring a specific configuration option (e.g., upon activating a respective user interface element such as user interface element 554 in FIG. 5I, and/or upon activating a respective user interface element such as user interface element 532 in FIG. 5G, or other user interface elements for configuring first input region) for the first input region 506.

Returning to FIG. 5I, user input 550-3 directed near scrollable carousel 520 switches the graphic representation that is overlaid on the representation of first input region 506-1, allowing a user to select a different function and/or application to be associated to first input region 506-1. For example, in FIG. 5I, a leftward user input, such as a swipe input 561 or other types of swipe input along one or more other directions, switches the graphical representation overlaying first input region 506-1 from representation 530 for a camera application to representation 550 for a flashlight application, as shown in FIG. 5O.

FIGS. 5O-5R illustrate example user interfaces for configuring first input region 506 of device 100 for a different operation of a different application from that illustrated in FIGS. 5I-5N, including an animated transition that is automatically displayed in accordance with a determination that animation display criteria are met, in accordance with some embodiments. FIG. 5O illustrates configuration interface 501-2 after the graphical representation overlaying first input region 506-1 in representation 507-3 has changed from the camera application to a flashlight application. Pagination indicator 526 shows that representation 550 currently displayed overlaid on first input region 506-1 is the fourth representation in the collection of graphical representations (e.g., of several selectable options, for example, of seven selectable options) displayed on scrollable carousel 520. Information about the flashlight application associated with representation 550 displayed over first input region 506-1 is displayed in a middle or lower portion of configuration interface 501-2. For example, region 550-2 provides a brief description of the flashlight application associated with representation 550. Similarly, an input directed at user interface element 550-1 allows a user to begin configuring the flashlight application.

Similarly, in response to not detecting a user input within a first time threshold after representation 550 is scrolled to overlay first input region 506-1 (e.g., user input 550-3 is not detected within the first time threshold), device 100 updates configurable interface 501-2 to provide an animated demonstration of the flashlight application on the configurable device 100-1, as shown in FIG. 5P. In some embodiments, the animated demonstration includes rotating a representation of configurable device 100-1 similar to that shown in FIGS. 5K and 5L, which reverses the rotation animation shown in FIGS. 5E and 5F.

Returning to FIG. 5O, user input 550-3 directed near scrollable carousel 520 switches the graphic representation that is overlaid on the representation of first input region 506-1, allowing a user to select a different function and/or application to be associated to first input region 506-1. Scrollable carousel 520 allows bi-directional (e.g., leftward or rightward) scrolling of graphical representations. For example, in FIG. 5O, a rightward user input, such as a swipe input 550-3 or another swipe input along a different direction, switches the graphical representation overlaying first input region 506-1 of in representation 507-4 from representation 550 for a flashlight application to representation 528 for a media recording application, as shown in FIG. 5S.

FIG. 5S illustrates configuration interface 501-2 after the graphical representation overlaying first input region 506-1 has changed from the flashlight application to a media recording application. Pagination indicator 526 shows that representation 528 currently displayed overlaid on first input region 506-1 is the second representation in the collection of graphical representations (e.g., of several selectable options, for example, of seven selectable options) displayed on scrollable carousel 520. Information about the media recording application associated with representation 528 displayed over first input region 506-1 is displayed in a middle or lower portion of configuration interface 501-2. For example, region 528-1 provides a brief description of the flashlight application associated with representation 550. Similarly, an input directed at user interface element 528-2 allows a user to begin configuring the media recording application.

FIG. 5S also illustrates user input 528-3 directed near scrollable carousel 520 that switches the graphic representation that is overlaid on the representation of first input region 506-1, allowing a user to select a different function and/or application to be associated to first input region 506-1. For example, in FIG. 5S, a rightward user input, such as a swipe input 528-3, or another swipe input along another direction, switches the graphical representation overlaying first input region 506-1 from representation 528 for the media recording application to representation 553 for a system application that provides a shortcut to perform an operation of a respective application and that manages respective shortcuts to respective operations of a plurality of applications, or another system application that provides access to and/or manages operations for multiple applications. Additional graphical representations are visible in scrollable carousel 520 due to the movement of user input 528-3. For example, representation 555 corresponds to an additional system function selectable by a user for associating with first input region 506-1. In some embodiments, as shown in FIG. 5T, representation 522 corresponding to a focus mode function is displayed in a loop on the scrollable carousel 520. Pagination indicator 526 shows that representation 553 currently displayed overlaid on first input region 506-1 is the sixth representation in the collection of graphical representations (e.g., of several selectable options, for example, of seven selectable options) displayed on scrollable carousel 520. Information about the shortcut function associated with representation 553 displayed over first input region 506-1 in representation 507-5 is displayed in a middle or lower portion of configuration interface 501-2. For example, region 553-1 provides a brief description about the shortcut function associated with representation 553.

FIGS. 5T-5AA illustrate example user interfaces for configuring first input region 506 of device 100 for a different operation of a system application, different application from that illustrated in FIGS. 5I-5N, in accordance with some embodiments. In some embodiments, the system application provides a shortcut to perform an operation of a respective application and that manages respective shortcuts to respective operations of a plurality of applications, or another system application that provides access to and/or manages operations for multiple applications.

FIG. 5T also illustrates selection input 553-3 directed to user interface element 553-2. In response to detecting selection input 553-3, device 100 updates configuration interface 501-2 to display one or more customization options specific to the shortcut function, as illustrated in FIGS. 5U and 5T.

FIG. 5U illustrates a first example of configuration interface 501-5 displayed in response to detecting selection input 553-3 directed at user interface element 553-2 illustrated in FIG. 5T. Configuration interface 501-5 includes a number of customization options that are grouped by application. In some embodiments, an order by which the customization options is presented to the user is based on a current context of device 100, for example, the current context includes information about which applications are opened recently, which application is the last accessed application, which applications are frequently used applications for the user, and/or other information about relative relevance of various applications at the present time and/or for the user. For example, in FIG. 5U, configuration interface 501-5 displays customization options for four different types of applications. In some embodiments, configuration interface 501-5 provides a scrollable list that includes more than the four different types of applications that are being currently displayed. The first type of application includes customization option represented by user interface elements 553-14 and 553-15, which relate to operations that are performed at a remote system or device from device 100. User interface element 553-14, when activated, is used to control the opening and closing of a garage door. User interface element 553-15, when activated, is used to control the locking and unlocking of a car. For example, in FIG. 5U, the user has most recently used an application for controlling a locking and unlocking of a garage door or the locking of a car. User interface elements 553-14 and 553-15 are therefore positioned at beginning of the scrollable list of customization options.

The second type of application includes customization options for a telephony or live communication application, the customization options include a listing of representations of a set of recent contacts, favored contacts, and/or a keypad for entering a phone number or username, to initiate a live communication session with. The third type of application is a system application relating to accessibility options for device 100. For example, user interface elements 553-9, 553-10, and 553-11, when activated, cause device 100 to switch to VoiceOver mode (e.g., VoiceOver mode provides audible descriptions of content presented on a display of device 100, and/or VoiceOver mode enables device 100 to be used without a user viewing the screen), a Reduce Motion mode (e.g., Reduce Motion mode reduces or disables motion effects on the display of device 100 that create perception of depth, and/or Reduce Motion mode replaces zoom or slide effects with dissolve effect for screen), or a Dark Display Mode (e.g., Dark Display Mode, or Dark Mode allows for better viewing experience in low-light environments by using a darker background for the display of device 100, and/or Dark Mode darkens background colors for various user interface elements) of operation, respectively. The fourth type of application is a set of applications related to timing. User interface elements 553-19 and 553-20, when activated, cause device 100 to start a timer, or to add a new alarm, respectively. In response to detecting user input 553-17 directed at interface element 553-19, first input region 506 is associated with starting a timer. Once a user has completed configuring the shortcut function, user input 553-18 can be directed to user interface element 553-16 (e.g., a “done” button, or other types of affordances) to conclude the configuration process.

FIG. 5V illustrates a second example of configuration interface 501-5 displayed in response to detecting selection input 553-3 directed at user interface element 553-2 illustrated in FIG. 5T. In some embodiments, as shown in FIG. 5V, customization options, while grouped by application are arranged according to a persistent sorting rule, such as being arranged alphabetically based on application name, chronologically based on when the applications were last accessed or installed, or another persistent sorting rule that is independent of a current context of the electronic device, which may include one or more parameters that change over time. In some embodiments, the ordering of the customization option prioritizes customization options that are simple and discrete (e.g., locking or unlocking a car, causes a car to honk, one-click operations such as starting a timer, turn on/off the ringer, turn on a DND mode, and/or other toggle or one-click operations) over operations that involve having a user consider information and provide additional input to perform (e.g., composing a text message to a recipient, play music from a selected album, and/or other operations that require multiple steps or need additional user input to perform)). For example, in FIG. 5T, customization options for locking a car, making a honking sound by the car, starting a timer, and starting a stopwatch are sorted ahead of customization options for writing a new note. In some embodiments, the list of customization options displayed on configuration user interface 501-6 includes a previously configured operation that required multiple steps to configure. Such a pre-configured shortcut option provides the user with quick access to select a previously customized option without having to navigate through additional controls. For example, user interface element 553-14 in FIG. 5U was configured via multi-step customization option to associate a sequence of user inputs to opening a garage. In response to detecting a user input 553-21 directed at a user interface element 553-29 configurable to associate first input region 506 to initiate a live communication session with a specified user, device 100 updates configuration user interface 501-6 to display configuration user interface 501-7, as shown in FIG. 5W. User interface element 553-26, when activated, allows the user to conclude the configuration process and exit configuration user interface 501-6.

In FIG. 5W, configuration user interface 501-7 includes a snippet or list 553-40 containing a number of suggested contacts the user may wish to use to configure a shortcut function of first input region 506. A user interface element 533-42 allows the user to select additional contacts not currently displayed in list 553-40. In response to detecting user input 553-41 directed at a contact “Kim,” device 100 updates configuration user interface 501-7 to display a configuration user interface 501-8, illustrated in FIG. 5X, that allows a user to further specify the mode of communication (e.g., mobile phone call, or video conference call) to be used to initiate communication with representation 533-70 of contact “Kim.” In response to detecting user input 533-48 directed at the option to initiate communication using a mobile phone call, a user can activate user interface element 533-71 to conclude the configuration process.

Returning to FIG. 5V, in response to detecting a user input 553-32 directed at user interface element 553-30 configurable to associate first input region 506 to initiate play back of a media content item, device 100 updates configuration user interface 501-6 to display configuration user interface 501-9, as shown in FIG. 5Y.

In FIG. 5Y, configuration user interface 501-7 includes a snippet or list 553-60 containing a number of suggested media content items the user may wish to use to configure a shortcut function of first input region 506. In response to detecting user input 553-61 directed at a function “Radio,” device 100 updates configuration user interface 501-9 to display a configuration user interface 501-10, illustrated in FIG. 5Z, that allows a user to further specify the type of broadcast station to associate the shortcut function with (e.g., local broadcast stations, to international broadcast stations). In response to detecting user input 533-63 directed at option 553-52 to broadcast from a local broadcasting station, the shortcut function is associated with playing media content from a local broadcasting station. In response to detecting user input 553-65 directed at user interface element 533-64 to conclude the configuration process, device 100 updates configuration interface 501-10 to display a configured user interface 501-11, as shown in FIG. 5AA, in which the graphical representation associated with the shortcut function is replaced by a graphical representation 553-60 depicting the customized radio station broadcast function. Region 553-72 is updated to provide a brief description about the radio function associated with representation 553-70. In response to detecting user input 533-73 directed at user interface element 533-72 to conclude the configuration process, first input region 506 is associated with the radio function of a music application.

FIGS. 5AB-5AD show an example activation of first input region 506 after first input region 506 has been associated with the radio function of a music application, described in reference to FIGS. 5V, and 5Y-5AA. FIG. 5AB illustrates user input 570-1 directed to first input region 506 after first input region 506 has been previously associated with the radio function of a music application. In response to detecting user input 570-1, device 100 initiates playing of radio broadcast media content, and device 100 displays session region 502-11 that includes a relevant playback control 590-1, as illustrated in FIG. 5AC. For example, while the radio broadcast media content item is playing, the relevant playback control 590-1 is a control for pausing radio broadcast. In some embodiments, media playback user interface 624-3 displays additionally displayed. For example, media playback user interface 590-3 includes additional information about the playback of “Song A” and includes control options for controlling the session (e.g., skip back, pause, and skip forward). In response to detecting user input 570-2, device 100 pauses playing of radio broadcast media content, and device 100 displays session region 502-12 that includes a relevant playback control 590-2, as illustrated in FIG. 5AD. In some embodiments, radio broadcast is displayed in an expanded session region as an animated transition from session region 502-2 that expands outward.

FIGS. 6A-6C illustrate example user interfaces for activating first input region 506 of device 100 to perform a previously configured operation of a system application, in accordance with some embodiments. FIG. 6A illustrates user input 602-1 directed to first input region 506 after first input region 506 has been previously associated with ringer mode/silent mode function based on the processes outlined in FIGS. 5A-5AD. FIG. 6A illustrates that, in response to user input 602-1, device 100 displays, in session region 502-13, an indication of a current association of first input region 506 to the ringer mode/silent mode function. For example, user input 602-1 is a press input (e.g., light, and/or short press input) by the user to get a reminder about what application and/or function is associated with first input region 506. In response to detecting user input 602-1, device 100 replaces display of session region 502-1 with display of session region 502-13 indicating that first input region 506 is associated with the silent mode function. Session region 502-13 includes a preview (e.g., an icon corresponding to the silent mode function, such as a line through a representation of a bell or another graphical representation to indicate that audio output is reduced) of the function first input region 506 is currently associated with, and a textual label (e.g., “Silent Mode On”) of the application. In FIG. 6B, user input 602-2 is directed to first input region 506. User input 602-1 and user input 602-2 toggle whether device 100 is in a silent mode in which audio and/or tactile outputs are reduced or silenced, and the user interface object displayed in response to detecting user input 602-2 optionally indicates the current mode (e.g., whether the toggling has turned silent mode on or off).

FIG. 6C illustrates that, in response to detecting a liftoff of user input 602-2, the silent mode function is toggled off. In some embodiments, user input 602-2 is a separate press input to first input region 506 from user input 602-1. In some embodiments, there is no liftoff between user input 602-2 and user input 602-1 (e.g., or user input 602-1 is a first portion of a press input and user input 602-2 is a second portion of the press input, or user input 602-2 is a continuation of user input 602-1). In response to silent mode function being toggled off, device 100 displays expanded session region 502-14 to show that ringer mode is turned on. In some embodiments, haptic responses are provided in response to the ringer mode being turned on. In some embodiments, expanded session region 502-14 includes a user adjustable ringer volume or system volume, such as volume slider 604 in session region 502-14 or another adjustment affordance that controls an output volume level for audio output (e.g., volume of ringing, or volume of other system notifications) from device 100. In some embodiments, device 100 display a first preview of the silent mode function via session region 502-13 when an intensity of the first portion of user input 602-2 input exceeds a first intensity threshold. In accordance with a determination that user input 602-2 has been continuously maintained on first input region 506 for at least a first threshold amount of time (e.g., detection of a long press on the first input region, and/or detection of a persistent selection input on the first input region) after the first portion of the first input has met the first set of one or more criteria for a long press, device 100 activates the ringer mode as displayed in session region 502-14.

FIGS. 6D-6H illustrate example user interfaces for activating first input region 506 of device 100 to perform a previously configured operation of an application, different from that illustrated in FIGS. 6A-6C, in accordance with some embodiments. FIG. 6D illustrates user input 602-3 directed to first input region 506 after first input region 506 has been previously associated with the flashlight application based on the processes outlined in FIGS. 5A-5AD. FIG. 6E illustrates that, in response to user input 602-3, device 100 displays, in session region 502-15, an indication of a current association of first input region 506 to the flashlight application. For example, user input 602-3 is a press input (e.g., light, and/or short press input) by the user to get a reminder about what application and/or functionality is associated with first input region 506. In response to detecting user input 602-3, device 100 replaces display of session region 502-1 with display of session region 502-15 indicating that first input region 506 is associated with the flashlight application. Session region 502-15 includes a preview (e.g., an icon corresponding to the flashlight application) of the application first input region 506 is currently associated with, and a textual label (e.g., “Flashlight”) of the application. In FIG. 6E, user input 602-4 is directed to first input region. In some embodiments, user input 602-3 is a first portion of a user input, and user input 602-4 is a second portion of the user input. In some embodiments, there is no liftoff between user input 602-3 and user input 602-4 (e.g., or user input 602-3 is a first portion of a press input and user input 602-4 is a second portion of the press input, or user input 602-4 is a continuation of user input 602-3). In some embodiments, user input 602-4 is a separate press input to first input region 506.

FIG. 6F illustrates that, in response to detecting a liftoff of user input 602-4, the flashlight of device 100 is turned on, as shown schematically by light rays 606-1. Device 100 also updates session region 502-15 to display expanded session region 502-16 to provide textual indication and/or a graphical indicator to show that the flashlight is turned on. After the flashlight is turned on, user input 602-5 to second input region 508-1 (e.g., or third input region 508-2) changes a brightness/intensity of the flashlight. For example, second input region 508-1 additionally also enables volume adjustments (e.g., a volume increase button), and third input region 508-2 also enables volume adjustments (e.g., a volume decrease button). In some embodiments, haptic responses are provided via second input region 508-1 and third input region 508-2, in response to detecting user input 602-5. In some embodiments, in response to detecting selection input 602-5 directed at a user interface element 553-54, home screen 500 is updated to display a brightness adjustment interface 608, as illustrated in FIG. 6G.

Brightness adjustment interface 608-1 includes a brightness slider 608-2 that includes an adjustable first portion 608-3 indicative of a current brightness of the flashlight. In response to user input 608-4 that includes a vertical movement component (e.g., toward session region 502-15), brightness of the flashlight is increased, as illustrated by the denser light rays 606-2 in FIG. 6H. The adjustable first portion 608-3 also increases in size (e.g., taller and/or wider) to show the increased brightness of the current flashlight setting.

FIGS. 6I-6L illustrate example user interfaces for activating first input region 506 of device 100 to perform a previously configured operation of an application, different from that illustrated in FIGS. 6D-6H, in accordance with some embodiments. FIG. 6I illustrates user input 602-6 directed to first input region 506 after first input region 506 has been previously associated with the camera application based on the processes outlined in FIGS. 5A-5AD. FIG. 6I illustrates that, in response to user input 602-6, device 100 displays, in session region 502-17, an indication of a current association of first input region 506 to the camera application. For example, user input 602-6 is a press input (e.g., light, and/or short press input) by the user to get a reminder about what application and/or functionality is associated with first input region 506. In response to detecting user input 602-6, device 100 replaces display of session region 502-1 with display of session region 502-17 indicating that first input region 506 is associated with the camera application. Session region 502-17 includes a preview (e.g., an icon corresponding to the camera application or other graphical representation of the camera application) of the application first input region 506 is currently associated with.

In some embodiments, in response to detecting user input 602-7 to first input region, device 100 displays, in session region 612-1, a live preview (e.g., a viewfinder of the camera application) and a capture button 612-2 that is activatable to stop or start video or image capture via the one or more cameras of device 100. In some embodiments, there is no liftoff between user input 602-6 and user input 602-7 (e.g., user input 602-6 is a first portion of a press input and user input 602-7 is a second portion of the press input, or user input 602-7 is a continuation of user input 602-6). In some embodiments, user input 602-7 is a separate press input (e.g., from user input 602-6) to first input region 506. In some embodiments, the live preview provided in session region 612-1 is maintained in accordance with detecting a continued user input 602-8, as shown in FIG. 6K, that does not include a liftoff from user input 602-7.

FIG. 6L illustrates that, in response to detecting a liftoff of user input 602-8, device 100 displays user interface 612-3 for the camera function. User interface 612-3 includes a representation of a field of view of one or more cameras (e.g., integrated cameras) of device 100; capture button 612-4 for performing, starting, or stopping media capture using the camera function (e.g., using one or more integrated cameras) of device 100. In some embodiments, a liftoff of user input 602-8 includes ceasing a physical/manual contact between the user and first input region 506. In some embodiments, a liftoff of user input 602-8 includes a reduce in detected pressure at first input region 506 below a release threshold while the physical/manual contact is still detected. In the example of FIG. 6L, user interface 612-3 also indicates that the camera function is currently in a photo capture mode (e.g., as indicated by the mode label “PHOTO” displayed centered above capture button 612-4). In some embodiments, user interface 612-3 for the camera function is displayed as animated transition from session region 612-1 that expands outward. In FIG. 6L, session region 502-1 is empty (e.g., the dashed line that delineates session region 502-1 in FIG. 6L for ease of reference is optionally not displayed).

FIGS. 6M-6R illustrate example user interfaces for activating first input region 506 of device 100 to perform a previously configured operation of an application, different from that illustrated in FIGS. 6I-6L, in accordance with some embodiments. FIG. 6M illustrates user input 602-9 directed to first input region 506 after first input region 506 has been previously associated with the timing application based on the processes outlined in FIGS. 5A-5AD. In response to an initial user input (not illustrated in FIG. 6M), device 100 displays, in session region 502-18, an indication of a current association of first input region 506 to the timing application. Session region 502-17 includes a preview (e.g., an icon corresponding to the timing application, or other graphical representation of the timing application) of the application first input region 506 is currently associated with, and a textual label (e.g., “Timer”) associated with the timing application. In some embodiments, the initial user input is a press input (e.g., light, and/or short press input) by the user to get a reminder about what application and/or function is associated with first input region 506. FIG. 6M illustrates that while session region 502-18 is displayed, in response to user input 602-9, device 100 replaces display of home screen 500 with display of timing user interface 614-1. In some embodiments, timing user interface 614-1 is provided on a top layer of display content, with an intervening layer that blurs and/or partially obscures the home screen 500, which is the lowest layer of display content. In some embodiments, timing user interface 614-1 is displayed on top of a wake screen. In some embodiments, timing user interface 614-1 is displayed without any underlying display content.

In FIG. 6N, timing user interface 614-1 includes a wheel of time that allows a user to set a timer (e.g., a countdown timer, or the time of an alarm) by the hour, the minute, and the second, down to one second increments using scrollable wheel of time 614-2, or other adjustable controls by a swipe input on the display of device 100. User interface 614-1 includes button 614-3 labeled “Start” for starting the timer. FIG. 6N illustrates user input 614-4, such as a tap input or other activation inputs, directed to button 614-3 while the wheel of time specifies a five-minute duration for the timer. User interface element 614-5, when activated, allows a user to cancel or terminate the configuration of the timer duration. For example, the timer duration reverts to the last configured duration, or resets to a default timer duration. FIG. 6O illustrates a state of device 100 ten seconds after the five-minute timer has started. For example, device 100 displays the current status of the timer (e.g., the timer icon and the amount of time remaining for the timer) in a timer session in session region 502-19, including continuing to update session region 502-19 as the timer progresses (e.g., decrementing (or in some embodiments incrementing) the timer over time following the scenario illustrated in FIGS. 6N and 6O). In FIG. 6O, in response to detecting user input 602-10, device 100 displays expanded session region 502-20 that includes controls 614-11 for stopping and/or pausing the timer during the timer session, and controls 614-12 for cancelling/terminating the timer session, as illustrated in FIG. 6P.

In FIGS. 6Q and 6R, the timing application associated with first input region 506 is not a countdown timer, but a stopwatch application. FIG. 6Q illustrates user input 602-11 directed to first input region 506 after first input region 506 has been previously associated with the stopwatch function of the timing application based on the processes outlined in FIGS. 5A-5AD. In response to detecting user input 602-11, and in accordance with a determination that no stopwatch timing session is ongoing, device 100 displays, in expanded session region 502-21, a stopwatch user interface that includes one or more activatable controls (e.g., a pause control, a resume control, and/or a cancel/terminate control) of the stopwatch while providing an updated display of the elapsed time tracked by the stopwatch. In FIG. 6R, in response to detecting user input 602-12, and in accordance with a determination that a stopwatch timing session (FIG. 6Q) is currently ongoing, device 100 displays, in expanded session region 502-22, a stopwatch user interface for a second lap of time tracking. In some embodiments, expanded session region 502-22 includes an activatable control (e.g., a pause control, a resume control, a cancel control) of the stopwatch while providing an updated display of the elapsed time of a respective lap (e.g., a second lap, or a third lap) tracked by the stopwatch function.

FIGS. 6S-6W illustrate example user interfaces for activating first input region 506 of device 100 to perform a previously configured operation of an application, different from that illustrated in FIGS. 6M-6R, in accordance with some embodiments. FIG. 6S illustrates user input 602-13 directed to first input region 506 after first input region 506 has been previously associated with a media recording application based on the processes outlined in FIGS. 5A-5AD. In response to an initial user input (not illustrated in FIG. 6S), device 100 displays, in session region 502-23, an indication of a current association of first input region 506 to the media recording application as indicated by graphical representation 616-1. Session region 502-23 includes a preview (e.g., an icon corresponding to the media recording application) of the application first input region 506 is currently associated with. In some embodiments, the initial user input is a press input (e.g., light, and/or short press input) by the user to get a reminder about what application and/or functionality is associated with first input region 506. FIG. 6S illustrates that while session region 502-23 is displayed, in response to user input 602-13, device 100 replaces display of home screen 500 with display of media recording user interface 616-2. In some embodiments, media recording user interface 616-2 is provided on a top layer of display content, with an intervening layer that blurs and/or partially obscures the home screen 500, which is the lowest layer of display content. In some embodiments, media recording user interface 616-2 is displayed on top of a wake screen. In some embodiments, media recording user interface 616-2 is displayed without any underlying display content.

In FIG. 6T, media recording user interface 616-2 includes an affordance 616-3 that can be activated to begin transcription of audio input such as voice input or speech input. Media recording user interface 616-2 also includes a transcription area that displays transcription of speech input that has been received. For example, cursor 616-5 shows the most recently received and transcribed speech input. In FIG. 6T, in response to detecting user input 616-4, device 100 begins to display transcription of speech input provided by the user. In some embodiments, the transcription is presented in real-time as speech is detected in the audio input, as shown in FIG. 6U. For example, cursor 616-5 has advanced to a different location in the transcription area of media recording user interface 616-2 in response to the detected audio input getting transcribed. In some embodiments, affordance 616-3 allows a user to toggle the transcription function on and off. For example, a user input on affordance 616-3 subsequent to user input 616-4 turns off the transcription function. In some embodiments, once the transcription function is turned off, if the transcription area contains transcription content, device 100 displays user interface elements (e.g., a “save” button, a “delete” button, and/or an “edit” button) to allow the user to either further process, discard, or save the transcription output. In some embodiments, user input 616-4 corresponds to a selection input and the textual transcription operation illustrated in FIGS. 6T and 6U is performed in response to detecting the selection input.

In FIG. 6U, in response to detecting user input 616-7, device 100 updates media recording user interface 616-2 to display a transcription text editing user interface 616-8 that includes displayed keyboard 616-9. The user is able to edit text (e.g., insert or delete) at a position of cursor 616-12 on transcription text editing user interface 616-8. Device 100 also displays user interface elements (e.g., “save” button 616-10 on keyboard 616-9, or at another location on transcription text editing user interface 616-8, or “delete” button 616-11 to discard the transcription text) that allow the user to further process, discard, or save the edited transcription output.

Returning to FIG. 6S, in some embodiments, instead of generating a text transcription of the audio input as shown in FIGS. 6S-6V), in response to a determination that user input 602-13 meets long press criteria (e.g., including a criterion that is met when the first input on the first input region has been maintained for more than a threshold amount of time), device 100 begins generating an audio recording of the received audio input. Upon a termination of user input 602-13 (e.g., lift-off of a contact associated with user input 602-13 from first input region 506, or reduction of intensity of user input 602-13 to below an intensity threshold, such as a lift-off intensity threshold, or a press detection intensity threshold), as shown in FIG. 6W, a new audio recording that captures audio input spanning the duration of the long press associated with user input 602-13 is displayed as user interface element 616-13. In some embodiments, information about the new audio recording is provided, for example, a time and date of the audio recording, and a duration of the audio recording is displayed. Optionally, device 100 displays user interface elements (e.g., a “save” button or “delete” button 616-10 as shown in FIG. 6U) that allow the user to either discard or save the audio recording.

In some embodiments, in response to a determination that user input 602-13 meets short press criteria, device 100 provides the transcription function described with respect to FIGS. 6T-6V. In some embodiments, in response to a determination that user input 602-13 meets long press criteria, device 100 provides the audio recording function described with respect to FIG. 6U. In some embodiments, as described herein, the functions triggered by the long press or short press are optionally reversed, and optionally other types of input are used to trigger these functions.

FIGS. 6X-6AA illustrate example user interfaces for activating first input region 506 of device 100 to perform a previously configured operation of an application, different from that illustrated in FIGS. 6S-6W, in accordance with some embodiments. FIG. 6X illustrates user input 602-14 directed to first input region 506 after first input region 506 has been previously associated with a system application for configuring the focus mode based on the processes outlined in FIGS. 5A-5AD. In response to detecting user input 602-14, device 100 displays, in session region 502-24, an indication of a current association of first input region 506 to the system application for configuring the focus mode of the device 100. Session region 502-24 includes a preview (e.g., an icon 618-1 corresponding to the system application for controlling the focus mode being turned on) of the application first input region 506 is currently associated with, and a textual label (e.g., “Focus Mode On”) associated with the system application. In some embodiments, the initial user input is a press input or a portion of a press input (e.g., light, and/or short press input) that provides a reminder about what application and/or functionality is associated with first input region 506.

FIG. 6Z illustrates that while session region 502-24 is displayed, in response to detecting user input 602-15 (FIG. 6Y), device 100 replaces display of home screen 500 with display of focus mode user interface 618-14. In some embodiments, focus mode user interface 618-14 is provided on a top layer of display content, with an intervening layer that blurs and/or partially obscures the home screen 500, which is the lowest layer of display content. In some embodiments, focus mode user interface 618-14 is displayed on top of a wake screen. In some embodiments, focus mode user interface 618-14 is displayed without any underlying display content.

As shown in FIG. 6Z, in response to detecting user input 602-15 on first input region 506 meets a first set of one or more criteria (e.g., a long press without a release from first input region 506), device 100 displays affordances for available focus modes, including a “Do Not Disturb” mode affordance 618-2, a “Work” mode affordance 618-4, a “Sleep” mode affordance 618-8, a “Driving” mode affordance 618-10, and a “Personal” mode affordance 618-12. In some embodiments, device 100 displays focus modes that have already been configured (e.g., previously set up and configured by the user). In some embodiments, device 100 displays some focus modes even if those focus modes are not yet configured (e.g., and when selected, will prompt the user to either configure the focus mode, and/or provide suggested settings for configuring the focus mode.

As shown in FIG. 6Z, in response to detecting a user input 618-16 on the “Work” mode affordance 618-16, device 100 displays additional information (e.g., textual information) 618-6 about the “Work” mode. A respective focus mode affordance allows a selection of functions to be turned on and off during the focus modes (e.g., notifications, network connection, incoming communication requests, display brightness, and/or other functions and parameters) and optionally the duration of the focus mode (e.g., a respective time from a reference time, a respective time until a particular triggering event, a respective time until a particular time of day, one hour from now, two hours from now, until tomorrow morning, until I leave this location, and/or other types of durations) can be selected. For example, if the user selects the “Work” mode and configures its duration as two hours from now, a subsequent activation of first input region 506 (e.g., by a press input or other sensing input) activates the “Work” focus mode for 2 hours. In some embodiments, different focus modes may include more than changing notification rules, such as to additionally include changing a background graphic (e.g., a wallpaper), and or arrangement of widgets and/or application icons on the home screen user interface or lock screen interface. Further, the information displayed in different applications may also be configured to change (e.g., which email accounts and/or calendar accounts are visible).

As shown in FIG. 6AA, in response to detecting user input 602-15 on first input region 506 that meets a second set of one or more criteria (e.g., the second set of one or more criteria include a time-based criterion, such as a short press followed by a release from first input region 506, or press inputs to first input region 506 that are separated by a waiting time period) while the first operating mode (e.g., focus mode) is currently active, device 100 deactivates the first operating mode. Device 100 also updates session region 502-25 to include a current status update of device 100 (e.g., icon 618-3 corresponding to the system application for controlling the focus mode being turned off, or another status indicator of the system application), and a textual label (e.g., “Focus Mode Off,” or another textual label) associated with the system application. In some embodiments, turning off the focus mode reverts device 100 to a default mode of notification delivery.

FIGS. 6Y and 6AA show the activation or deactivation of the focus mode performed in response to detecting a termination of the first input, such as user input 602-14 and user input 602-15 (e.g., activated on an up-click or release of the press input on first input region 506). Instead of toggling the focus mode on and off as shown in FIGS. 6X and 6Y using two distinct press inputs, in some embodiments, the activation or deactivation of a particular mode is performed without a termination of the user input (e.g., activated on the down-click of the press input on first input region 506, such as user input 602-14 or another user input). In some embodiments, the status region is updated to show that the action to be performed is to activate or deactivate a respective focus mode of the plurality of focus modes when the user input meets first criteria (e.g., a time criterion or an intensity criterion).

FIGS. 6AB-6AC illustrate example user interfaces for activating first input region 506 of device 100 to perform a previously configured operation of a system application, different from that illustrated in FIGS. 6X-6AA, in accordance with some embodiments. FIG. 6AB illustrates user input 602-16 directed to first input region 506 after first input region 506 has been previously associated with a system application for providing accessibility options based on the processes outlined in FIGS. 5A-5AD. In some embodiments, the accessibility options include vision-related accessibility options, such as voiceover, zoom, large display and text size, spoken content, and/or audio description; physical or motion-based accessibility options, such as touch assistance, reachability assistance, and/or voice control; hearing-based accessibility options, such as sound recognition, subtitles and captions, and/or RTT/TYY; and/or other types of accessibility options, such as guided access, voice-based assistance, and/or color filters. In some embodiments, the accessibility options are provided using a system application (e.g., a system settings application, and/or an application that controls functions that are applicable to the operating system or is generally applicable to multiple applications that uses a relevant system functionality (e.g., display, audio output, and/or tactile output)).

In response to an initial user input (not illustrated in FIG. 6AB), device 100 displays, in session region 502-26, an indication of a current association of first input region 506 to the system application for controlling one or more accessibility options, as indicated by graphical representation 620-1. Session region 502-26 includes a preview (e.g., an icon corresponding to accessibility function of the system application) of the application first input region 506 is currently associated with, the system application. In some embodiments, the initial user input is a press input (e.g., light, and/or short press input) by the user to get a reminder about what application and/or function is associated with first input region 506. FIG. 6AB illustrates that while session region 502-26 is displayed, in response to user input 602-16, device 100 updates session region 502-26 to include indication 620-2 that Reduce Motion function is toggled on.

Instead of being associated with an accessibility function that can be toggled on and off with a single input, first input region 506 can also be associated with an accessibility option that displays a menu of options for further customization. FIG. 6AC illustrates user input 602-17 directed to first input region 506 after first input region 506 has been previously associated with a system application for providing accessibility options based on the processes outlined in FIGS. 5A-5AD. In response to an initial user input (not illustrated in FIG. 6AB), device 100 displays, in session region 502-27, an indication of a current association of first input region 506 to the system application for controlling one or more accessibility options. Session region 502-27 includes a preview (e.g., an icon corresponding to accessibility function of the system application) of the application first input region 506 is currently associated with, the system application. In some embodiments, the initial user input is a press input (e.g., light, and/or short press input) by the user to get a reminder about what application and/or function is associated with first input region 506. FIG. 6AC illustrates that while session region 502-27 is displayed, in response to user input 602-17, device 100 updates session region 502-27 to include indication 620-3 that Voice Over function is activated and replaces display of home screen 500 with display of Voice Over configuration user interface 620-4. In some embodiments, Voice Over configuration user interface 620-4 is displayed without any underlying display content, as shown in FIG. 6AC. Voice Over configuration user interface 620-4 includes a slidable toggle switch for turning on Voice Over function, and allows a user selection of a speaking rate, and various other parameters.

FIGS. 6AD-6AH illustrate example user interfaces for activating first input region 506 of device 100 to perform a previously configured operation of an application, different from that illustrated in FIGS. 6AB-6AC, in accordance with some embodiments. In FIG. 6AD, session region 502-28 is displayed, in response to detecting a first portion (not shown) of a user input, and in accordance with a determination that the first portion of the first input satisfies a preview criteria (e.g., a time-based criterion that the first input be maintained for at least a first threshold amount of time (optionally, with less than a threshold amount of movement), having an intensity above a first intensity threshold, having an intensity below a second intensity threshold, having a change in intensity that indicates a first type of press pattern (e.g., a single down click, a down-click followed by an up-click, or another type of press patterns) and/or having a first threshold amount of movement. Session region 502-28 includes a preview of the telephony or live communication application first input region 506 is currently associated with (e.g., icon 622-1 or other graphical representations corresponding to the phone application). The first portion of the user input (e.g., a light, and/or short press input) can be used to provide a reminder about what application and/or functionality is associated with first input region 506. In some embodiments, user input 602-18 is detected while device 100 is in a low-power operation state that optionally includes a display of wake screen 605.

FIG. 6AD illustrates user input 602-18 directed to first input region 506 after first input region 506 has been previously associated with the phone application and further customized to specify calling a specific user, based on the processes outlined in FIGS. 5V-5X. In response to detecting user input 602-18, device 100 initiates an outgoing telephone call to the user specified during the customization process (e.g., to “Chris”) described in FIGS. 5V-5X, and device 100 updates the session region 502-28, to an expanded session region 502-29, as illustrated in FIG. 6AE. In some embodiments, the expanded session region 502-29 includes information about the outgoing phone call and/or one or more controls for interacting with the outgoing phone call request. For example, the session region 502-29 includes contact information associated with the outgoing call (e.g., information indicating that the call is to “Chris”) and/or a stored contact photo or icon associated with the contact. In some embodiments, the session region 502-29 further includes a plurality of control options, including an option 510 to cancel the outgoing call and an option to switch to directing audio output for the call using the speaker mode.

In FIG. 6AF, similar to session region 502-28 displayed in FIG. 6AD, in response to detecting a first portion (not shown) of a user input, and in accordance with a determination that the first portion of the first input satisfies preview criteria, device 100 displays session region 502-28 that includes a preview of the phone application first input region 506 is currently associated with (e.g., icon 622-1 or other graphical representations corresponding to the phone application). User input 602-19 is directed to first input region 506. First input region 506, while previously associated with the phone application, has not been further customized to call any particular user. In response to detecting user input 602-19, device 100 displays selection user interface 622-2 that includes representations of a set of recent contacts, favored contacts, and/or a keypad for entering a phone number or username, to initiate a live communication session with. For example, selection user interface 622-2 includes four contacts, “Alice,” “Chris,” “Mary,” and “Kim.” In some embodiments, selection user interface 622-2 expands out from status region 502-28 via an animated expansion in response to device 100 detecting user input 602-18. Optionally, such an animated transition or expansion includes expanding status region 502-28 in a respective direction (e.g., a downward, and/or leftward, and/or rightward) out of the status region 502-28. In response to detecting user input 602-20 directed at the contact “Alice,” device 100 initiates an outgoing telephone call to the contact “Alice.” Device 100 updates the session region 502-28, to expanded session region 622-3, as illustrated in FIG. 6AE. In some embodiments, expanded session region 622-3 includes information about the outgoing phone call and/or one or more controls for interacting with the outgoing phone call request. For example, the session region 502-29 includes contact information associated with the outgoing call (e.g., information indicating that the call is to “Alice”) and/or a stored contact photo or icon associated with the contact. In some embodiments, the session region 502-29 further includes a plurality of control options, including an option to cancel the outgoing call and an option to direct audio output for the call through a speaker of device 100.

Similarly, in FIG. 6AH, in response to a user input (e.g., a selection input on a control option for ending the communication session), the device 100 ends the ongoing communication session (e.g., hangs up the phone call with “Alice”) and updates session region 502-29 to session region 502-30. For example, phone icon 622-1 is displayed and a length of time that the phone call has been ongoing is displayed. In some embodiments, an audio waveform is displayed to illustrate incoming and/or outgoing audio information (e.g., that is part of the phone call). In some embodiments, different portions (e.g., along a horizontal axis, or along a different axis) of the waveform represent different audio frequencies, and in some such embodiments, the height of a respective portion (e.g., of the different portions) of the waveform represents the amplitude of the audio signal for a frequency or frequency band corresponding to the respective portion of the waveform.

FIGS. 6AI-6AJ illustrate example user interfaces for activating first input region 506 of device 100 to perform a previously configured operation of an application, different from that illustrated in FIGS. 6AD-6AH, in accordance with some embodiments. FIG. 6AI illustrates user input 602-21 directed to first input region 506 after first input region 506 has been previously associated with a media playback application, similar to the processes outlined in FIGS. 5Y-5AA. In response to detecting user input 602-21, device 100 initiates playback of media content item, and device 100 displays session region 502-31 that includes a graphical representation 624-1 of the media playback application and a relevant playback control 624-2. For example, while the media content item is playing, the relevant playback control 624-2 is a control for pausing media playback. In some embodiments, a media playback user interface 624-3 displays additionally displayed. For example, media playback user interface 624-3 includes additional information about the playback of “Song A” and includes control options for controlling the session (e.g., skip back, pause, and skip forward). In some embodiments, media display of the expanded session region 502-14 is animated as a transition from session region 502-8 that expands outward. For example, session region 502-14 includes additional information about the playback of “Song A” and includes control options for controlling the session (e.g., skip back, pause, and skip forward). In some embodiments, media playback user interface 624-3 may be displayed as an expanded session region.

FIG. 6AJ illustrates user input 602-22 directed to first input region 506. In response to detecting user input 602-22, device 100 pauses playback of media content item, and device 100 displays session region 502-32 that includes a relevant playback control 624-5. For example, while the media content item is paused in response to detecting user input 602-22, the relevant playback control 624-5 is a control for resuming media playback. In some embodiments, media playback user interface 624-3 is updated to display the relevant playback control 624-5.

FIGS. 6AK-6AL illustrate example user interfaces for activating first input region 506 of device 100 to perform a previously configured operation of an application, different from that illustrated in FIGS. 6AI-6AJ, in accordance with some embodiments. First input region 506, in addition to being associated with performing a first operation in response to detecting a single input (e.g., press input, or a long press input), can be configured to associate a sequence of user inputs with performing a different operation. FIG. 6AK illustrates sequence 602-23 of user inputs directed to first input region 506 after such a sequence of user inputs has been previously associated with performing an operation at a remote system. For example, in response to detecting sequence 602-23 of user inputs at first input region 506 of device 100, a remotely-controlled locking system for a car, which is separate from device 100, is activated to lock the car. Device 100 also displays session region 502-33 that includes a graphical representation 626-1 of the car, and graphical indicator 626-2 of the operation performed on the car in response to detecting sequence 602-23 of user inputs.

Sequences of user inputs can also be used to toggle a locking state of the car (e.g., from a locked state to an unlocked state or vice versa), as indicated by the change in appearance of graphical indicator 626-2 showing a locked representation in FIG. 6AK to graphical indicator 626-3 showing an unlocked representation in FIG. 6AL, in response to detecting sequence 602-24 of user inputs to first input region, as shown in updated session region 502-34.

FIGS. 7A-7I are flow diagrams illustrating method 700 of displaying user interfaces in response to inputs via a configurable first input region of a multifunction device in accordance with some embodiments. Method 700 is performed at a computer system (e.g., portable multifunction device 100, FIG. 1A, or device 300, FIG. 3) that is in communication with a display generation component having a display area (e.g., touch screen 112, FIG. 1A, or display 340, FIG. 3). In some embodiments, one or more sensors of the computer system (e.g., speaker 111 and/or one or more optical sensors 164, FIG. 1A, or sensor(s) 359, FIG. 3) are positioned within one or more sensor regions that are encompassed by the status region, and the display generation component is not capable of displaying content within the one or more sensor regions. Some operations in method 700 are, optionally, combined and/or the order of some operations is, optionally, changed.

At an electronic device with a display (e.g., a touch-screen display, a display separate from a touch-sensitive surface, a stereoscopic display, a head-mounted display, or another kind of display device), and a first input region that is separate from the display (e.g., the first input region is a button, a mechanical switch, a solid state button, a touch-sensitive surface, or another type of input region that can be activated by contact and/or manual manipulation, the first input region is located on a side edge, top edge, or bottom edge of the electronic device that is adjacent to the boundary of the display region, the first input region is located on the backside of the electronic device while the display is on the front side of the electronic device, and/or the first input region is integrated into the same device housing as the display, but is located outside of the display region of the display, first input region 506 is separate from display of device 100): the electronic device detects (702) a first input on the first input region (e.g., detecting an input of a first type on the first input region), including detecting a first portion of the first input followed by a second portion of the first input (e.g., detecting a first contact touching down on the first input region followed by a change in various parameters of the first input, such as a duration, a location, an intensity, and other parameters of the first input, and optionally, a liftoff of the first contact; or detecting another type of manual manipulation on the first input region, optionally including different stages of the input, such as the start, different ways of manipulating the first input region, and a termination of the manual manipulation on the first input region).

In response to detecting the first input on the first input region: during the first portion of the first input: in accordance with a determination that the first portion of the first input satisfies a first set of one or more criteria (e.g., preview criteria, including a time-based criterion that requires the first input to be maintained for at least a first threshold amount of time (optionally, with less than a threshold amount of movement), having an intensity above a first intensity threshold, having an intensity below a second intensity threshold, having a change in intensity that indicates a first type of press pattern (e.g., a single down click, a down-click followed by an up-click, or another type of press patterns) and/or having a first threshold amount of movement (optionally, in a first direction or in a second direction different from the first direction), e.g., user input 602-3 on first input region 506 in FIG. 6D satisfies the first set of one or more criteria) and that the first input region is associated with a first operation of a first application (e.g., the first operation is launching the first application, displaying a last displayed user interface of the first application, a first operation that has been selected by a user via a settings user interface, a first operation that has been automatically selected based on the current context, or another operation of the first application, e.g., in FIGS. 6D and 6E, first input region 506 is associated with the flashlight application). The electronic device displays (704), via the display, a first preview that corresponds to the first operation of the first application (e.g., displaying, in a status region of the display, such as at the top of the display region, the upper right corner of the display, a center of the display, a left edge of the display, a region adjacent to the first input region, or other areas for the status region, an indication of the identity, nature, current state, and/or other information corresponding to the first operation of the first application, e.g., in FIG. 6E, a graphical representation of a preview of the flashlight application is displayed in session region 502-15).

In accordance with a determination that the first portion of the first input satisfies the first set of one or more criteria and that the first input region is associated with a second operation of a second application (e.g., the second operation is launching the second application, displaying a last displayed user interface of the second application, a second operation that has been selected by a user via a settings user interface, a second operation that has been automatically selected based on the current context, or another operation of the second application, e.g., user input 602-1 on first input region 506 in FIG. 6A satisfies the first set of one or more criteria, FIGS. 6A and 6B, first input region 506 is associated with system application for controlling a silent mode or ringer mode of device 100) different from the first application (e.g., the first and second applications are respectively two different user applications (e.g., messages application, media player application, fitness application, clock application, camera application, calendar application, and/or other user applications), one system application (e.g., the operation modes (e.g., focus mode, DND mode, sleep mode, power-save mode, in-flight mode, and/or other modes that can be turned on or off by the operating system) and/or configuration applications (e.g., settings for various operating system functions) of the operating system) and one user application, or two system applications), the electronic device displays, via the display, a second preview that corresponds to the second operation of the second application (e.g., displaying, in the status region of the display, such as at the top of the display region, the upper right corner of the display, the center of the display, the left edge of the display, the region adjacent to the first input region, or other areas for the status region, an indication of the identity, nature, current state, and/or other information corresponding to the second operation of the second application, e.g., in FIG. 6B, a graphical representation of a preview of the system application for controlling the silent mode is displayed in session region 502-13), the second preview being different from the first preview (e.g., different application icons, different color, and/or different information). In some embodiments, in response to detecting the first input on the first input region: during the first portion of the first input: in accordance with a determination that the first portion of the first input does not satisfy the preview criteria, the electronic device forgoes displaying the first preview and the second preview, and optionally displays visual feedback corresponds to one or more characteristics of the first input and/or displays prompt that guides the user's input.

During the second portion of the first input following the first portion of the first input (e.g., the first input is a continuous input using a continuously maintained contact on the first input region, or the first input includes discrete portions that are separately by less than a threshold amount of time): in accordance with a determination that the second portion of the first input (e.g., either alone or in combination with the first portion of the first input) meets a second set of one or more criteria that are different from the first set of one or more criteria (e.g., the second set of criteria include activation criteria for triggering performance of the associated operation of the associated application, including a time-based criterion that requires the first input to be maintained for at least a second threshold amount of time (optionally, with less than a threshold amount of movement), having an intensity above a third intensity threshold, having an intensity below a fourth intensity threshold, having a change in intensity that indicates a second type of press pattern (e.g., a single up click or another type of press patterns), and/or having a second threshold amount of movement (optionally, in a first direction or in a second direction different from the first direction), and/or having a first rate of increase, a first rate of decrease, a first amount of increase, and/or a first amount of decrease in intensity in intensity), and/or liftoff of the first contact) after the first portion of the first input has met the first set of one or more criteria (e.g., preview criteria or a an initiation criteria) and that the first input region is associated with the first operation of the first application, performing the first operation of the first application (e.g., without performing the second operation of the second application, e.g., in FIG. 6F, a flashlight of device 100 is turned on in response to detecting user input 602-4).

In accordance with a determination that the second portion of the first input (e.g., either alone or in combination with the first portion of the first input) meets the second set of one or more criteria after the first portion of the first input has met the first set of one or more criteria (e.g., preview criteria or a an initiation criteria) and that the first input region is associated with the second operation of the second application, performing the second operation of the second application (e.g., without performing the first operation of the first application, e.g., in FIG. 6C, the system application toggles to turn on the ringer mode operation for device 100 in response to detecting user input 602-2). In some embodiments, in response to detecting the first input on the first input region: during the second portion of the first input: in accordance with a determination that the second portion of the first input does not meet the performance criteria after the first portion of the first input has met the preview criteria, forgoing performing the first operation of the first application and the second operation of the second application. In some embodiments, the first set of criteria and the second set of criteria are configured such that an input would have met the first set of criteria if it meets the second set of criteria. For example, in some embodiments, the first set of criteria are met by the touch-down of the contact, and the second set of criteria are met by an increase in intensity of the contact above a first intensity threshold. For example, in some embodiments, the preview is shown on contact with the first input region, and the operation is performed on pressing down on the first input region (optionally, within a threshold amount of time after touch-down of the contact, or after a threshold amount of time since touch-down of the contact). In some embodiments, the first set of criteria are met by the touch-down of the contact followed by an increase in intensity of the contact above a first threshold, and the second set of criteria are met by a decrease in intensity of the contact below a second intensity threshold lower than the first intensity threshold. For example, the preview is displayed on the down click a first press input, and the operation is performed on the up-click of the first press input. In some embodiments, the first set of criteria are met by touch-down of the contact followed by an increase in intensity above a first threshold intensity (and, optionally, that is that is maintained above the first intensity threshold for at least a first threshold amount of time), and the second set of criteria are met when the contact has been maintained above the first intensity threshold for at least a second threshold amount of time. For example, in some embodiments, the preview is displayed on a down-click or contact of the press input, and the operation is performed when the contact has been maintained on the first input region (optionally, with less than a threshold amount of movement in a unit of time) for at least a long press time threshold (optionally, after the down-click intensity threshold has been met). In some embodiments, the operation is performed on detection of the up-click of the long press input. In some embodiments, the first set of criteria are met after a contact is maintained for at least a threshold amount of time and/or has an intensity that rises above a first intensity threshold, and the second set of criteria are met when the contact is moved in a first direction (e.g., in a forward direction along the first input region, in a backward direction along the first input region, in a clockwise direction relative to the first input region, in a counterclockwise direction relative to the first input region, in a first transverse direction of the first input region, or in a second transverse direction of the first input region). For example, the preview is displayed on touch-down or the down-click of the press input, and the operation is performed on a swipe in the first direction by the contact. Other types of inputs can be utilized to trigger the display of the preview and/or the performance of the operation, depending on which operation of which application is currently associated with the first input region and the first input type. In some scenarios, an input that meets the first set of criteria but is terminated without meeting the second set of criteria causes the electronic device to display the preview without causing performance of the corresponding operation. In some embodiments, when the first input meets the second set of criteria, the electronic device ceases to display the preview that has been displayed, and optionally, displays status of the operation that is performed or other user interface feedback corresponding to the performance of the operation that is being performed.

Using a first portion of an input to a first input region to provide a preview of an operation and a second portion of the same input to perform the operation causes the electronic device to provide a user with both a preview of an available operation and to perform the available operation in response to a continued input from the user, thereby providing visual feedback of the operation being performed, without displaying additional controls, and reducing the number of inputs and amount of time needed to perform a particular operation on the electronic device.

In some embodiments, displaying the first preview that corresponds to the first operation of the first application includes (706) displaying first content corresponding to the first application in a first region (e.g., a dedicated status region, a region that displays other content and temporarily displays the previews overlaying or replacing the underlying content, a static or expandable region surrounding a cut-out area in which one or more hardware components (e.g., camera lenses, speakers, and/or microphones) reside) of the display (e.g., in the upper edge portion of the display area, the upper right corner of the display area, or another designated status region of the display area; in a region of the display that is adjacent to the first input region; or in a region that is not adjacent to the first input region), and displaying the second preview that corresponds to the second operation of the second application includes display second content corresponding to the second application in the first region of the display, wherein the second content is different from the first content. In some embodiments, the first content includes a first icon corresponding to the first operation and/or the first application, and the second includes a second icon corresponding to the second operation and/or the second application. In some embodiments, displaying the first content and the displaying the second content, respectively, includes expanding a status region to display the first content and the second content in an area that was not occupied by the status region before the detection of the first input. In some embodiments, the first content indicates a current state of the first application, optionally, in regard to the first operation; and/or the second content indicates a current state of the second application, optionally, in regard to the second operation. In some embodiments, the first region and the content displayed within the first region is animated and/or changes in appearance in accordance with one or more characteristics (e.g., intensity, duration, and/or other parameters) of the first input and/or changes of the one or more characteristics of the first input. For example, in FIGS. 6D-6E, device 100 displays a first preview about a flashlight application that includes first content (e.g., “Flashlight On,”, and/or a graphical representation of the flashlight application, an icon of the flashlight application) corresponding to the flashlight application in session region 502-15. In FIG. 6M, device 100 displays a second preview about a timing application that includes second content (e.g., “Timer,”, and/or a graphical representation of the timing application, an icon of the timing application) corresponding to the timing application in session region 502-18. Using a status region to display information about or a current status of an operation of an application that is associated with the first input region upon selection via the first input region, causes the electronic device to provide a user with a quick view of what available operations are associated with the first input region while making more efficient use of the display area by concurrently displaying other user interfaces for other functions of the electronic device outside of the status region, thereby reducing the number of inputs and amount of time needed to perform a particular operation on the electronic device.

In some embodiments, displaying the first preview includes (708) displaying an indication of the first operation of the first application. In some embodiments, displaying the second preview includes displaying an indication of the second operation of the second application. In some embodiments, the indication of the first operation is displayed as all or part of the first preview. For example, in some embodiments, the first operation of the first application is launching a user interface for making a call to a contact, and displaying the first preview includes displaying an application icon for the telephony application or a phone icon, optionally, in a status region of the display. In some embodiments, the first operation of the first application is launching a timer user interface for setting a timer or starting an existing timer, and displaying the first preview includes displaying an application icon for the timer application, optionally, in a status region of the display. Analogously and optionally, in some embodiments, displaying the second preview includes displaying an indication of the second operation of the second application. In some embodiments, the second indication is displayed as all or part of the second preview. For example, in FIGS. 6D-6E, device 100 displays a first preview that includes displaying an indication of the first operation of the flashlight application that includes turning on the flashlight application. In another example, FIG. 6K shows a first preview in session region 502-18 that includes displaying a viewfinder of a camera application, and displays an indication of the first operation of the camera application by displaying a capture button 610-1 that is activatable to stop or start video or image capture via the one or more cameras of device 100. In response to detecting an input via the first input region, displaying an indication of the first operation of the first application provides feedback about an available action without displaying additional controls, providing helpful feedback to users that reduces input errors and increases the efficiency of the user's operation of the device while also making more efficient use of the display area by allowing user interfaces for other functions of the electronic device to be displayed and interacted with outside of the status region.

In some embodiments, displaying the first preview that corresponds to the first operation of the first application includes (710) providing an indication of a current state of a setting of the electronic device (e.g., the setting that corresponds to the first application, and/or the first operation of the first application, and/or a setting that would be affected by performance of the first operation of the first application). For example, in some embodiments, the current state of the setting of the electronic device is a current on/off state for the ringer setting (e.g., in accordance with a determination that the first application is the system application that manages the ringer of the electronic device, and the first operation is for toggling the ringer on or off). In some embodiments, the current state of the setting of the electronic device is a current state of a flashlight of the electronic device (e.g., in accordance with a determination that the first application is a flashlight application, and the first operation is toggling the flashlight on or off, or displaying a control user interface for the flashlight). Analogously, and optionally, in some embodiments, displaying the second preview that corresponds to the second operation of the second application includes providing an indication of a current state of a setting of the electronic device (e.g., the setting that corresponds to the second application, and/or the second operation of the second application, and/or a setting that would be affected by performance of the second operation of the second application). For example, in FIG. 6B, device 100 provides an indication of a current state of a setting of device 100 by displaying in session region 502-13 an indication that the silent mode is on. In another example, in FIG. 6Z, device 100 provides an indication of a current state of a setting of device 100 by displaying in session region 502-24 an indication that the focus mode is on. In response to detecting an input via the first input region, displaying, in the status region, an indication of a current state of a setting of the electronic device provides feedback about a state of the electronic device while making more efficient use of the display area by allowing user interfaces for other functions of the electronic device to be displayed and interacted with outside of the status region.

In some embodiments, during the second portion of the first input following the first portion of the first input, in accordance with the determination that the second portion of the first input meets the second set of one or more criteria after the first portion of the first input has met the first set of one or more criteria and that the first input region is associated with the first operation of the first application, the electronic device provides (712) an indication of the first operation that is being performed in response to detecting the second portion of the first input. In some embodiments, in addition to performing the first operation, the electronic device provides a visual indication or description of the first operation or its outcome in conjunction with performing the first operation. For example, in some embodiments, after optionally displaying the current state of the ringer setting of the electronic device (e.g., in accordance with a determination that the first application is the system application that manages the ringer of the electronic device, and the first operation is for toggling the ringer on or off), the electronic device toggles the current state of the ringer setting in response to the second portion of the first input and displays the updated indication of the current state of the ringer setting accordingly. In some embodiments, after optionally displaying the current state of the flashlight of the electronic device (e.g., in accordance with a determination that the first application is a flashlight application, and the first operation is toggling the flashlight on or off), the electronic device toggles the current state of the flashlight and displays the updated indication of the current state of the flashlight accordingly. In some embodiments, after optionally displaying an indication that the first input region is associated with an operation to call “Mom” using a telephony application or a VoIP application, the electronic device initiates a call to a number associated with a contact “Mom” and displaying an indication that the call to Mom has been initiated and waiting to be picked up. Analogously, and optionally, in some embodiments, during the second portion of the first input following the first portion of the first input, in accordance with the determination that the second portion of the first input meets the second set of one or more criteria after the first portion of the first input has met the first set of one or more criteria and that the first input region is associated with the second operation of the second application, the electronic device provides an indication of the second operation that has been performed in response to detecting the second portion of the first input. For example, in FIG. 6C, device 100 displays in session region 502-14 an indication that ringer mode has been toggled on by disabling the silent mode device 100 was in, as shown in FIG. 5B, and provides an indication of the first operation that is being performed in response to detecting the second portion of user input 602-2 (FIG. 6B). In another example, in FIG. 6F, device 100 displays in session region 502-16 an indication that the flashlight is turned on and provides an indication of the first operation that is being performed in response to detecting the second portion of user input 602-4 (FIG. 6E). In response to detecting a second portion of an input via the first input region, displaying in the status region an indication of the first operation that is being performed provides feedback about changes in a state of the electronic device while making more efficient use of the display area by allowing user interfaces for other functions of the electronic device to be displayed and interacted with outside of the status region.

In some embodiments, performing the first operation of the first application includes (714) displaying a first set of selectable options corresponding to the first application. For example, in some embodiments, the first application is a telephony or live communication application, and performing the first operation of the first application includes displaying representations of a set of recent contacts, favored contacts, and/or a keypad for entering a phone number or username, to initiate a live communication session with. In some embodiments, the first application is a messaging application, and performing the first operation of the first application includes displaying a blank message composition user interface, and/or representations of a set of recent contacts or favored contacts for receiving the message. In some embodiments, the first application is a media player application, and performing the first operation of the first application includes displaying a listing of recently played media, favorite media, or other available media content to play using the media player application. In some embodiments, analogously and optionally, performing the second operation of the second application includes displaying a second set of selectable options corresponding to the second application. For example, in FIG. 6AF, device 100 displays a first set of selectable options corresponding to the first application by displaying in selection user interface 622-2 representations of a set of recent contacts, favored contacts, and/or a keypad for entering a phone number or username, to initiate a live communication session with. In another example, in FIG. 6N, device 100 displays timing user interface 614-1 that includes a wheel of time that allows a user to set a timer (e.g., a countdown timer, or the time of an alarm) by the hour, the minute, and the second, down to one second increments using a scrollable wheel of time, or other adjustable controls. Displaying selectable options in response to detecting an input via the first input region, and configuring the displayed user interface object to be responsive to touch inputs to perform additional operations, reduces the number of inputs and amount of time needed to perform operations on the electronic device.

In some embodiments, displaying the first set of selectable options corresponding to the first application includes (716) displaying an animated expansion of the first set of selectable options from a status region of the display. In some embodiments, the status region is the first region that is used to display the first preview of the first operation of the first application. In some embodiments, the status region is also used to display the second preview of the second operation of the second application, in accordance with a determination that the first input region is associated with the second operation of the second application. In some embodiments, the status region is used to display the first preview of the first operation of the first application, and performing the first operation includes expanding the first preview into a platter including the first set of selectable options corresponding to the first application. Analogously, and optionally, in some embodiments, the status region is used to display the second preview of the second operation of the second application, and performing the second operation includes expanding the second preview into a platter including the second set of selectable options corresponding to the second application. For example, in FIG. 6AF, selection user interface 622-2 expands out from status region 502-28 (FIG. 6AD) via an animated expansion in response to device 100 detecting user input 602-18. In another example, in FIG. 6N, timing user interface 614-1 expands out from status region 502-18 (FIG. 6M) via an animated expansion in response to device 100 detecting user input 602-9. Enabling the status region to expand and provide selectable options, causes the electronic device to automatically provide a user with relevant information and configurable options that the user has indicated is of interest, thereby reducing the number of inputs and amount of time needed to perform a particular operation on the electronic device.

In some embodiments, the first set of selectable options corresponding to the first application includes (718) at least a first option to set a first parameter of the first operation of the first application. For example, in some embodiments, the first operation is setting or starting a timer using a timer application, and performing the first operation includes displaying a user interface object, e.g., wheels of time or other adjustable controls, for setting a duration of the timer or the time of an alarm). In another example, in some embodiments, the first operation is starting a focus mode using a system application for configuring the focus mode, and performing the first operation includes displaying a selection of functions that can be turned on and off during the focus modes (e.g., notifications, network connection, incoming communication requests, display brightness, and/or other functions and parameters) and optionally the duration of the focus mode (e.g., one hour from now, two hours from now, until tomorrow morning, until I leave this location, and/or other types of durations). Analogously and optionally, in some embodiments, performing the second operation of the second application includes displaying a second set of selectable options corresponding to the second application, and the second set of selectable options corresponding to the second application includes at least a second option to set a second parameter of the second operation of the second application. For example, in FIG. 6N, device 100 displays timing user interface 614-1 that includes a wheel of time that allows a user to set a timer (e.g., a countdown timer, or the time of an alarm) by the hour, the minute, and the second, down to one second increments using a scrollable wheel of time, or other adjustable controls to set a time duration parameter of a countdown operation of the timing application. Enabling a user to select at least a first option to set a first parameter of the first operation of the first application provides the user with quick access to adjust and customize pertinent characteristics of the first operation without having to navigate through additional controls, thereby reducing the number of inputs and amount of time needed to perform, using the user selected first parameter, a particular operation on electronic device.

In some embodiments, performing the first operation of the first application includes (720) displaying an animated expansion of a first user interface of the first application from a second region (e.g., a dedicated status region, a region that displays other content and temporarily displays the previews overlaying or replacing the underlying content, a static or expandable region surrounding a cut-out area in which one or more hardware components (e.g., camera lenses, speakers, and/or microphones) reside) of the display (e.g., in the upper edge portion of the display area, the upper right corner of the display area, or another designated status region of the display area; in a region of the display that is adjacent to the first input region; or in a region that is not adjacent to the first input region), and performing the second operation of the second application includes displaying an animated expansion of a second user interface of the second application from the second region of the display (e.g., the second region is the same region as the first region used to display the first preview of the first application and the second preview of the second application, and/or the second region is a persistent status region of the display from which the user interface of an application associated with the first input region is expanded out of). In some embodiments, displaying the first preview includes expanding a persistent status region to display the first content corresponding to the first application, and performing the first operation includes further expanding the first content into a user interface of the first application. In some embodiments, the second region and the expansion of the user interface of the first application is animated and/or changes in appearance in accordance with one or more characteristics (e.g., intensity, duration, and/or other parameters) of the first input and/or changes of the one or more characteristics of the first input. For example, FIGS. 6J-L show an animated expansion of user interface 612-1 that includes a representation of a field of view of one or more cameras (e.g., integrated cameras) of device 100 from session region 502-18 (FIG. 6K). In another example, FIGS. 6E-G show an animated expansion of brightness adjustment interface 608-1 having a brightness slider 608-2 that includes an adjustable first portion 608-3 from session region 502-15 (FIG. 6E) or from session region 502-16 (FIG. 6F). Displaying an animated expansion of a user interface of an application associated with the first input region from the second region of the display in response to a user input via the first input region, provides visual feedback that links the input detected via the first input region to the animated expansion of the user interface, and reduces the number of inputs needed to interact with an application currently represented (e.g., in a preview) by the status region or to start interacting with an application associated with the first input region.

In some embodiments, the first set of one or more criteria are met by the first portion of the first input in accordance with a determination that an intensity of the first portion of the first input exceeds (722) a first intensity threshold (e.g., detection of a press as opposed to mere contact of the user's finger with the first input region), and the second set of one or more criteria are met by the second portion of the first input in accordance with a determination that the first input has been continuously maintained on the first input region for at least a first threshold amount of time (e.g., detection of a long press on the first input region) after the first portion of the first input has met the first set of one or more criteria. For example, in FIGS. 6B-6C, device 100 display a preview of the silent mode function via session region 502-13 when an intensity of the first portion of user input 602-2 input exceeds a first intensity threshold. In accordance with a determination that user input 602-2 has been continuously maintained on first input region 506 for at least a first threshold amount of time after the first portion of the first input has met the first set of one or more criteria for a long press, device 100 activates the ringer mode as displayed in session region 502-14. In another example, in FIGS. 6J-6L, device 100 display a preview of the camera application via session region 502-17 when an intensity of the first portion of user input 602-2 input exceeds a first intensity threshold. In accordance with a determination that user input 602-2 has been continuously maintained on first input region 506 for at least a first threshold amount of time after the first portion of the first input has met the first set of one or more criteria for a long press, device 100 activates the camera application by displaying user interface 612-3 (FIG. 6L). Using a first portion of an input to a first input region to provide a preview of an operation and a second portion of the same input to perform the operation causes the electronic device to provide a user with both a preview of an available operation and to perform the available operation in response to a continued input from the user, thereby providing visual feedback of the operation to be performed, without displaying additional controls, and reducing the number of inputs and amount of time needed to perform a particular operation on the electronic device. Further, performing the available operation in accordance with a determination that the first input has been continuously maintained on the first input region for at least the first threshold amount of time delays performance of the operation associated with the input until the user has committed to the input, thereby helping the user achieve an intended outcome and reducing user mistakes.

In some embodiments, the electronic device detects (724) a second input at the first input region (e.g., detecting an input of a second type on the first input region; detecting the second input at a different time from the first input, when the device is in substantially the same state as when the first input was detected); and in response to detecting the second input on the first input region: in accordance with a determination that the second input meets a third set of one or more criteria, different from the first set of one or more criteria and the second set of one or more criteria, and the first input region is associated with a third operation of a third application (e.g., third application is the same as the first application, the same as the second application, or different from the first application and the second application), performing the third operation of the third application, wherein performing the third operation of the third application is different from performing the first operation of the first application and different from performing the second operation of the second application (and different from displaying the first preview, and different from displaying the second preview). In some embodiments, the third set of one or more criteria are used to detect a different input type from the first set of one or more criteria and the second set of one or more criteria. In some embodiments, in response to detecting the first input on the first input region, in accordance with a determination that the first input meets a third set of one or more criteria, different from the first set of one or more criteria and the second set of one or more criteria, and the first input region is associated with a third operation of a third application (e.g., third application is the same as the first application, the same as the second application, or different from the first application and the second application), performing the third operation of the third application, wherein performing the third operation of the third application is different from performing the first operation of the first application and different from performing the second operation of the second application (and different from displaying the first preview, and different from displaying the second preview). In some embodiments, in response to detecting an input of the first type on the first input region, e.g., the input that meets the first set of one or more criteria and the second set of one or more criteria (e.g., a short press followed by a release from the first input region), the electronic device displays a preview of the first operation and performs the first operation of the first application; and in response to detecting an input of a second type on the first input region, e.g., the input that meets the third set of one or more criteria (e.g., a long press without a release from the first input region), the electronic device performs a third operation of the third application (e.g., another operation in the first application that is different from the first operation of the first application, or an operation from an application different from the first application and the second application). For example, in some embodiments, the first operation of the first application is presenting a first voice memo recording user interface of a recording application, and the third operation of the third application is starting to record a voice memo using the recording application, without displaying the first voice memo recording user interface of the recording application. For example, in FIG. 6S, in response to detecting a short press, device 100 display media recording user interface 616-2. In contrast, in FIG. 6W, in response to detecting a long press, device 100 begins recording an audio output file to generate a new audio recording displayed as user interface element 616-13 when user-input 602-13 (FIG. 6S) ends. In response to detecting an input via a first input region, displaying different user interface objects in the status region based on which type of input was provided via the first input region enables a user to invoke different functions of the electronic device without displaying additional controls.

In some embodiments, the first operation of the first application and the second operation of the second application are selected (726) from a set of two or more operations (e.g., during configuration of the first input region as described in FIGS. 5A-5AD), wherein a respective operation of the set of two or more operations corresponds to a respective application of a plurality of different applications. In some embodiments, the operation is selected by the user to be associated with the first input region. In some embodiments, the operation is selected automatically by the operating system of the electronic device to be associated with the first input region based on one or more conditions and the current context. In some embodiments, different operations corresponding to different applications are selected to be the operation that is currently associated with the first input region, at different points in time, and/or under different conditions. For example, in FIGS. 6D-6E, first input region 506 is associated with a flashlight application, as indicated by session region 502-15 (FIG. 6E). As another example, In FIG. 6M, first input region 506 is associated with a timing application, as indicated by session region 502-18. Enabling an operation of an application to be selected from a plurality of different applications for associating with the first input regions provides the user with quick access to customize a desired operation to be associated with the first input region, thereby reducing the number of inputs and amount of time needed to perform a desired operation on the electronic device.

In some embodiments, performing the first operation of the first application includes (728): in accordance with a determination that the first operation of the first application includes controlling output of alerts for one or more types of events occurring at the electronic device (e.g., visual and/or audio notifications and alerts that are output in response to receipt of communication, such as emails, texts, notifications, phone calls, and/or FaceTime calls, and/or in response to events requiring user input or attention, such as low battery, network interruption, or other types of events), adjusting one or more parameters for outputting alerts for at least some of the one or more types of events occurring at the electronic device (e.g., muting or unmuting the audio alerts, turning on or off the banner notifications, sending alerts and notifications to the notification center directly without first displaying them, and/or otherwise adjusting the delivery prominence, frequency, type, and timing of the alerts) from a current manner by which the alerts would have been provided at the electronic device. In some embodiments, only some types of alerts are adjusted, while other types of alerts are generated without alteration. For example, in some embodiments, if the first input region is associated with the system application that controls the focus modes of the device, performing the first operation of the first application includes togging on/off a focus mode, which toggles on/off delivery of audio and/or visual alerts and notifications for at least some applications and some types of events occurring at the electronic device. For example, in FIGS. 6B and 6C, device 100 adjusts one or more parameters for outputting alerts for at least some of the one or more types of events occurring at device 100 by switching from silent mode as indicated by session region 502-13 (FIG. 5B) to the ringer mode as indicated by session region 502-14, in response to detecting user input 602-2. In response to detecting an input via a first input region, displaying, in the status region, a user interface object indicating a current status (e.g., enabled or disabled) of controlling output of alerts for one or more types of events occurring at the electronic device provides feedback about a state of the device while making more efficient use of the display area by allowing user interfaces for other functions of the electronic device to be displayed and interacted with outside of the status region.

In some embodiments, performing the first operation of the first application includes (730): in accordance with a determination that the first operation of the first application includes initiating a process to record audio input (e.g., sound, speech, and/or video) using a media recording application (e.g., voice memo recording using a voice recording, or audio/visual recording using a media recording application), displaying a user interface of the media recording application that includes one or more user interface objects corresponding to the process to record audio input (e.g., a start button for starting recording the voice input, a stop button or pause button for stopping or pausing the recording of the voice input, an indication of how long the recording has been running, a text input area for entering text, a transcription area that displays transcription of speech input that has been received, and other controls and indicators related to media recording). In some embodiments, performing the first operation includes displaying the user interface with controls for starting the actual recording of media using the media recording application. In some embodiments, performing the first operation includes actually starting media recording using the media recording application. In some embodiments, the electronic device determines whether to the display the user interface or start recording right away based on the type of input on the first input region that has been detected. In some embodiments, performing the first operation of the first application includes generating a media file and/or generating a transcription of the audio/visual input provided to the media recording application. In some embodiments, before the second set of criteria are met for performing the first operation, the first input has met the first set of criteria, and the electronic device displays a preview indicating that the action that is to be performed is recording audio input using a media recording application (e.g., displaying an application icon of the media recording application, and/or displaying text prompt regarding how to get started with the recording (e.g., short press to start recording, short press to show recording controls, or long press to start recording)). For example, in FIG. 6T, device 100 displays media recording user interface 616-2 in response to detecting a termination of user input 602-13. In another example, in FIG. 6S, in response to detecting a long press, device 100 begins recording an audio output file to generate a new audio recording displayed as user interface element 616-13 in FIG. 6W when user-input 602-13 (FIG. 6S) ends. In response to detecting a second portion of a user input via a first input region, displaying a user interface of a media recording application provides a user with quick access to record audio input using the media recording application, thereby reducing the number of inputs and amount of time needed to perform a particular operation on the electronic device.

In some embodiments, performing the first operation of the first application includes (732): in accordance with a determination that the first operation of the first application includes initiating a process to record audio input (e.g., sound, speech, and/or video) using the media recording application (e.g., voice memo recording using a voice recording, or audio/visual recording using a media recording application): in accordance with a determination that the first input meets long press criteria (e.g., including a criterion that is met when the first input on the first input region has been maintained for more than a threshold amount of time (e.g., a long press time threshold) (optionally, with less than a threshold amount of movement in a unit of time) with at least a first intensity threshold (e.g., a light press intensity threshold, or a press detection intensity threshold) after touch-down of the first input on the first input region), starting audio input recording (e.g., ongoing and continuous recording of speech input provided by the user, and/or sound in the surrounding environment, and optionally, accompanying video of the user and/or environment); and in accordance with a determination that a termination of the first input (e.g., lift-off of the contact from the first input region, or reduction of intensity of the first input to below a second intensity threshold (e.g. lift-off intensity threshold, or a press detection intensity threshold)) has been detected after meeting the long press criteria, stopping the audio input recording that has been started (and optionally, generating an audio file and/or transcription of the audio recording, based on the audio input that has been received). In some embodiments, the audio file and/or transcription of the audio input are generated in response to an explicit user request, e.g., by activation of an affordance or performance of a gesture (e.g., a “save” button, a “transcribe” button, or an “OK” gesture). For example, in FIGS. 6S and 6W, device 100 stops audio input recording that has been started by displaying user interface element 616-13 in response to detecting a termination of user input 602-13. Maintaining an audio input recording until an end of the input via the first input region causes the device to automatically delay performance of the operation associated with the input until the user has committed to the input, thereby helping the user achieve an intended outcome and reducing user mistakes

In some embodiments, performing the first operation of the first application includes (734): in accordance with a determination that the first operation of the first application includes initiating a process to record audio input (e.g., sound, speech, and/or video) using the media recording application (e.g., voice memo recording using a voice recording, or audio/visual recording using a media recording application): in accordance with a determination that the first input meets short press criteria (e.g., including a criterion that is met when the first input on the first input region has been maintained for less than a threshold amount of time (e.g., the long press time threshold) (optionally, with less than a threshold amount of movement in a unit of time) after exceeding a first intensity threshold (e.g., a light press intensity threshold, or a press detection intensity threshold)), starting audio input recording (e.g., ongoing and continuous recording of speech input provided by the user, and/or sound in the surrounding environment, and optionally, accompanying video of the user and/or environment), and maintaining audio input recording after a termination of the first input is detected after meeting the short press criteria (e.g., lift-off of the contact from the first input region, or reduction of intensity of the first input to below a second intensity threshold (e.g. lift-off intensity threshold, or a press detection intensity threshold)). In some embodiments, while the audio recording is ongoing, the electronic device detects a second input on the first input region, and in accordance with a determination that the second input meets the short press criteria, the electronic device stops the audio input recording that has been started (and optionally, generating an audio file and/or transcription of the audio recording, based on the audio input that has been received). In some embodiments, the audio file and/or transcription of the audio input are generated in response to an explicit user request, e.g., by activation of an affordance or performance of a gesture (e.g., a “save” button, a “transcribe” button, or an “OK” gesture). In some embodiments, as described herein, the functions triggered by the long press or short press are optionally reversed, and optionally other types of input are used to trigger these functions. For example, in FIG. 6T, device 100 displays media recording user interface 616-2 in response to detecting a termination of user input 602-13. In another example, in FIG. 6S, in response to detecting a long press, device 100 begins recording an audio output file to generate a new audio recording displayed as user interface element 616-13 in FIG. 6W when user-input 602-13 (FIG. 6S) ends. Starting audio input recording when a short press is detected via a first input region enables a user to record audio input without using a display of the electronic device, which allows the user to interact with other functions of the electronic device using displayed user interfaces. Allowing a single input via the first input region to start and stop the audio input recording allows a user to quickly begin or cease audio input recording regardless of whatever process is in progress, without displaying additional controls, reducing the number of inputs required to select a desired operation, improving performance and efficiency of the electronic device.

In some embodiments, the user interface of the media recording application includes (736) at least a first selectable option that, when selected, causes the electronic device to record the audio input in an audio output file, and a second selectable option that, when selected, causes the electronic device to generate text based on speech contained in the audio input. In some embodiments, both the audio file and the transcribed text are output by the electronic device if both the first option and the second option are selected by the user. In some embodiments, the audio output is selected by default, and the user is allowed to select the transcription instead of or in addition to the audio output. In some embodiments, the transcription option is selected by default, and the user is allowed the select the audio file instead of or in addition to the transcription. In some embodiments, the transcription is presented in real-time as speech is detected in the audio input. For example, in FIG. 6T, device 100 displays media recording user interface 616-2 in response to detecting a termination of user input 602-13 that meets short press criteria. In another example, in FIG. 6S, in response to detecting a long press, device 100 begins recording an audio output file to generate a new audio recording displayed as user interface element 616-13 in FIG. 6W when user-input 602-13 (FIG. 6S) ends. By using different types of inputs, a user can select between recording audio input into an audio output file or generating text based on speech contained in the audio input. Displaying a first selectable option that enables the electronic device to record the audio input in an audio output file, and a second selectable option that enables the electronic device to generate text based on speech contained in the audio input enables a user to customize the output of the media recording application, reducing the number of inputs required to select a desired operation, improving performance and efficiency of the electronic device.

In some embodiments, performing the first operation of the first application includes (738): in accordance with a determination that the first operation of the first application includes launching a camera application, displaying a user interface of the camera application (e.g., displaying a viewfinder with live camera view and displaying one or more camera controls to take still image, video, and/or other images and video with other camera modes (e.g., a slow-motion mode, a panorama mode, a flash mode, a short-clip mode). In some embodiments, performing the first operation includes displaying the user interface of the camera application includes display controls for starting the actual capture of image or video using the camera application. In some embodiments, performing the first operation includes actually taking a picture or starting to capture a video using the camera application. In some embodiments, the electronic device determines whether to the display the user interface or start media capture right away based on the type of input on the first input region that has been detected. In some embodiments, before the second set of criteria are met for performing the first operation, the first input has met the first set of criteria, and the electronic device displays a preview indicating that the action that is to be performed is launching the camera application and/or taking a snapshot or video using the camera application. For example, in FIG. 6L, device 100 displays user interface 612-3 in response to detecting user input 602-2. User interface 612-3 includes a representation of a field of view of one or more cameras (e.g., integrated cameras) of device 100 and capture button 612-4 for performing, starting, or stopping media capture using the camera function (e.g., using one or more integrated cameras) of device 100. In response to detecting a second portion of a user input via a first input region, displaying a user interface of one or more cameras of the electronic device, such as one or more integrated cameras, provides a user with quick access to the camera(s), thereby reducing the number of inputs and amount of time needed to perform a particular operation on the electronic device.

In some embodiments, displaying the first preview that corresponds to the first operation of the first application in accordance with the determination that the first portion of the first input satisfies the first set of one or more criteria includes (740): in accordance with a determination that the first operation of the first application includes launching a camera application, displaying a graphical representation of the camera application in a preview region of the display (e.g., the preview region is the first region of the display that is used to display the first preview, the status region that is used to display status of the electronic device and the status of the second application, and/or the persistent status region that is used to display notification and alert that corresponds to an ongoing session or event (e.g., a telephone call, a navigation session, or a subscribed live event)) in accordance with a determination that the first input meets press criteria (e.g., the first input has an increase in intensity above a first intensity threshold (e.g., a press detection intensity threshold, or a light press intensity threshold), optionally within a threshold amount of time since touch-down of the first input on the first input region) before a termination of the first input is detected. For example, in FIGS. 6J, device 100 display a preview of the camera application via session region 502-17 when an intensity of the first portion of user input 602-2 input meets press criteria before a termination of user input 602-2 is detected. Displaying a graphical representation of the camera application in a preview region of the display provides a user a quick reminder about which operation of an application is associated with a first input region, making more efficient use of the display area by concurrently enabling user interfaces for other functions of the electronic device to be displayed and interacted with outside of the status region, thereby reducing the number of inputs and amount of time needed to perform a particular operation on the electronic device.

In some embodiments, displaying a user interface of the camera application includes (742) displaying the user interface of the camera application in response to detecting a termination of the first input. In some embodiments, the electronic device automatically captures an image or video in response to detecting the termination of the first input, and continues to display the user interface of the camera application after capturing the image and video. For example, in FIGS. 6K-6L, device 100 turns on the camera application by displaying a viewfinder in user interface 612-1 in response to detecting a termination of user input 602-8. In response to detecting a termination of the first input via the first input region, automatically transitioning a preview (e.g., an icon or a camera feed) displayed in the status region to a user interface of a camera application displayed outside of the status region reduces the number of inputs needed to launch the camera application via an input to the first input region. Launching the camera application upon a termination of the input via the first input region causes the device to automatically delay performance of the operation associated with the input until the user has committed to the input, thereby helping the user achieve an intended outcome and reducing user mistakes.

In some embodiments, performing the first operation of the first application includes (744): in accordance with a determination that the first operation of the first application includes controlling a flashlight of the electronic device using a flashlight application, performing at least one of displaying a user interface of the flashlight application and changing an on/off state of the flashlight. In some embodiments, performing the first operation includes displaying the user interface of the flashlight application includes display controls for turning the flashlight on or off, and adjusting a color temperature of the flashlight, and/or changing a mode of the flashlight (e.g., regular, strobe, or focused) without changing the on/off state of the flashlight. In some embodiments, performing the first operation includes changing the on/off state of the flashlight without displaying a user interface of the flashlight application. In some embodiments, the user interface of the flashlight application is displayed in conjunction with changing the on/off state of the flashlight, in response to the same press input on the first input region. In some embodiments, the electronic device determines whether to display the user interface of the flashlight or simply toggles the current state of the flashlight based on the input that has been detected (e.g., short press and lift-off to toggle flashlight on and off, and long press and liftoff to display the user interface of the flashlight application, or vice versa). In some embodiments, before the second set of criteria are met for performing the first operation, the first input has met the first set of criteria, and the electronic device displays a preview indicating that the action that is to be performed is controlling the flashlight using the flashlight application, and/or showing the current state of the flashlight. For example, in FIGS. 6D-6E, device 100 displays a preview of a flashlight application in session region 502-15 and user input 602-4 changes an on/off state of the flashlight by turning on the flashlight in FIG. 6F from the off state shown in FIG. 6E. In response to detecting a second portion of a user input via a first input region, displaying a user interface of the flashlight application and/or changing an on/off state of the flashlight provides a user with quick access to the flashlight, thereby reducing the number of inputs and amount of time needed to perform a particular operation on the electronic device.

In some embodiments, displaying the first preview that corresponds to the first operation of the first application in accordance with the determination that the first portion of the first input satisfies the first set of one or more criteria includes (746): in accordance with a determination that the first operation of the first application includes controlling a flashlight of the electronic device using a flashlight application: displaying a graphical representation of the flashlight application in a preview region of the display (e.g., the preview region is the first region of the display that is used to display the first preview, the status region that is used to display status of the electronic device and the status of the second application, and/or the persistent status region that is used to display notification and alert that corresponds to an ongoing session or event (e.g., a telephone call, a navigation session, and/or a subscribed live event)) in accordance with a determination that the first input meets press criteria (e.g., the first input has an increase in intensity above a first intensity threshold (e.g., a press detection intensity threshold, and/or a light press intensity threshold), optionally within a threshold amount of time since touch-down of the first input on the first input region) before a termination of the first input is detected. For example, in FIGS. 6D-6E, device 100 displays a graphical representation of the flashlight application in session region 502-15 in response to detecting user input 602-3 that meets press criteria before a termination of user input 602-3 is detected. Displaying a graphical representation of the flashlight application in a preview region of the display provides a user a quick reminder about which operation of an application is associated with a first input region, making more efficient use of the display area by concurrently enabling user interfaces for other functions of the electronic device to be displayed and interacted with outside of the status region, thereby reducing the number of inputs and amount of time needed to perform a particular operation on the electronic device.

In some embodiments, performing the first operation of the first application includes (748): in accordance with a determination that the first operation of the first application includes controlling a flashlight of the electronic device using a flashlight application, changing an on/off state of the flashlight (e.g., turning on the flashlight if it is off at the time that the liftoff of the first input is detected, and/or turning off the flashlight if it is on at the time that the liftoff of the first input is detected) in response to detecting a termination of the first input (e.g., detecting liftoff of the contact from the first input region, or detecting a reduction in intensity of the first input below a detection intensity threshold and/or below a lift-off threshold). In some embodiments, in conjunction with changing the on/off state of the flashlight, the electronic device also updates the indication of the status of the flashlight in the status region to reflect the new state of the flashlight. In some embodiments, in conjunction with changing the on/off state of the flashlight, the electronic device also updates the display to display a flashlight control user interface (e.g., a scrubber to adjust flashlight brightness, one or more buttons to change flashlight mode) if the flashlight is turned on from an off state in response to the termination of the first input, and the electronic device ceases to display the flashlight control user interface if the flashlight is turned off from an on state in response to the termination of the first input. For example, in FIGS. 6E-6F, device 100 turns on the flashlight to emit light rays 606-1 in response to detecting a termination of user input 602-4. In response to detecting a termination of the first input via the first input region, automatically transitioning a preview displayed in the status region to turning on a flashlight of the electronic device reduces the number of inputs needed to turn on the flashlight of the electronic device via the first input to the first input region. Changing an on/off state of the flashlight upon a termination of the input via the first input region causes the device to automatically delay performance of the operation associated with the input until the user has committed to the input, thereby helping the user achieve an intended outcome and reducing user mistakes.

In some embodiments, while the flashlight is on as a result of the first input on the first input region (e.g., the flashlight is turned on in accordance with a determination that the first operation of the first application includes controlling a flashlight of the electronic device using a flashlight application), the electronic device detects (750) a second input on a second input region that is separate from the display and that is different from the first input region (e.g., the second input region includes one of the hardware and/or solid state button regions that are used to control the volume for audio output of the electronic device) (e.g., the second input region is adjacent to the first input region on the rim or side edge of the electronic device, and/or are on different edges of the electronic device from the first input region); and in response to detecting the second input: in accordance with a determination that the second input meets first adjustment criteria (e.g., the second input includes a touch-down of a contact on the second input region followed by an increase in intensity of the contact above a light press intensity threshold, or another intensity threshold; and/or meets other intensity, timing, and rate of change-based criteria), adjust a brightness of the flashlight in accordance with the second input (e.g., consecutive presses increases the brightness by fixed discrete amounts, and/or continuously maintained contact changes the brightness continuously with a rate corresponding to the duration and/or intensity of the contact). In some embodiments, depending on the position of the second input on the second input region, and/or depending on which input region of a pair of input regions is the second input region, the electronic device either increase or decrease the brightness of the flashlight. In some embodiments, a swipe input in a first direction on the surface of the second input region increases the brightness of the flashlight, while a swipe in a second direction, different from the first direction, on the surface of the second input region decreases the brightness of the flashlight. Other characteristics of the second input (e.g., location, movement direction, movement pattern, duration, movement rate, intensity, change in intensity) are optionally used to control how the brightness and other characteristics of the flashlight is adjusted, in accordance with various embodiments. For example, in FIG. 6G, while the flashlight is on as a result of user input 602-4, in response to detecting user input 602-5 directed at second input region 508, device 100 displays brightness adjustment interface 608-1. In response to detecting an input via a hardware element such as a volume button, displaying, a user interface object with one or more brightness adjustment controls provides feedback about a state of the device while reducing the number of inputs needed to adjust a brightness of a flashlight of the electronic device.

In some embodiments, while the flashlight is on and the user interface of the flashlight application is displayed as a result of the first input on the first input region (e.g., the flashlight is turned on and the user interface is displayed in accordance with a determination that the first operation of the first application includes controlling a flashlight of the electronic device using a flashlight application), the electronic device detects (752) a third input directed to the user interface of the flashlight application; and in response to detecting the third input directed to the user interface of the flashlight application: in accordance with a determination that the third input meets second adjustment criteria (e.g., the third input is a swipe input, or a drag input at a location on a touch sensitive surface or in the air that corresponds to the location of a slider control for the brightness of the flashlight, and in a direction corresponding to an increasing or decreasing value of flashlight brightness; and/or the third input is a tap input on a button for increasing or decreasing the brightness by a discrete amount), the electronic device adjusts a brightness of the flashlight in accordance with the third input (e.g., tapping on a plus button or minus button increases or decreases the brightness by fixed discrete amounts, and/or swiping or dragging on a slider control corresponding to brightness adjusts the brightness by an amount that corresponds to the magnitude of the swiping or dragging). In some embodiments, depending on the location of the third input and direction of the third input, the electronic device either increase or decrease the brightness of the flashlight. In some embodiments, a swipe input in a first direction on the surface of display increases the brightness of the flashlight, while a swipe in a second direction, different from the first direction, on the surface of the display decreases the brightness of the flashlight. Other characteristics of the third input (e.g., location, movement direction, movement pattern, duration, movement rate, intensity, change in intensity) are optionally used to control how the brightness and other characteristics of the flashlight is adjusted, in accordance with various embodiments. For example, in FIG. 6G, while the flashlight is on as a result of user input 602-4, in response to detecting user input 602-5 directed at second input region 508, device 100 displays brightness adjustment interface 608-1. In response to user input 608-4 (FIG. 6G) on the display of device 100, brightness of the flashlight is increased, as illustrated by the denser light rays 606-2 in FIG. 6H. For a user interface object that is displayed in response to detecting an input via a first input region and configuring the user interface object to be responsive to touch inputs to perform additional operations reduces the number of inputs and amount of time needed to perform operations on the electronic device. While the flashlight is turned on via an input to the first input region, displaying a user interface object with one or more brightness adjustment controls that are adjustable by touch provides feedback about a state of the device while reducing the number of inputs needed to adjust a brightness of a flashlight of the electronic device.

In some embodiments, performing the first operation of the first application includes (754): in accordance with a determination that the first operation of the first application includes initiating a process to enable an accessibility option (e.g., vision-related accessibility options, such as voiceover, zoom, large display and text size, spoken content, and/or audio description; physical or motion-based accessibility options, such as touch assistance, reachability assistance, and/or voice control; hearing-based accessibility options, such as sound recognition, subtitles and captions, and/or RTT/TYY; and/or other types of accessibility options, such as guided access, voice-based assistance, and/or color filters) using a system application (e.g., a system settings application, and/or an application that controls functions that are applicable to the operating system or is generally applicable to multiple applications that uses a relevant system functionality (e.g., display, audio output, and/or tactile output)), performing at least one of activating a first accessibility option at the electronic device and displaying a plurality of selectable accessibility options on the display. In some embodiments, performing the first operation includes displaying the plurality of selectable accessibility options (e.g., a set of options selected by the user earlier, and/or a set of automatically recommended options). In some embodiments, performing the first operation includes actually activating an accessibility option (e.g., a respective option that has been selected by the user during a configuration stage, and/or a default accessibility option automatically selected by the operating system). In some embodiments, the electronic device determines whether to the display the selectable options in a user interface, or activating a respective accessibility option right away based on the type of input on the first input region that has been detected. In some embodiments, before the second set of criteria are met for performing the first operation, the first input has met the first set of criteria, and the electronic device displays a preview indicating that the action that is to be performed is activating an accessibility option using a system application (e.g., displaying an icon of the accessibility option that would be activated, and/or displaying text prompt regarding how to select and/or activate the accessibility option (e.g., short press to activate a default option, or long press to show menu of available accessibility options, or vice versa)). In some embodiments, as described herein, the functions triggered by the long press and/or short press are optionally reversed, and optionally other types of input are used to trigger these functions. For example, in FIGS. 6AB, device 100 activates a first accessibility option having the graphical representation 620-2, as indicated in session region 502-26 in response to detecting user input 602-16. In another example, in FIG. 6AC, device 100 displays 620-0 plurality of selectable accessibility options in Voice Over configuration user interface 620-4 that includes a slidable toggle switch for turning on Voice Over function in response to detecting user input 602-16. In response to detecting a second portion of a user input via a first input region, activating a first accessibility option at the electronic device and/or displaying a plurality of selectable accessibility options on the display provides a user with quick access to the first accessibility option, thereby reducing the number of inputs and amount of time needed to perform a particular operation on the electronic device.

In some embodiments, performing the first operation of the first application includes (756): in accordance with a determination that the first operation of the first application includes controlling an operating mode of the electronic device in which notification delivery for a plurality of applications is moderated by a system application (e.g., a system settings application, and/or an application that controls functions that are applicable to the operating system or is generally applicable to multiple applications that uses a relevant system functionality (e.g., notification delivery, alert generation, display, audio output, and/or tactile output)), performing at least one of activating a first operating mode in which notification delivery for a first plurality of applications is moderated in accordance with a first set of rules by the system application and displaying a plurality of selectable operating modes in which notification delivery for respective pluralities of applications are moderated in accordance with respective sets of rules by the system application. In some embodiments, performing the first operation includes turning on a first focus mode in which notifications or alerts from a first set of applications are muted or delivered directly to notification summary and/or notification history. In some embodiments, performing the first operation includes displaying a plurality of selectable options that reduce the notification and alerts for different sets of applications (e.g., morning mode, evening mode, work mode, rest mode, workout mode, and other user-configured modes). In some embodiments, the electronic device determines whether to the display the selectable options in a user interface, and/or activating a respective focus mode right away based on the type of input on the first input region that has been detected. In some embodiments, before the second set of criteria are met for performing the first operation, the first input has met the first set of criteria, and the electronic device displays a preview indicating that the action that is to be performed is activating a respective focus mode using a system application (e.g., displaying an icon of the focus mode that would be activated, and/or displaying text prompt regarding how to select and/or activate the focus mode (e.g., short press to activate a default option, and/or long press to show menu of available focus modes, or vice versa)). In some embodiments, in conjunction with changing the notification delivery behavior for a respective set of applications in response to the first input, the electronic device also implements different application content display rules, and/or different wake screen/home screen arrangements (e.g., wallpaper of dark screen, wall paper, and/or apps available on home screen) for a respective operating mode, and will toggle on/off these rules along with the notification delivery behavior rules for a respective focus mode. For example, in FIG. 6Z, device 100 activates a first operating mode in which notification delivery for a first plurality of applications is moderated in accordance with a first set of rules by the system application, as indicated by session region 502-24, in response to detecting user input 602-14. In FIG. 6Z, device 100 displays a plurality of selectable operating modes, including a “Do Not Disturb” mode affordance 618-2, a “Work” mode affordance 618-4, a “Sleep” mode affordance 618-8, a “Driving” mode affordance 618-10, and a “Personal” mode affordance 618-12, in which notification delivery for respective pluralities of applications are moderated in accordance with respective sets of rules by the system application, in response to detecting user input 602-15. In response to detecting a second portion of a user input via a first input region, controlling an operating mode of the electronic device in which notification delivery for a plurality of applications is moderated by a system application provides a user with quick access to change notification delivery on the electronic device, thereby reducing the number of inputs and amount of time needed to perform a particular operation on the electronic device.

In some embodiments, activating the first operating mode in which notification delivery for the first plurality of applications is moderated in accordance with the first set of rules by the system application includes (758): in accordance with a determination that the first input meets short press criteria (e.g., including a criterion that is met when the first input on the first input region has been maintained for less than a threshold amount of time (e.g., the long press time threshold) (optionally, with less than a threshold amount of movement in a unit of time) after exceeding a first intensity threshold (e.g., a light press intensity threshold, and/or a press detection intensity threshold); and optionally, a criterion that a lift-off of the first input is detected within a threshold amount of time after the first intensity threshold is met by the first input) and that the first operating mode is not currently activated, activating the first operating mode. In some embodiments, in accordance with a determination that the first input does not meet short press criteria and/or that the first operating mode is currently active, the electronic device does not activate the first operating mode. In some embodiments, in accordance with a determination that the first input meets the short press criteria and that the first operating mode is currently active, the electronic device deactivates the first operating mode. In some embodiments, performing the first operation of the first application includes: in accordance with a determination that the first operation of the first application includes controlling an operating mode of the electronic device in which notification delivery for a plurality of applications is moderated by a system application, and that one of the plurality of operating modes is currently active, the electronic device performing at least one of deactivating the currently active operating mode of the plurality of selectable operating modes in which notification delivery for respective pluralities of applications are moderated in accordance with respective sets of rules by the system application, and displaying selectable options for activating respective ones of the plurality of operating modes. In some embodiments, the activation or deactivation of the operating mode is performed without requiring a termination of the first input (e.g., activated on the down-click of the press input on the first input region). In some embodiments, the activation or deactivation of the operating mode is performed in response to detecting a termination of the first input (e.g., activated on an up-click and/or release of the press input on the first input region). In some embodiments, the status region is updated to show that the action to be performed is to activate or deactivate a respective operating mode of the plurality of operating modes when the first set of criteria are met by the first input, and the respective operating mode is activated or deactivated when the first input meets the second set of criteria. For example, in FIG. 6AA, device 100 deactivates a first operating mode in which notification delivery for a first plurality of applications is moderated in accordance with a first set of rules by the system application by disenabling the first operating mode, as indicated by session region 502-25, in response to detecting user input 602-15. Detecting a short press via a first input region to activate the first operating mode when the first operating mode is not currently activated enables a user to control a first operating mode of the electronic device without using a display of the electronic device, which allows the user to interact with other functions of the electronic device using displayed user interfaces. Allowing a single input via the first input region to toggle the first operating mode allows a user to quickly change the first operating mode regardless of whatever process is in progress, without displaying additional controls, reducing the number of inputs required to select a desired operation, improving performance and efficiency of the electronic device.

In some embodiments, displaying respective selectable options corresponding to the plurality of operating modes in which notification delivery for respective pluralities of applications are moderated in accordance with respective sets of rules by the system application includes (760): in accordance with a determination that the first input meets long press criteria (e.g., including a criterion that is met when the first input on the first input region has been maintained for more than a threshold amount of time (e.g., a long press time threshold) (optionally, with less than a threshold amount of movement in a unit of time) with at least a first intensity threshold (e.g., a light press intensity threshold, and/or a press detection intensity threshold) after touch-down of the first input on the first input region, and optionally, followed by a liftoff of the first input), displaying the respective selectable options that correspond to the plurality of operating modes in which notification delivery for respective pluralities of applications are moderated in accordance with respective sets of rules by the system application (e.g., DND mode, work mode, sleep mode, driving mode, or a different mode). In some embodiments, the plurality of operating modes that are toggled on and off and/or selected also includes operating modes that present application content for different sets of applications using different sets of display rules, and/or have different arrangements of application icons and widgets, background, wallpaper, visual appearances for one or more system user interfaces (e.g., time element, font, color scheme, and other visual features), such as the wake screen user interface, lock screen user interface, and/or home screen user interfaces. In some embodiments, as described herein, the functions triggered by the long press and/or short press are optionally reversed, and optionally other types of input are used to trigger these functions. For example, in FIG. 6Z, device 100 displays a plurality of selectable operating modes including a “Do Not Disturb” mode affordance 618-2, a “Work” mode affordance 618-4, a “Sleep” mode affordance 618-8, a “Driving” mode affordance 618-10, and a “Personal” mode affordance 618-12, in which notification delivery for respective pluralities of applications are moderated in accordance with respective sets of rules by the system application, in response to detecting user input 602-15 that meets long press criteria. Displaying respective selectable options that correspond to the plurality of operating modes in which notification delivery for respective pluralities of applications are moderated in response to detecting a long press, causes the electronic device to automatically provide a user with a summary of time-sensitive information while visually deemphasizing the alert consistent with the reduced notification mode and making more efficient use of the display area by concurrently displaying other user interfaces for other functions of the electronic device outside of the status region.

In some embodiments, performing the first operation of the first application includes (762): in accordance with a determination that the first operation of the first application includes tracking elapsed time using a timing application (e.g., tracking elapsed time via timer, and/or via a stopwatch), performing at least one of starting tracking elapsed time using the timing application (e.g., starting a stopwatch, starting a preconfigured timer, or restarting a stopped timer or stopwatch; starting a new lap on a running stopwatch, stop or pause a timer or stopwatch that is already running, and/or performing operations to start or stop the tracking of elapsed time on a timer or stopwatch) and displaying one or more controls for configure a new timer (e.g., a wheel of time, and/or selectable options for setting a timer) using the timing application (e.g., after receiving inputs to adjust a new timer, in response to detecting a subsequent activation input, the new timer is started using the adjustments made prior to activation, and/or the new timer is started based on prior adjustments made to one or more parameters of the timer). For example, in FIG. 6N, device 100 displays timing user interface 614-1 that includes a wheel of time that allows a user to set a timer (e.g., a countdown timer, and/or the time of an alarm) by the hour, the minute, and the second, down to one second increments using a scrollable wheel of time, and/or other adjustable controls in response to detecting user input 602-9 (FIG. 6M). As another example, in FIG. 6M and FIG. 6O, device 100 displays session region 502-19 that includes a timing application that tracks elapsed time in accordance with a determination that user input 602-12 meets short press criteria and that tracking of elapsed time is not currently ongoing at device 100. Using a single input via the first input region to starting tracking elapsed time using the timing application and/or displaying one or more controls for configure a new timer allows a user to quickly begin and/or control a timing application regardless of whatever process is in progress, without displaying additional controls, reducing the number of inputs required to select a desired operation, improving performance and efficiency of the electronic device.

In some embodiments, starting tracking elapsed time using the timing application includes (764): in accordance with a determination that the first input meets short press criteria (e.g., including a criterion that is met when the first input on the first input region has been maintained for less than a threshold amount of time (e.g., the long press time threshold) (optionally, with less than a threshold amount of movement in a unit of time) after exceeding a first intensity threshold (e.g., a light press intensity threshold, and/or a press detection intensity threshold); and optionally, a criterion that a lift-off of the first input is detected within a threshold amount of time after the first intensity threshold is met by the first input) and that tracking of elapsed time is not currently ongoing at the electronic device, starting tracking elapsed time (e.g., using a new timer, and/or starting a new stopwatch) using the timing application. For example, in FIG. 6Q, device 100 displays session region 502-21 that includes a stopwatch that starts tracking elapsed time in accordance with a determination that user input 602-12 meets short press criteria and that tracking of elapsed time is not currently ongoing at device 100. Starting tracking of elapsed time using the timing application in response to detecting an input via the first input region enables the user to track elapsed time in a consistent region of the display while making more efficient use of the display area, thereby reducing an amount of time needed to perform a particular operation on the device.

In some embodiments, starting tracking elapsed time using the timing application includes (766): in accordance with a determination that the first input meets short press criteria (e.g., including a criterion that is met when the first input on the first input region has been maintained for less than a threshold amount of time (e.g., the long press time threshold, optionally, with less than a threshold amount of movement in a unit of time) after exceeding a first intensity threshold (e.g., a light press intensity threshold, or a press detection intensity threshold); and optionally, a criterion that a lift-off of the first input is detected within a threshold amount of time after the first intensity threshold is met by the first input) and that tracking of elapsed time is currently ongoing at the electronic device, starting tracking elapsed time (e.g., using a new timer, and/or starting a new stopwatch) with a new starting time (e.g., starting a new timer or stopwatch, or starting a new lap using the timer or stop watch, optionally, and/or in parallel of the currently running timer or stop watch) using the timing application (and optionally, stopping the existing timer, and/or allowing two timers to run concurrently). For example, in FIG. 6R, device 100 displays session region 502-22 that includes a stopwatch that starts tracking elapsed time with a new start time in accordance with a determination that user input 602-12 meets short press criteria and that tracking of elapsed time is currently ongoing at device 100. Using a new starting time to track elapsed time in response to detecting an input via the first input region enables the user to concurrently track multiple time intervals in a consistent region of the display while making more efficient use of the display area, thereby reducing an amount of time needed to perform a particular operation on the device.

In some embodiments, displaying the one or more controls for configure a new timer (e.g., a wheel of time and/or selectable options for setting a timer) using the timing application includes (768): in accordance with a determination that the first input meets long press criteria (e.g., including a criterion that is met when the first input on the first input region has been maintained for more than a threshold amount of time (e.g., a long press time threshold) (optionally, with less than a threshold amount of movement in a unit of time) with at least a first intensity threshold (e.g., a light press intensity threshold, and/or a press detection intensity threshold) after touch-down of the first input on the first input region, and optionally, followed by a liftoff of the first input), displaying the one or more controls for configuring a new timer using the timing application. In some embodiments, as described herein, the functions triggered by the long press and/or short press are optionally reversed, and optionally other types of input are used to trigger these functions. For example, in FIG. 6N, device 100 displays timing user interface 614-1 that includes a wheel of time that allows a user to set a timer (e.g., a countdown timer, and/or the time of an alarm) by the hour, the minute, and the second, down to one second increments using a scrollable wheel of time, and/or other adjustable controls in response to detecting user input 602-9 (FIG. 6M) that meets long press criteria. Displaying the one or more controls for configuring a new timer using the timing application in response to detecting a long press enables a user to configure a new timer using the timing application, providing the user with quick access to adjust and customize pertinent characteristics of the new timer without having to navigate through additional controls, thereby reducing the number of inputs and amount of time needed to perform, using the user selected first parameter, a particular operation on electronic device.

In some embodiments, the electronic device displays (770) a first user interface for configuring the first input region, including: displaying a graphical representation of the first input region on the display, and displaying a plurality of selectable options corresponding to respective operations of a plurality of applications that are available to be associated with the first input region; while displaying the first user interface, detecting a third input (e.g., a swipe input, a tap input on a selectable representation of a respective operation of a respective application) that corresponds to a request to select a respective operation of a respective application (e.g., from a carousel of available operations of different applications) to be associated with the first input region; and in response to detecting the third input: in accordance with a determination that the third input corresponds to a request to select the first operation of the first application to be associated with the first input region, the electronic device displays a first graphical representation of the first operation of the first application (e.g., a glyph such as a moon, or voice memo, and/or other representations) in proximity of the graphical representation of the first input region (e.g., moving the first graphical representation to a distance closer than representations of other operations of other applications that are available for selection); and in accordance with a determination that the third input corresponds to a request to select the second operation of the second application to be associated with the first input region, displaying a second graphical representation of the second operation of the second application (e.g., a glyph such as a moon, or voice memo, and/or other representations) in proximity of the graphical representation of the first input region (e.g., moving the second graphical representation to a distance closer than representations of other operations of other applications that are available for selection). For example, in FIG. 5I, while displaying representation 507-2 of first input region 506-1, which includes representation 530 for a camera application, in response to detecting user input 561 that corresponds to a request to switch to a different configuration option associated with the first input region 506-1, representation 507-3 of first input region 506-1, which includes representation 550 for a flashlight application is displayed (FIG. 5O). Representation 530 for a camera application and representation 550 for a flashlight application are each in proximity of the graphical representation of first input region 506-1. Displaying a respective graphical representation of a respective operation of a respective application in proximity of the graphical representation of the first input region provides visual feedback about the respective operation to be associated with the first input region, without displaying additional controls, and thereby reducing the number of inputs and amount of time needed to configure the first input region on the electronic device.

In some embodiments, in response to detecting the third input in accordance with the determination that the third input corresponds to a request to select the first operation of the first application to be associated with the first input region, the electronic device displays (752) information (e.g., an animated demonstration, textual description, and/or other information) of the first operation of the first application, in conjunction with displaying the first graphical representation of the first operation of the first application in proximity of the graphical representation of the first input region; and in accordance with the determination that the third input corresponds to a request to select the second operation of the second application to be associated with the first input region, displaying information (e.g., an animated demonstration, textual description, and/or other information) of the second operation of the second application, in conjunction with displaying the second graphical representation of the second operation of the second application in proximity of the graphical representation of the first input region. For example, in FIG. 5I, in response to not detecting a user input within a first time threshold, device 100 updates configurable interface 501-2 to provide an animated demonstration of the camera application on configurable device 100-1 as shown in FIGS. 5M-5N. For example, FIG. 5N shows a viewfinder of user interface 509-1 of a camera application. The animated demonstration of a simulated activation of first input region 506-1 when associated with the camera application provides more information regarding the function of camera application. Displaying information of respective operation of respective application provides relevant information to the user for selecting a specific operation of an application to be associated with the first input region on the electronic device without displaying additional controls, thereby reducing the number of inputs and the amount of time needed for the user to associate the specific operation of the application with the first input region on the electronic device.

It should be understood that the particular order in which the operations in FIGS. 7A-7I have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 800) are also applicable in an analogous manner to method 700 described above with respect to FIGS. 7A-7I. For example, the session regions, status information, user interface objects, user interfaces, user inputs, gestures, alerts, device/system contexts, and/or device/system functions described above with reference to method 700 optionally have one or more of the characteristics of the session regions, status information, user interface objects, user interfaces, user inputs, gestures, alerts, device/system contexts, and/or device/system functions described herein with reference to other methods described herein (e.g., methods 800). For brevity, these details are not repeated here.

FIGS. 8A-8F are flow diagrams illustrating method 800 for configuring a first input region in accordance with some embodiments. Method 800 is performed at a computer system (e.g., portable multifunction device 100, FIG. 1A, or device 300, FIG. 3) that is in communication with a display generation component having a display area (e.g., touch screen 112, FIG. 1A, or display 340, FIG. 3), optionally a touch-sensitive surface (e.g., touch screen 112, FIG. 1A, and/or touchpad 355, FIG. 3), and optionally one or more sensors (e.g., speaker 111 and/or one or more optical sensors 164, FIG. 1A, and/or sensor(s) 359, FIG. 3). In some embodiments, one or more sensors of the computer system are positioned within one or more sensor regions that are encompassed by the status region, and the display generation component is not capable of displaying content within the one or more sensor regions. Some operations in method 800 are, optionally, combined and/or the order of some operations is, optionally, changed.

At an electronic device with a display (e.g., a touch-screen display, a display separate from a touch-sensitive surface, a stereoscopic display, a head-mounted display, and/or another kind of display device), and a first input region that is separate from the display (e.g., the first input region is a button, a mechanical switch, a solid state button, a touch-sensitive surface, or another type of input region that can be activated by contact and/or manual manipulation, the first input region is located on a side edge, a top edge, and/or a bottom edge of the electronic device that is adjacent to the boundary of the display region, the first input region is located on a backside of the electronic device while the display is on the front side of the electronic device, and/or the first input region is integrated into the same device housing as the display, but is located outside of the display region of the display, the first input region is located on a plane perpendicular to a surface of display, the first input region is located on a plane substantially perpendicular to a surface of display, and/or first input region 506 in FIG. 5A is separate from display of device 100), the electronic device displays (802) a first user interface for configuring the first input region, including concurrently displaying a first representation of the first input region (e.g., the first representation includes a high-quality 3D model of the customizable hardware control region, and/or the first representation includes a graphical depict of spatial features of the customizable hardware control region, in FIG. 5G, configuration user interface 501-2 includes representation 507-1 of first input region 506-1) and first content indicating a first configuration option associated with the first input region, wherein the first representation of the first input region includes a first graphical representation having a first set of one or more visual features that are based on a physical appearance of the first input region (e.g., a shape, spatial dimensions, and texture of the first representation corresponds to a shape, relative size, spatial dimensions, and texture of the first input region, optionally, relative to a graphical representation of at least a portion of the electronic device at which the first input region is located, in FIG. 5G, representation 507-1 of first input region 506-1 includes visual features that are based on a physical appearance of first input region 506-1), the electronic device detects (804) a first input that corresponds to a request to switch to a second configuration option associated with the first input region (e.g., a swipe gesture directed to the first representation of the first input region, a swipe or tap gesture directed to a scroll or switching affordance, and/or other user types of user inputs, in FIG. 5G, user input 538 corresponds to a request to switch to representation 530 of a camera application, as shown in FIG. 5I).

In response to detecting the first input, the electronic device concurrently displays (806), in the first user interface, a second representation of the first input region and second content indicating a second configuration option associated with the first input region (e.g., replacing the display of the first representation and the first content at the location of the first representation and the first content in the first user interface, in FIG. 5I, representation 507-2 of first input region 506-1 includes representation 530 that is associated with a camera application), wherein the second representation of the first input region has the first set of one or more visual features that are based on the physical appearance of the first input region (e.g., a shape, spatial dimensions, and texture of the first representation corresponds to a shape, relative size, spatial dimensions, and texture of the first input region, optionally, relative to a graphical representation of at least a portion of the electronic device at which the first input region is located) (e.g., the first and second representation share some commonalities, but have variations in embellishments) and the second representation of the first input region is different from the first representation of the first input region in at least a second set of one or more visual features that indicate a change in configuration option from the first configuration option to the second configuration option (e.g., a change in glyph, a change in color, a change in texture, or other visual changes that do not alter the perception that the second representation and the first representation both correspond to the first input region, representation 507-2 in FIG. 5I differs from representation 507-1 in FIG. 5G). Displaying different representations of a first input region for different configuration options enables a user to readily determine which configuration option is being used and/or made available for use with the first input region, and provides visual feedback about the configuration option to be associated with the first input region, without displaying additional controls, and thereby reducing the number of inputs and amount of time needed to configure the first input region on the electronic device.

In some embodiments, while displaying, in the first user interface, the second representation of the first input region and the second content indicating the second configuration option associated with the first input region (e.g., the second representation of the first input region includes a second graphical element that corresponds to the second configuration option, the second graphical element at least partially overlays a graphical representation of the first input region), the electronic device detects (808) a second input (e.g., a swipe gesture that moves the second graphical element away from the graphical representation of the first input region while pulling a third graphical element closer to the graphical representation of the first input region, the third graphical element at least partially overlays the graphical representation of the first input region, the first graphical element, the second graphical element, and the third graphical element are arranged in a carousel, the carousel loops by placing the last graphical element adjacent the first graphical element) that corresponds to a request to switch to a third configuration option associated with the first input region (e.g., selecting the third configuration option by positioning, via a swipe input, the third graphical element over the graphical representation of the first input region); and in response to detecting the second input, the electronic device concurrently displays, in the first user interface, a third representation of the first input region and third content indicating that the third configuration option is associated with the first input region, wherein the first representation of the first input region, the second representation of the first input region, and the third representation of the first input region have the first set of one or more visual features that are based on the physical appearance of the first input region, and are different in at least the second set of one or more visual features that indicate a change in configuration option from the first configuration option, to the second configuration option, to the third configuration option (e.g., a currently selected configuration option is the configuration option that corresponds to the graphical element that is overlaid on the graphical representation of the first input region). In some embodiments, changing an appearance of the representation of the first input region is in real-time synchronized to the second input. For example, in FIG. 5I, while displaying representation 507-2 of first input region 506-1, which includes representation 530 for a camera application, in response to detecting user input 561 that corresponds to a request to switch to a different configuration option associated with the first input region 506-1, representation 507-3 of first input region 506-1, which includes representation 550 for a flashlight application is displayed (FIG. 5O). Changing appearance of the representation of the first input region based on the currently selected configuration option provides visual feedback about the configuration option to be associated with the first input region, without displaying additional controls, and thereby reducing the number of inputs and amount of time needed to configure the first input region on the electronic device.

In some embodiments, a first difference in the second set of one or more visual features includes (810) a difference in a first display property (e.g., a color, hue, texture, fill pattern, reflectivity, and/or other display properties) in the first representation of the first input region and the second representation of the first input region (and/or the third representation of the first input region). In some embodiments, the electronic device displays a color and/or hue that is virtually cast onto the currently featured graphical representation of first input region and optionally onto its surrounding regions. In some embodiments, the change in color is over a majority of, such as all of, the graphical representation of the first input region. For example, in FIG. 5I, visual characteristics of representation 507-2 of first input region 506-1, represented by cross-hatched shading is different from representation 507-1 of first input region 506-1 of FIG. 5G shown with a diagonal shading. Displaying a difference in a first display property in the first representation of the first input region and the second representation of the first input region provides visual feedback about the configuration option to be associated with the first input region, without displaying additional controls, and thereby reducing the number of inputs and amount of time needed to configure the first input region on the electronic device.

In some embodiments, a second difference in the second set of one or more visual features includes (812) a difference in a graphical representation of a configuration option (e.g., a glyph, an icon, an animated symbol, or other graphical elements conveying the application and/or operation associated with the first input region for a given configuration option) in the first representation of the first input region and the second representation of the first input region (and/or the third representation of the first input region). In some embodiments, the graphical representation of configuration option includes a first glyph or symbol for the first configuration option, a second glyph or symbol for the second configuration option, and a third glyph or symbol for the third configuration option, where the first glyph or symbol is associated with the first operation of the first application, the second glyph or symbol is associated with the second operation of the second application, and the third glyph or symbol is associated with the third operation of the third application. For example, in FIG. 5I, while displaying representation 507-2 of first input region 506-1, which includes graphical representation 530 for a camera application, in response to detecting user input 561 that corresponds to a request to switch to a different configuration option associated with the first input region 506-1, representation 507-3 of first input region 506-1, which includes graphical representation 550 for a flashlight application is displayed (FIG. 5O). Displaying a difference in a graphical representation of in the first representation of the first input region and the second representation of the first input region provides visual feedback about the configuration option to be associated with the first input region, without displaying additional controls, and thereby reducing the number of inputs and amount of time needed to configure the first input region on the electronic device.

In some embodiments, prior to concurrently displaying the first representation of the first input region and the first content indicating the first configuration option associated with the first input region, the electronic device displays (814), in the first user interface, a representation of the electronic device that includes the first input region (e.g., the representation of the first input region in the representation of the electronic device is sized proportionately to the representation of the electronic device, and/or the representation of the electronic device is a part of an animated demonstration of how to configure the first input region and the animated demonstration shows simulated activation of the first input region after configuration); while displaying the representation of the electronic device in the first user interface, the electronic device detects a third input that corresponds to a request to start configuring the first input region (e.g., detect activation of the first input region, a tap input directed to the first input region or the representation of the electronic device, or another input that corresponds to a request to start configuring the first input region); in response to detecting the third input that corresponds to a request to start configuring the first input region, the electronic device display(s) an animated transition including zooming in toward the representation of the electronic device to show the first representation of the first input region. In some embodiments, the first representation of the first input region is concurrently displayed with a graphical representation of at least a portion of the electronic device at which the first input region is located, and/or the first representation of the first input region has a different orientation relative to the display compared to the first input region in the representation of the electronic device. For example, in FIG. 5G, representation 507-1 of first input region 506-1 is displayed as having zoomed in from the representation of first input region 506-1 shown in FIG. 5F, in response to detecting user input 516-2 that corresponds to a request to start configuring first input region 506-1 (FIG. 5E). Displaying an animated transition including zooming in toward the representation of the electronic device to show the first representation of the first input region guides the user to the location of the first input region on the electronic device without displaying additional controls, and reducing the amount of time needed for the user to begin configuring the first input region on the electronic device.

In some embodiments, displaying the animated transition further includes (816) rotating the representation of the electronic device to show the first representation of the first input region rotating from a first orientation relative to the first user interface to a second orientation relative to the first user interface (e.g., as the representation of the electronic device is rotated from a frontal view (or a substantially frontal view) to a side view (or a substantially side view), the representation of the first input region is rotated from a side view (e.g., or a substantially side view) to a frontal view (or a substantially frontal view) in the first user interface). For example in some embodiments, the rotation is part of an animated sequence between a representation of the electronic device that shows its display and a representation of the electronic device that shows the first input region, and/or the rotated view of the representation of the electronic device is rotated by an angle between 70°-110° from a central vertical axis about the electronic device. For example, In FIG. 5D, in response to detecting user input 516-1 directed to first input region 506, configuration interface 501-1 for configuring first input region 506 of device 100 is updated to display a rotating representation of configurable multifunction device 100-1, as illustrated in FIG. 5E. In some embodiments, user input 516-1 initiates the configuration of first input region 506. FIGS. 5E-5G show an animation of the rotating representation of configurable multifunction device 100-1 transitioning to configuration interface 501-2, as illustrated in FIG. 5G. Configuration interface 501-2 in FIG. 5G includes representation 507-1 of first input region 506-1. Rotating from a first orientation relative to the first user interface to a second orientation relative to the first user interface guides the user to the location of the first input region on the electronic device by providing information about the orientation of the first input region relative to the display, without displaying additional controls, and reducing the amount of time needed for the user to begin configuring the first input region on the electronic device.

In some embodiments, the first input includes (818) movement in a first direction (e.g., the first input is a swipe input in a horizontal direction of the first user interface, the first input is a swipe input in a vertical direction of the first user interface, or the first input includes movement in a direction that corresponds to a scrolling direction of a plurality of configuration options available to be associated with the first input region). While displaying the first user interface, the electronic device detects a sequence of one or more user inputs that include movements in the first direction (e.g., a sequence of swipe inputs to scroll through the plurality of available configuration options for the first input region, such as scrolling through a plurality of configuration options in a carousel of available operations of different applications that are available to be associated with the first input region); and in response to detecting the sequence of one or more user inputs that include movements in the first direction: scrolling through respective representations of the first input region of a plurality of representations of the first input region in accordance with the sequence of one or more user inputs (and updating the content that indicates the currently featured configuration option), wherein the respective representations of the first input region have the first set of one or more visual features that are based on the physical appearance of the first input region and differ from one another in at least the second set of one or more visual features that indicate different configuration options represented by the respective representations of the first input region. In some embodiments, the electronic device displays a plurality of configuration options in an ordered set on a carousel, and providing a preview of a number of selectable configuration options preceding the configuration option for which respective content is displayed, and providing a preview of a number of selectable configuration options subsequent to the configuration option for which respective content is displayed. For example, in FIG. 5I, while displaying representation 507-2 of first input region 506-1, which includes graphical representation 530 for a camera application, in response to detecting a swipe input 561 that corresponds to a request to switch to a different configuration option associated with the first input region 506-1, representation 507-3 of first input region 506-1, which includes graphical representation 550 for a flashlight application is displayed (FIG. 5O). Scrolling through respective representations of the first input region in accordance with a sequence of one or more user inputs provides visual feedback about the configuration option to be associated with the first input region, without displaying additional controls, and thereby reducing the number of inputs and amount of time needed to configure the first input region on the electronic device.

In some embodiments, while displaying the second representation of the first input region and the second content, the electronic device detects (820) that demonstration criteria are met (e.g., determining that the user has stopped scrolling further to the next configuration option, a threshold amount of time has elapsed since the second representation of the first input region is displayed, the user's attention is on the second content, and/or the user has activated the first input region to try it out) (e.g., the user does not finalize a configuration of the configuration option associated with the second representation of the first input region at this time), displaying a first animated demonstration of a respective operation of a respective application corresponding to the second configuration option. In some embodiments, the animated demonstration automatically provides more information than the second content to the user regarding the functionality of the configuration option by showing a simulated activation of the first input region if associated with the second configuration option. Optionally, in some embodiments, a user interface element is displayed in conjunction with the animated demonstration, and a user input directed to the user interface element allows the user to exit the animated demonstration and return to the display of the second representation of the first input region and the second content, to continue with the configuration process. In some embodiments, if the user interface element is not selected, the animated demonstration proceeds to an animated demonstration of a third configuration option (e.g., subsequent to the second configuration option). In some embodiments, if the user does not actively interrupt the first animated demonstration, the electronic device returns to the display of the second representation of the first input region and the second content, after the first demonstration is completed. For example, in FIG. 5I, in response to not detecting a user input within a first time threshold, device 100 updates configurable interface 501-2 to provide an animated demonstration of the camera application on configurable device 100-1 as shown in FIGS. 5M-5N. For example, FIG. 5N shows a viewfinder of user interface 509-1 of a camera application. The animated demonstration of a simulated activation of first input region 506-1 when associated with the camera application provides more information regarding the function of camera application. Displaying a first animated demonstration of a respective operation of a respective application corresponding to the second configuration option in response to detecting that demonstration criteria are met causes the electronic device to automatically provide the user with quick access to relevant information specific to the respective operation of the respective application, thereby reducing the number of inputs and amount of time needed to configure the first input region of the electronic device.

In some embodiments, detecting that demonstration criteria are met includes (822) detecting an activation of the first input region while displaying the second representation of the first input region in the first user interface (e.g., detecting a press on the first input region, a tap on the first input region, a swipe on the first input region, or another type of input that is a valid input for activating the corresponding operation associated with the first input region), and displaying the first animated demonstration of the respective operation of a respective application corresponding to the second configuration option includes: rotating the second representation of the first input region with a graphical representation of at least a first portion of the electronic device at which the first input region is located (e.g., rotating the first input region away from a plane parallel to the display of the electronic device) to reveal a graphical representation of a second portion of the electronic device (e.g., to show a frontal view or a substantially frontal view of the representation of the electronic device, or to show a back view or a substantially back view of the representation of the electronic device), and displaying animated content within the graphical representation of the second portion of the electronic device (e.g., the second portion of the electronic device is a display of the electronic device, a status region on the display of the electronic device (e.g., to show ringer mode turn off, or a viewfinder of a camera turning on, or another indication of an operation being performed), or the second portion of the electronic device is an LED flash light (e.g., to show a flash light turning on, or to show another operation being performed) on a back of the electronic device) that illustrate performance of the respective operation of the respective application corresponding to the second configuration option (e.g., in response to the simulated activation of the first input region that is detected while displaying the first user interface and the second configuration option). For example, FIG. 5N shows a viewfinder of user interface 509-1 of a camera application. The animated demonstration of a simulated activation of first input region 506-1 when associated with the camera application provides more information regarding the function of camera application. Displaying animated content within the graphical representation of the second portion of the electronic device guides the user to the location of the first input region on the electronic device by providing information about the orientation of the first input region relative to the display, without displaying additional controls, and reducing the amount of time needed for the user to begin configuring the first input region on the electronic device.

In some embodiments, in conjunction with displaying, in the first user interface, a respective representation of the first input region that is associated with a respective configuration option (e.g., the first configuration option, the second configuration option, or another configuration option that are available to be associated with the first input region), the electronic device displays (824) a first user interface element (e.g., a configuration button, or another user interface control) for configuring the respective configuration option (e.g., selecting and configuring a respective operation of the respective application corresponding to respective configuration option); the electronic device detects user selection of the first user interface element; and in response to detecting the user selection of the first user interface element (e.g., a tap input directed to the first user interface element, or another type of selection input directed to the first user interface element), the electronic device displays a plurality of customization options associated with the respective configuration option (e.g., ceasing to display the respective representation of the first input region that is associated with the respective configuration option). For example, in FIG. 5O, an input directed at user interface element 550-1 allows a user to begin configuring the flashlight application. In another example, FIG. 5I also illustrates selection input 558 directed to user interface element 554. In response to detecting selection input 558, device 100 updates configuration interface 501-2 to display one or more customization options 560 specific to the camera application, as illustrated in FIG. 5J. The list of customization options 560 includes affordances for available camera capture modes such as a “Take photos” mode affordance, a “Take portrait selfie” mode affordance, a “Take portrait” mode affordance, a “Take video” mode affordance, and a “Take selfie” mode affordance. Displaying a first user interface element for configuring a respective configuration option of the first input region allows a user to select when the customization of the configuration option should begin and provides visual feedback that the customization process has begun, thereby reducing the amount of time needed to perform a customization process for the first input region on electronic device.

In some embodiments, displaying the plurality of customization options associated with the respective configuration option includes (826): in accordance with a determination that the respective configuration option is the first configuration option (e.g., the selection input was detected while the first representation of the first input region and the first content corresponding to the first configuration option were displayed in the first user interface), displaying a first set of customization options associated with the first configuration option, and in accordance with a determination that the respective configuration option is the second configuration option (e.g., the selection input was detected while the second representation of the first input region and the second content corresponding to the second configuration option were displayed in the first user interface), displaying a second set of customization options associated with the second configuration option, wherein the second set of customization options are different from the first set of customization options. For example, FIG. 5I illustrates selection input 558 directed to user interface element 554. In response to detecting selection input 558, device 100 updates configuration interface 501-2 to display one or more customization options 560 specific to the camera application, as illustrated in FIG. 5J. The list of customization options 560 includes affordances for available camera capture modes such as a “Take photos” mode affordance, a “Take portrait selfie” mode affordance, a “Take portrait” mode affordance, a “Take video” mode affordance, and a “Take selfie” mode affordance. In another example, FIG. 5G also illustrates selection input 536 directed to user interface element 532. In response to detecting selection input 536, configuration interface 501-2 is updated to display, as illustrated in FIG. 5H, one or more customization options 540 specific to a system application that controls an operating mode of the electronic device in which notification delivery for a plurality of applications is moderated. For example, the list of customization options 540 includes affordances for available focus modes such as a “Do not disturb” mode affordance, a “Work” mode affordance, a “Sleep” mode affordance, a “Driving” mode affordance, and a “Personal” mode affordance. Displaying different sets of customization options based on the respective configuration option automatically presents relevant customization options to the user, thereby reducing the number of inputs and the amount of time needed to perform a customization process for the first input region on electronic device.

In some embodiments, displaying the plurality of customization options associated with the respective configuration option includes (828): in accordance with a determination that the respective configuration option is associated with a camera application, displaying a first option for launching a user interface of the camera application within one or more applications different from the camera application. For example, in some embodiments, the option to launch the user interface for the camera application in different applications is provided as a toggle switch that is displayed among a first set of customization options for the camera application. In some embodiments, the first set of customization options provide the user with a selection user interface for specifying which application is permitted to launch the user interface for the camera application. In some embodiments, the first set of customization options includes an option to launch a user interface of a camera application that allows the electronic device to capture images or video frames (e.g., automatically, without requiring a capture input from the user in the user interface of the camera application). For example, FIG. 5I illustrates selection input 558 directed to user interface element 554. In response to detecting selection input 558, device 100 updates configuration interface 501-2 to display one or more customization options 560 specific to the camera application, as illustrated in FIG. 5J. Customization options 560 includes a toggle slider for indicating whether the camera application is to be made available in applications, for example, whether a user can activate the camera application via an input to the first input region 506 while one or more other applications are in use. Displaying a first option for launching a user interface of a camera application within one or more applications different from the camera application enables a user to launch the camera application via an input to the first input region, without displaying additional controls, regardless of whatever application or process is in progress, thereby reducing the number of inputs and amount of time needed to perform a particular operation of the camera application on the electronic device.

In some embodiments, displaying the plurality of customization options associated with the respective configuration option includes (830): in accordance with a determination that the respective configuration option is associated with a camera application, displaying respective options for launching the camera application in respective capture modes of a plurality of different capture modes (e.g., a slow-motion mode, a panorama mode, a flash mode, a short-clip mode (e.g., still, video, selfie, portrait, and panorama). For example, in some embodiments, the options for selecting which capture mode to launch the user interface for the camera application are provided in the form of radio buttons for different capture modes that are displayed among a first set of customization options for the camera application. For example, FIG. 5I illustrates selection input 558 directed to user interface element 554. In response to detecting selection input 558, device 100 updates configuration interface 501-2 to display one or more customization options 560 specific to the camera application, as illustrated in FIG. 5J. The list of customization options 560 includes affordances for available camera capture modes such as a “Take photos” mode affordance, a “Take portrait selfie” mode affordance, a “Take portrait” mode affordance, a “Take video” mode affordance, and a “Take selfie” mode affordance. Displaying respective options for launching the camera application in respective capture modes of a plurality of different capture modes enables a user to select and customize a camera capture mode when invoking the camera application via an input to the first input region, thereby reducing the number of inputs and amount of time needed to perform a particular operation using a selected capture mode of the camera application on the electronic device.

In some embodiments, in response to detecting the user selection of the first user interface element (e.g., a tap input directed to the first user interface element, or another type of selection input directed to the first user interface element), the electronic device displays (832) an animated transition to zoom out from the respective representation of the first input region that is associated with the respective configuration option (and optionally ceasing to display the respective representation of the first input region at the end of the animated transition). In some embodiments, the zoomed-out view of the respective representation of the first input region is concurrently displayed with the plurality of customization options associated with the respective configuration option. In some embodiments, the plurality of customization options associated with the respective configuration option are displayed without concurrently displaying the respective representation of the first input region that is associated with the respective configuration option. For example, device 100 displays an animated transition starting at the depiction of first input region 506-1 shown in FIG. 5G and ends with the depiction of first input region 506-1 shown in FIG. 5H. Displaying an animated transition to zoom out from representation 507-1 shown in FIG. 5G to representation 507-1 shown in FIG. 5H deemphasizes the respective representation and allows the user to focus on the respective configuration option for the respective representation (e.g., for focus mode selection, or for camera capture mode selection). Displaying an animated transition to zoom out from the respective representation of the first input region deemphasizes the respective representation allows the user to focus on the respective configuration option for the respective representation, and provides visual feedback to the user that the current user interface is not interactable for changing a respective representation of the first input region but is for further configuring the currently selected representation of the first input region, without displaying additional controls, and reduces the amount of time needed for the user to begin configuring the first input region on the electronic device.

In some embodiments, while displaying, in the first user interface, the respective representation of the first input region that is associated with the respective configuration option, the electronic device displays (834) a respective animated demonstration for the respective configuration option in the first user interface; In some embodiments, the respective animated demonstration for the respective configuration option is displayed in response to detecting that demonstration criteria are met (e.g., determining that the user has stopped scrolling further to the next configuration option, a threshold amount of time has elapsed since the respective representation of the first input region is displayed, the user's attention is on the respective content associated with the respective configuration option, and/or the user has activated the first input region to try it out while the respective representation of the first input region is displayed), and in response to detecting the user selection of the first user interface element, the electronic device ceases to display the respective animated demonstration of the respective configuration option (e.g., while displaying a respective set of customization options associated with the respective configuration option, the animated demonstration ceases to be displayed). For example, respective animated demonstration of the respective configuration option such as that for the camera function shown in FIGS. 5K-5N is paused in response to detecting a user selection input 558 of user interface element 558 for configuring the camera application in FIG. 5I. Ceasing to display a respective animated demonstration of a respective configuration option allows the user to focus on a respective configuration option for the respective representation, and provides visual feedback to the user, without displaying additional controls, that the current user interface is not interactable for changing a respective representation of the first input region but for further configuring the currently selected representation of the first input region, thereby reducing the amount of time needed for the user to select the configuration option for configuring the first input region on the electronic device.

In some embodiments, displaying the plurality of customization options associated with the respective configuration option includes (836): in accordance with a determination that the respective representation of the first input region is associated with a system application that manages operations for a plurality of applications (e.g., a system application that provides a shortcut to perform an operation of a respective application and that manages respective shortcuts to respective operations of a plurality of applications, or another system application that provides access to and/or manages operations for multiple applications), displaying the plurality of customization options grouped by application, including displaying a first group of customization options for a first application of the plurality of applications, and displaying a second group of customization options for a second application of the plurality of applications, different from the first application. For example, in some embodiments, the respective representation of the first input is associated with a shortcut application, and the customization options are not specific to a single application such as camera, timer, voice memo, ringer, focus modes, and flashlight, and/or another individual user application, but includes respective groups of options corresponding to multiple different applications. In some embodiments, the applications and/or groups of options are displayed in a scrollable list. For example, in FIG. 5U, configuration interface 501-5 displays customization options grouped by application for four different types of applications. In some embodiments, configuration interface 501-5 provides a scrollable list that includes more than the four different types of applications that are being currently displayed. The first type of application includes customization option represented by user interface elements 553-14 and 553-15, which relate to operations that are performed at a remote system or device from device 100. User interface element 553-14, when activated, is used to control the opening and closing of a garage door. User interface element 553-15, when activated, is used to control the locking and unlocking of a car. Displaying customization options grouped by application allows a user to easily search through the available options based on application, and optionally having a scrollable list of customization options grouped by application provides the user with a larger range of applications and customization options than would be possible with a static list, thereby reducing the number of inputs and amount of time needed to configure the first input region for a specific customization option.

In some embodiments, displaying the plurality of customization options grouped by application includes (838) displaying respective groups of customization options corresponding to different applications in an order that is based on a current context (e.g., including which applications are opened recently, which application is the last accessed application, which applications are frequently used applications for the user, and/or other information about relative relevance of various applications at the present time and/or for the user) of the electronic device. For example, in FIG. 5U, configuration interface 501-5 displays customization options grouped by application. In some embodiments, an order by which the customization options is presented to the user is based on a current context of device 100, for example, the current context includes information about which applications are opened recently, which application is the last accessed application, which applications are frequently used applications for the user, and/or other information about relative relevance of various applications at the present time and/or for the user. For example, in FIG. 5U, the user has most recently used an application for controlling a locking and unlocking of a garage door or the locking of a car. User interface elements 553-14 and 553-15 are therefore positioned at beginning of the scrollable list of customization options. Displaying respective groups of customization options corresponding to different applications in an order that is based on a current context of the electronic device causes the electronic device to automatically provide a user with quick access to customization options of various applications that the user is likely to use, thereby reducing the number of inputs and amount of time needed to perform a particular operation on the electronic device.

In some embodiments, displaying the plurality of customization options grouped by application includes (840) displaying respective groups of customization options corresponding to different applications in an order that is based on a sorting rule (e.g., alphabetically based on application name, chronologically based on when the applications were last accessed or installed, or another persistent sorting rule), independent of a current context of the electronic device (e.g., one or more parameters that change over time). For example, in FIG. 5T, configuration interface 501-6 displays customization options grouped by application in an order that is based on a sorting rule independent of a current context of the electronic device. For example, the configuration interface 5016 displays customization options that are sorted alphabetically. Displaying respective groups of customization options corresponding to different applications in an order that is based on a persistent sorting rule causes the electronic device to present customization options of various applications in a manner that allows the user to easily search through the available options and applications according to the persistent sorting rule, thereby reducing the number of inputs and amount of time needed to perform a particular operation on the electronic device.

In some embodiments, displaying the plurality of customization options associated with the respective configuration option includes (842): displaying the plurality of customization options in an order that is based on a prioritization of respective operation types of the plurality of customization options (e.g., operations that are simple and discrete (e.g., one-click operations, such as starting a timer, turn on/off the ringer, turn on a DND mode, and/or other toggle or one-click operations) are prioritized over operations that require the user to consider information and provide additional input to perform (e.g., composing a text message to a recipient, play music from a selected album, and/or other operations that require multiple steps or need additional user input to perform)). For example, in FIG. 5T, the ordering of the customization option prioritizes customization options that are simple and discrete (e.g., locking or unlocking a car, causes a car to honk, one-click operations such as starting a timer, turn on/off the ringer, turn on a DND mode, and/or other toggle or one-click operations) over operations that involve having a user consider information and provide additional input to perform (e.g., composing a text message to a recipient, play music from a selected album, and/or other operations that require multiple steps or need additional user input to perform)). For example, in FIG. 5T, customization options for locking a car, making a honking sound by the car, starting a timer, and starting a stopwatch are sorted ahead of customization options for writing a new note. Displaying the plurality of customization options in an order that is based on a prioritization of respective operation types of the plurality of customization options causes the electronic device to concomitantly guide the user in selecting a customization option that is more well-suited for activation via the first input region, thereby reducing the number of inputs and reducing the potential amount of user frustration to perform a particular operation on the electronic device.

In some embodiments, while displaying the plurality of customization options associated with the respective configuration option, the electronic device detects (844) user selection of a first customization option of the plurality of customization options; and in response to detecting the user selection of the first customization option of the plurality of customization options associated with the respective representation, the electronic device displays a second option (e.g., an input field, a selection list of parameter values, or a plurality of selectable options) to set a first parameter of the first customization option (e.g., a user-selectable parameter, a contact to call, a document to open, a media item or playlist to play, or other selectable options). In some embodiments, the first customization option is setting or starting a timer using a timer application, and displaying the second option includes displaying a user interface object, e.g., wheels of time or other adjustable controls, for setting a duration of the timer or the time of an alarm). For example, in FIG. 5T, in response to detecting a user input 553-21 directed at user interface element 553-29 configurable to associate first input region 506 to initiate a live communication session with a specified user, device 100 updates configuration user interface 501-6 to display configuration user interface 501-7, as shown in FIG. 5W. In this way, a user is able to, for example, set a first parameter of a contact to call for the customization option of initiating a live communication session. In FIG. 5W, configuration user interface 501-7 includes a snippet or list 553-40 containing a number of suggested contacts the user may wish to use to configure a shortcut function of first input region 506. Enabling a user to set a first parameter of a first customization option provides the user with quick access to adjust and customize pertinent characteristics of the first customization option without having to navigate through additional controls, thereby reducing the number of inputs and amount of time needed to perform, using the user selected first parameter, a particular operation on electronic device.

In some embodiments, displaying the plurality of customization options includes (846) displaying a third option that was a previously configured operation that required multiple steps to configure. For example, in FIG. 5U, user interface element 553-14 was configured via multi-step customization option to associate a sequence of user inputs to opening a garage. Displaying a previously configured operation that required multiple steps to configure provides the user with quick access to select a previously customized option without having to navigate through additional controls, thereby reducing the number of inputs and amount of time needed to perform, using the previously customized option, a particular operation on electronic device.

In some embodiments, while displaying the plurality of customization options associated with the respective configuration option, the electronic device displays (848) a second user interface element (e.g., a “done” button, a “close” button, and/or other affordances for finalizing the configuration process) for finalizing the respective configuration option of the first input region; and in response to detecting user selection of the second user interface element, the electronic device associates the first input region with the respective configuration option in accordance with a current selection of customization options from the plurality of customization options (and optionally, ceasing display of the plurality of customization options associated with the respective configuration option, for example, subsequent activation of the first input region includes user interfaces described in reference to method 700, and FIGS. 6A-6AL). For example, in FIG. 5Z, in response to detecting user input 553-65 directed at user interface element 533-64 to conclude the configuration process, device 100 updates configuration interface 501-10 to display a configured user interface 501-11, as shown in FIG. 5AA. In response to detecting user input 533-73 directed at user interface element 533-72 to conclude the configuration process, first input region 506 is associated with the radio function of a music application. Displaying a second user interface element for finalizing a respective configuration option of the first input region allows a user to select when the customization of the configuration option should conclude and provides visual feedback that the current selection of customization options is being associated with the first input region, thereby reducing the amount of time needed to perform a customization process for the first input region on electronic device.

It should be understood that the particular order in which the operations in FIGS. 8A-8F have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 700) are also applicable in an analogous manner to method 800 described above with respect to FIGS. 8A-8F. For example, the session regions, status information, user interface objects, user interfaces, user inputs, device/system functions, alerts, notifications, applications, and/or modes described above with reference to method 800 optionally have one or more of the characteristics of the session regions, status information, user interface objects, user interfaces, user inputs, device/system functions, alerts, notifications, applications, and/or modes described herein with reference to other methods described herein (e.g., method 700). For brevity, these details are not repeated here.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system and/or computer readable medium claims where the system and/or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system and/or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve display of content in a session region. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, and/or any other identifying or personal information.

The present disclosure recognizes that the use of such personal information data, in the present technology, can be used to the benefit of users. For example, the personal information data can be used to improve the automatic selection of content for display in a session region based on users' activity patterns. Further, other uses for personal information data that benefit the user are also contemplated by the present disclosure. For instance, health and fitness data may be used to provide insights into a user's general wellness, and/or may be used as positive feedback to individuals using technology to pursue wellness goals.

The present disclosure contemplates that the entities responsible for the collection, analysis, disclosure, transfer, storage, and/or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of automatic selection of content for display in a session region based on users' activity patterns, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content for display in a session region can be selected by inferring relevance or preferences based on non-personal information data or a bare minimum amount of personal information, such as the content being requested by the device associated with a user, other non-personal information available to the service, or publicly available information.

1. A method, comprising:
at an electronic device with a display, and a first input region that is separate from the display:
detecting a first input on the first input region, including detecting a first portion of the first input followed by a second portion of the first input;
in response to detecting the first input on the first input region:
during the first portion of the first input:
in accordance with a determination that the first portion of the first input satisfies a first set of one or more criteria and that the first input region is associated with a first operation of a first application, displaying, via the display, a first preview that corresponds to the first operation of the first application; and
in accordance with a determination that the first portion of the first input satisfies the first set of one or more criteria and that the first input region is associated with a second operation of a second application different from the first application, displaying, via the display, a second preview that corresponds to the second operation of the second application, the second preview being different from the first preview; and
during the second portion of the first input following the first portion of the first input:
in accordance with a determination that the second portion of the first input meets a second set of one or more criteria that are different from the first set of one or more criteria after the first portion of the first input has met the first set of one or more criteria and that the first input region is associated with the first operation of the first application, performing the first operation of the first application; and
in accordance with a determination that the second portion of the first input meets the second set of one or more criteria after the first portion of the first input has met the first set of one or more criteria and that the first input region is associated with the second operation of the second application, performing the second operation of the second application.

2. The method of claim 1, wherein:
displaying the first preview that corresponds to the first operation of the first application includes displaying first content corresponding to the first application in a first region, and
displaying the second preview that corresponds to the second operation of the second application includes displaying second content corresponding to the second application in the first region of the display, wherein the second content is different from the first content.

3. The method of claim 1, wherein displaying the first preview includes displaying an indication of the first operation of the first application.

4. The method of claim 1, wherein displaying the first preview that corresponds to the first operation of the first application includes providing an indication of a current state of a setting of the electronic device.

5. The method of claim 1, including:
during the second portion of the first input following the first portion of the first input, in accordance with the determination that the second portion of the first input meets the second set of one or more criteria after the first portion of the first input has met the first set of one or more criteria and that the first input region is associated with the first operation of the first application, providing an indication of the first operation that is being performed in response to detecting the second portion of the first input.

6. The method of claim 1, wherein performing the first operation of the first application includes displaying a first set of selectable options corresponding to the first application.

7. The method of claim 6, wherein displaying the first set of selectable options corresponding to the first application includes displaying an animated expansion of the first set of selectable options from a status region of the display.

8. The method of claim 6, wherein the first set of selectable options corresponding to the first application includes at least a first option to set a first parameter of the first operation of the first application.

9. The method of claim 1, wherein:
performing the first operation of the first application includes displaying an animated expansion of a first user interface of the first application from a second region of the display, and
performing the second operation of the second application includes displaying an animated expansion of a second user interface of the second application from the second region of the display.

10. The method of claim 1, wherein the first set of one or more criteria are met by the first portion of the first input in accordance with a determination that an intensity of the first portion of the first input exceeds a first intensity threshold, and the second set of one or more criteria are met by the second portion of the first input in accordance with a determination that the first input has been continuously maintained on the first input region for at least a first threshold amount of time after the first portion of the first input has met the first set of one or more criteria.

11. The method of claim 1, including:
detecting a second input at the first input region; and
in response to detecting the second input on the first input region:
in accordance with a determination that the second input meets a third set of one or more criteria, different from the first set of one or more criteria and the second set of one or more criteria, and the first input region is associated with a third operation of a third application, performing the third operation of the third application, wherein performing the third operation of the third application is different from performing the first operation of the first application and different from performing the second operation of the second application.

12. The method of claim 1, wherein the first operation of the first application and the second operation of the second application are selected from a set of two or more operations, wherein a respective operation of the set of two or more operations corresponds to a respective application of a plurality of different applications.

13. The method of claim 1, wherein performing the first operation of the first application includes:
in accordance with a determination that the first operation of the first application includes controlling output of alerts for one or more types of events occurring at the electronic device, adjusting one or more parameters for outputting alerts for at least some of the one or more types of events occurring at the electronic device from a current manner by which the alerts would have been provided at the electronic device.

14. The method of claim 1, wherein performing the first operation of the first application includes:
in accordance with a determination that the first operation of the first application includes initiating a process to record audio input using a media recording application, displaying a user interface of the media recording application that includes one or more user interface objects corresponding to the process to record audio input

15. The method of claim 14, wherein performing the first operation of the first application includes:
in accordance with a determination that the first operation of the first application includes initiating a process to record audio input using the media recording application:
in accordance with a determination that the first input meets long press criteria, starting audio input recording; and
in accordance with a determination that a termination of the first input has been detected after meeting the long press criteria, stopping the audio input recording that has been started.

16. The method of claim 14, wherein performing the first operation of the first application includes:
in accordance with a determination that the first operation of the first application includes initiating a process to record audio input using the media recording application:
in accordance with a determination that the first input meets short press criteria, starting audio input recording, and maintaining audio input recording after a termination of the first input is detected after meeting the short press criteria.

17. The method of claim 14, wherein the user interface of the media recording application includes at least a first selectable option that, when selected, causes the electronic device to record the audio input in an audio output file, and a second selectable option that, when selected, causes the electronic device to generate text based on speech contained in the audio input.

18. The method of claim 1, wherein performing the first operation of the first application includes:
in accordance with a determination that the first operation of the first application includes launching a camera application, displaying a user interface of the camera application.

19. The method of claim 18, wherein displaying the first preview that corresponds to the first operation of the first application in accordance with the determination that the first portion of the first input satisfies the first set of one or more criteria includes:
in accordance with a determination that the first operation of the first application includes launching a camera application, displaying a graphical representation of the camera application in a preview region of the display in accordance with a determination that the first input meets press criteria before a termination of the first input is detected.

20. The method of claim 18, wherein displaying a user interface of the camera application includes displaying the user interface of the camera application in response to detecting a termination of the first input.

21. The method of claim 1, wherein performing the first operation of the first application includes:
in accordance with a determination that the first operation of the first application includes controlling a flashlight of the electronic device using a flashlight application, performing at least one of displaying a user interface of the flashlight application and changing an on/off state of the flashlight.

22. The method of claim 21, wherein displaying the first preview that corresponds to the first operation of the first application in accordance with the determination that the first portion of the first input satisfies the first set of one or more criteria includes:
in accordance with a determination that the first operation of the first application includes controlling a flashlight of the electronic device using a flashlight application:
displaying a graphical representation of the flashlight application in a preview region of the display in accordance with a determination that the first input meets press criteria before a termination of the first input is detected.

23. The method of claim 21, wherein performing the first operation of the first application includes:
in accordance with a determination that the first operation of the first application includes controlling a flashlight of the electronic device using a flashlight application, changing an on/off state of the flashlight in response to detecting a termination of the first input.

24. The method of claim 21, including:
while the flashlight is on as a result of the first input on the first input region, detecting a second input on a second input region that is separate from the display and that is different from the first input region; and
in response to detecting the second input:
in accordance with a determination that the second input meets first adjustment criteria, adjusting a brightness of the flashlight in accordance with the second input.

25. The method of claim 21, including:
while the flashlight is on and the user interface of the flashlight application is displayed as a result of the first input on the first input region, detecting a third input directed to the user interface of the flashlight application; and
in response to detecting the third input directed to the user interface of the flashlight application:
in accordance with a determination that the third input meets second adjustment criteria, adjusting a brightness of the flashlight in accordance with the third input.

26. The method of claim 1, wherein performing the first operation of the first application includes:
in accordance with a determination that the first operation of the first application includes initiating a process to enable an accessibility option, performing at least one of activating a first accessibility option at the electronic device and displaying a plurality of selectable accessibility options on the display.

27. The method of claim 1, wherein performing the first operation of the first application includes:
in accordance with a determination that the first operation of the first application includes controlling an operating mode of the electronic device in which notification delivery for a plurality of applications is moderated by a system application, performing at least one of activating a first operating mode in which notification delivery for a first plurality of applications is moderated in accordance with a first set of rules by the system application and displaying a plurality of selectable operating modes in which notification delivery for respective pluralities of applications are moderated in accordance with respective sets of rules by the system application.

28. The method of claim 27, wherein activating the first operating mode in which notification delivery for the first plurality of applications is moderated in accordance with the first set of rules by the system application includes:
in accordance with a determination that the first input meets short press criteria and that the first operating mode is not currently activated, activating the first operating mode.

29. The method of claim 27, wherein displaying respective selectable options corresponding to the plurality of operating modes in which notification delivery for respective pluralities of applications are moderated in accordance with respective sets of rules by the system application includes:
in accordance with a determination that the first input meets long press criteria, displaying the respective selectable options that correspond to the plurality of operating modes in which notification delivery for respective pluralities of applications are moderated in accordance with respective sets of rules by the system application.

30. The method of claim 1, wherein performing the first operation of the first application includes:
in accordance with a determination that the first operation of the first application includes tracking elapsed time using a timing application, performing at least one of starting tracking elapsed time using the timing application and displaying one or more controls for configure a new timer using the timing application.

31. The method of claim 30, wherein starting tracking elapsed time using the timing application includes:
in accordance with a determination that the first input meets short press criteria and that tracking of elapsed time is not currently ongoing at the electronic device, starting tracking elapsed time using the timing application.

32. The method of claim 30, wherein starting tracking elapsed time using the timing application includes:
in accordance with a determination that the first input meets short press criteria and that tracking of elapsed time is currently ongoing at the electronic device, starting tracking elapsed time with a new starting time using the timing application.

33. The method of claim 30, wherein displaying the one or more controls for configure a new timer using the timing application includes:
in accordance with a determination that the first input meets long press criteria, displaying the one or more controls for configuring a new timer using the timing application.

34. The method of claim 1, including:
displaying a first user interface for configuring the first input region, including:
displaying a graphical representation of the first input region on the display, and
displaying a plurality of selectable options corresponding to respective operations of a plurality of applications that are available to be associated with the first input region;
while displaying the first user interface, detecting a third input that corresponds to a request to select a respective operation of a respective application to be associated with the first input region; and
in response to detecting the third input:
in accordance with a determination that the third input corresponds to a request to select the first operation of the first application to be associated with the first input region, displaying a first graphical representation of the first operation of the first application in proximity of the graphical representation of the first input region; and
in accordance with a determination that the third input corresponds to a request to select the second operation of the second application to be associated with the first input region, displaying a second graphical representation of the second operation of the second application in proximity of the graphical representation of the first input region.

35. The method of claim 34, including:
in response to detecting the third input:
in accordance with the determination that the third input corresponds to a request to select the first operation of the first application to be associated with the first input region, displaying information of the first operation of the first application, in conjunction with displaying the first graphical representation of the first operation of the first application in proximity of the graphical representation of the first input region; and
in accordance with the determination that the third input corresponds to a request to select the second operation of the second application to be associated with the first input region, displaying information of the second operation of the second application, in conjunction with displaying the second graphical representation of the second operation of the second application in proximity of the graphical representation of the first input region.

36. An electronic device that is in communication with a display generation component having a display area, the electronic device comprising:
one or more processors; and
memory storing one or more programs, wherein the one or more programs are configured to be executed by the one or more processors, the one or more programs including instructions for:
detecting a first input on a first input region separate from the display generation component, including detecting a first portion of the first input followed by a second portion of the first input;
in response to detecting the first input on the first input region:
during the first portion of the first input:
in accordance with a determination that the first portion of the first input satisfies a first set of one or more criteria and that the first input region is associated with a first operation of a first application, displaying, via the display generation component, a first preview that corresponds to the first operation of the first application; and
in accordance with a determination that the first portion of the first input satisfies the first set of one or more criteria and that the first input region is associated with a second operation of a second application different from the first application, displaying, via the display generation component, a second preview that corresponds to the second operation of the second application, the second preview being different from the first preview; and
during the second portion of the first input following the first portion of the first input:
in accordance with a determination that the second portion of the first input meets a second set of one or more criteria that are different from the first set of one or more criteria after the first portion of the first input has met the first set of one or more criteria and that the first input region is associated with the first operation of the first application, performing the first operation of the first application; and
in accordance with a determination that the second portion of the first input meets the second set of one or more criteria after the first portion of the first input has met the first set of one or more criteria and that the first input region is associated with the second operation of the second application, performing the second operation of the second application.

37. A computer readable storage medium storing one or more programs, the one or more programs comprising instructions that, when executed by an electronic device that is in communication with a display generation component having a display area, cause the electronic device to:
detecting a first input on a first input region separate from the display generation component, including detecting a first portion of the first input followed by a second portion of the first input;
in response to detecting the first input on the first input region:
during the first portion of the first input:
in accordance with a determination that the first portion of the first input satisfies a first set of one or more criteria and that the first input region is associated with a first operation of a first application, displaying, via the display generation component, a first preview that corresponds to the first operation of the first application; and
in accordance with a determination that the first portion of the first input satisfies the first set of one or more criteria and that the first input region is associated with a second operation of a second application different from the first application, displaying, via the display generation component, a second preview that corresponds to the second operation of the second application, the second preview being different from the first preview; and
during the second portion of the first input following the first portion of the first input:
in accordance with a determination that the second portion of the first input meets a second set of one or more criteria that are different from the first set of one or more criteria after the first portion of the first input has met the first set of one or more criteria and that the first input region is associated with the first operation of the first application, performing the first operation of the first application; and
in accordance with a determination that the second portion of the first input meets the second set of one or more criteria after the first portion of the first input has met the first set of one or more criteria and that the first input region is associated with the second operation of the second application, performing the second operation of the second application.

38-61. (canceled)
